(19) United States
(12) Patent Application Publication
(10) Pub. No.: US 2026/0086408 A1
(43) Pub. Date: Mar. 26, 2026

(54) Light-Emitting Device, Backlight Module, and Display Substrate

(71) Applicants: BEIJING BOE TECHNOLOGY DEVELOPMENT CO., LTD., Beijing (CN); BOE TECHNOLOGY GROUP CO., LTD., Chaoyang District, Beijing (CN)

(72) Inventors: Weiting Peng, Beijing (CN); Yun Lai, Beijing (CN); Wei Wang, Beijing (CN); Qian Sun, Beijing (CN)

(21) Appl. No.: 19/111,001

(22) PCT Filed: Nov. 28, 2023
(86) PCT No.: PCT/CN2023/134709

§ 371 Date: Mar. 12, 2025

(30) Foreign Application Priority Data
Mar. 27, 2023 (WO) PCT/CN2023/084188

(51) Int. Cl. G02F 1/13357

(52) U.S. Cl. CPC G02F 1/133617

(57) ABSTRACT

A light-emitting device includes a first light conversion layer, a light emitting portion located on a side of the first light conversion layer, and a second light conversion layer located on a side of the light-emitting portion away from the first light conversion layer. The first light conversion layer is configured to change a traveling direction of part of light incident of the first light conversion layer. The second light conversion layer is configured to change a traveling direction of part of light incident on the second light conversion layer, so that the light with a change in the traveling direction exits in a direction towards the first light conversion layer, and the second light conversion layer is configured to enable at least part of light entering the second light conversion layer to form linearly polarized light to exit from the light-emitting device.

### CROSS-REFERENCE TO RELATED APPLICATIONS

This application is the United States national phase of International Patent Application No. PCT/CN2023/134709, filed Nov. 28, 2023, and claims priority to International Patent Application No. PCT/CN2023/084188, filed Mar. 27, 2023, the disclosures of which are hereby incorporated by reference in their entireties.

### BACKGROUND OF THE INVENTION

### Field of the Invention

The present disclosure relates to the field of display technologies, and in particular, to a light-emitting device and a manufacturing method therefor, a backlight module, a display substrate, and a display apparatus.

### Description of Related Art

A head-mounted display apparatus is a display apparatus that can be worn on the user's head. The head-mounted display apparatus may be virtual reality (VR) glasses, a VR helmet, or any other VR display apparatus. These VR display apparatuses isolate users' visual and auditory senses from the outside world, and guide the users to feel as if they are in a virtual environment, achieving VR display.

### SUMMARY OF THE INVENTION

In an aspect, a light-emitting device is provided, and the light-emitting device includes a first light conversion layer, a light-emitting portion, and a second light conversion layer. The light-emitting portion is located on a side of the first light conversion layer and used for emitting light. The second light conversion layer is located on a side of the light-emitting portion away from the first light conversion layer. The first light conversion layer is configured to change a traveling direction of part of light incident on the first light conversion layer, so that the light with a change in the traveling direction exits in a direction towards the second light conversion layer, and a polarization direction of at least part of the light with the change in the traveling direction is changed. The second light conversion layer is configured to change a traveling direction of part of light incident on the second light conversion layer, so that the light with a change in the traveling direction exits in a direction towards the first light conversion layer; and the second light conversion layer is configured to enable at least part of light entering the second light conversion layer to form linearly polarized light to exit from the light-emitting device.

In some embodiments, the light-emitting portion includes a first semiconductor layer, a light-emitting layer, and a second semiconductor layer that are stacked in sequence, and the first semiconductor layer is closer to the first light conversion layer than the second semiconductor layer. The light-emitting layer is a multi-quantum well layer.

In some embodiments, the second light conversion layer includes a metal wire grid structure.

In some embodiments, the light-emitting device further includes an isolation portion; the isolation portion separates the light-emitting layer into a plurality of island-shaped light-emitting units, and the island-shaped light-emitting units are configured to emit light.

In some embodiments, the island-shaped light-emitting units are in contact with the isolation portion, and the isolation portion between adjacent island-shaped light-emitting units is continuously distributed. The isolation portion is further configured to separate the first semiconductor layer into a plurality of island-shaped first semiconductor units; and/or the isolation portion is further configured to separate the second semiconductor layer into a plurality of island-shaped second semiconductor units.

In some embodiments, a material of the isolation portion includes argon element or arsenic element.

In some embodiments, the isolation portion is configured to separate the first semiconductor layer into a plurality of island-shaped first semiconductor units, and the island-shaped first semiconductor units are in one-to-one correspondence with the island-shaped light-emitting units. The light-emitting device further includes: a first electrode layer located on a side of the light-emitting portion away from the second light conversion layer, and a driving circuit layer located on a side of the first electrode layer away from the light-emitting portion. The driving circuit layer is electrically connected to the island-shaped first semiconductor units through the first electrode layer.

In some embodiments, the first light conversion layer includes a phase conversion layer and the first electrode layer, and the phase conversion layer is located between the first electrode layer and the light-emitting portion. The first electrode layer includes a plurality of first electrodes spaced apart from each other, and each of the first electrodes is electrically connected to one or more island-shaped first semiconductor units. The first electrodes are configured to reflect light incident on the first electrodes.

In some embodiments, the phase conversion layer includes a plurality of conductive portions, and a conductive portion is partially directly opposite to the at least one island-shaped first semiconductor unit; a side of the conductive portion is electrically connected to a first electrode, and another side of the conductive portion is electrically connected to one or more island-shaped first semiconductor units. Alternatively, the phase conversion layer includes a plurality of first via holes, and a first electrode is electrically connected to one or more island-shaped first semiconductor units through a first via hole.

In some embodiments, the light-emitting device further includes a current blocking layer located between the first electrode layer and the phase conversion layer, and an orthographic projection of the current blocking layer on an extension plane of the isolation portion overlaps with the isolation portion. An orthographic projection of the first electrode on a plane where the light-emitting portion is located overlaps with an island-shaped light-emitting unit.

In some embodiments, the first electrode includes an overlapping portion, and the overlapping portion is in contact with a surface of the current blocking layer away from the first light conversion layer; and the driving circuit layer is in contact with the overlapping portion.

In some embodiments, the first light conversion layer includes a phase conversion layer and a reflective layer, and the phase conversion layer is located between the reflective layer and the light-emitting portion. The phase conversion layer includes a plurality of nanostructures arranged in an array, and a first dielectric layer located between any two adjacent nanostructures.

In some embodiments, a surface of the first dielectric layer close to the light-emitting portion is flush with surfaces of the plurality of nanostructures close to the light-emitting portion.

In some embodiments, a refractive index of the first dielectric layer is in a range of 1.3 to 1.5.

In some embodiments, a nanostructure is in a shape of one of a cuboid, a frustum of a pyramid, an elliptical cylinder, and a frustum of an elliptical cone; or the phase conversion layer is of a wire grid structure.

In some embodiments, in a case where a nanostructure is in a shape of a cuboid, and the plurality of nanostructures constitute a wire grid structure, a repetition period of the wire grid structure is in a range of 180 nm to 220 nm, a line width of the wire grid structure is in a range of 40 nm to 80 nm, and a height of the nanostructure is in a range of 60 nm to 140 nm.

In some embodiments, in a case where the nanostructure is in the shape of the cuboid, an orthographic projection of the nanostructure on a plane where the light-emitting portion is located is in a shape of a rectangle. The rectangle includes a first side and a second side, and a dimension of the first side is smaller than a dimension of the second side. The dimension of the first side is in a range of 40 nm to 80 nm; a minimum repetition period of the plurality of nanostructures along an extension direction of the first side is in a range of 160 nm to 240 nm; the dimension of the second side is in a range of 540 nm to 580 nm, and a ratio of the dimension of the second side to a minimum repetition period of the plurality of nanostructures along an extension direction of the second side is in a range of 0.86 to 1.00; and a height of the nanostructure is in a range of 60 nm to 140 nm.

In some embodiments, in a case where the nanostructure is in the shape of the elliptical cylinder, an orthographic projection of the nanostructure on a plane where the light-emitting portion is located is in a shape of an ellipse. The ellipse includes a major axis and a minor axis. A dimension of the minor axis is in a range of 40 nm to 80 nm; a minimum repetition period of the plurality of nanostructures along an extension direction of the minor axis is in a range of 160 nm to 220 nm; a dimension of the major axis is in a range of 540 nm to 580 nm, and a ratio of the dimension of the major axis to a minimum repetition period of the plurality of nanostructures along an extension direction of the major axis is in a range of 0.87 to 1.00; and a height of the nanostructure is in a range of 60 nm to 140 nm.

In some embodiments, a wavelength of light emitted by the light-emitting portion is in a range of 435 nm to 485 nm; a refractive index of the first dielectric layer is in a range of 1.46 to 1.50; the light-emitting portion includes a first semiconductor layer and a second semiconductor layer, and a refractive index of the first semiconductor layer is in a range of 2.30 to 2.42; and a material of the nanostructure is metal aluminum.

In some embodiments, the second light conversion layer includes a metal wire grid. The metal wire grid includes: a first metal layer, a second dielectric layer, and a second metal layer. The first metal layer includes a plurality of first metal patterns; the plurality of first metal patterns extend in a first direction and are arranged at intervals in a second direction; and the first direction intersects the second direction. The second dielectric layer includes a plurality of light-transmitting dielectric patterns; each of the plurality of light-transmitting dielectric patterns extends in the first direction, and the plurality of light-transmitting dielectric patterns are arranged at intervals in the second direction; and a light-transmitting dielectric pattern is located between two adjacent first metal patterns. The second metal layer includes a plurality of second metal patterns; each of the plurality of second metal patterns extends in the first direction, and the plurality of second metal patterns are arranged at intervals in the second direction; and a second metal pattern is located on the light-transmitting dielectric pattern.

In some embodiments, the second light conversion layer includes a metal wire grid. The metal wire grid includes a third metal layer; the third metal layer includes a plurality of third metal patterns, and the plurality of third metal patterns extend in a first direction and are arranged at intervals in a second direction; and the first direction intersects the second direction.

In some embodiments, the first light conversion layer includes a plurality of nanostructures. An orthographic projection of a nanostructure on a plane where the light-emitting portion is located is in a shape of a rectangle, and the rectangle includes a first side and a second side; a dimension of the first side is smaller than a dimension of the second side; and an included angle between a direction where the second side of the nanostructure is located and the first direction is in a range of 30° to 60°. Alternatively, the orthographic projection of the nanostructure on the plane where the light-emitting portion is located is in a shape of an ellipse, and the ellipse includes a major axis and a minor axis; and an included angle between a direction where the major axis of the nanostructure is located and the first direction is in a range of 30° to 60°.

In some embodiments, the light-emitting device further includes a second electrode layer located between the light-emitting portion and the second light conversion layer. The second electrode layer includes a plurality of first openings, and an orthographic projection of a first opening on a plane where the light-emitting portion is located overlaps with the light-emitting portion.

In some embodiments, the light-emitting device further includes a second electrode layer. The second electrode layer includes a plurality of first openings. The metal wire grid includes a plurality of sub-wire grids arranged at intervals, and a sub-wire grid is located in a first opening; and an orthographic projection of the sub-wire grid on a plane where the light-emitting portion is located overlaps with the light-emitting portion.

In some embodiments, the light-emitting device further includes a second electrode, and the second electrode and the metal wire grid are manufactured through a single process.

In another aspect, a manufacturing method for a light-emitting device is provided, and the method includes: forming a light-emitting sub-device, the light-emitting sub-device including a first light conversion layer and a light-emitting portion located on the first light conversion layer; and forming a second light conversion layer on a side of the light-emitting sub-device, where the second light conversion layer is located on a side of the light-emitting portion away from the first light conversion layer, and the light-emitting sub-device and the second light conversion layer constitute the light-emitting device.

In some embodiments, forming the light-emitting sub-device, includes: forming the light-emitting portion, where the light-emitting portion includes a second semiconductor layer, a light-emitting layer, and a first semiconductor layer that are stacked in sequence; forming an isolation portion in the light-emitting portion using an ion implantation process, where the isolation portion separates the light-emitting layer into a plurality of island-shaped light-emitting units, and separates the first semiconductor layer into a plurality of island-shaped first semiconductor units, and the island-shaped light-emitting units are in one-to-one correspondence with the island-shaped first semiconductor units; and forming the first light conversion layer on the island-shaped first semiconductor units and the isolation portion.

In some embodiments, forming the first light conversion layer on the island-shaped first semiconductor units and the isolation portion, includes: forming a plurality of nanostructures on the island-shaped first semiconductor units and the isolation portion, and forming a first dielectric layer between adjacent nanostructures.

In some embodiments, forming the light-emitting sub-device further includes: forming a current blocking layer on the first light conversion layer, where an orthographic projection of the current blocking layer on an extension plane of the isolation portion overlaps with the isolation portion; the current blocking layer includes a plurality of third openings, and the third openings expose a portion of a surface of the first light conversion layer; and forming a first electrode layer on the current blocking layer, where the first electrode layer includes a plurality of first electrodes spaced apart from each other, and each of the first electrodes is electrically connected to an island-shaped first semiconductor unit through a third opening and the first light conversion layer.

In some embodiments, forming the light-emitting sub-device further includes: forming a current blocking layer on the first light conversion layer, where an orthographic projection of the current blocking layer on an extension plane of the isolation portion overlaps with the isolation portion; the current blocking layer includes a plurality of third openings, and the third openings expose a portion of a surface of the first light conversion layer; forming first via holes penetrating through the first light conversion layer through the third openings, where a first via hole exposes a portion of a surface of an island-shaped first semiconductor unit, and an orthographic projection of the first via hole on the light-emitting portion is within an orthographic projection of a third opening on the light-emitting portion; and forming a first electrode layer on the current blocking layer, where the first electrode layer includes a plurality of first electrodes spaced apart from each other, and a first electrode is electrically connected to one or more island-shaped first semiconductor units through the third opening and the first via hole.

In yet another aspect, a backlight module is provided, and the backlight module includes a substrate, and one or more light-emitting devices, located on the substrate, as described in any one of the above embodiments.

In yet another aspect, a display apparatus is provided, and the display apparatus includes a backlight panel and a liquid crystal panel. The backlight panel is the light-emitting device described in any one of the above embodiments, and the liquid crystal panel is located on a light-exit side of the backlight pane.

In yet another aspect, a display substrate is provided, and the display substrate includes: a substrate, one or more light-emitting devices described in any one of the above embodiments, and a color conversion layer. Light emitted by the light-emitting devices is blue light or ultraviolet light. The light-emitting devices are located on a side of the substrate. The color conversion layer is located on a side of the light-emitting devices away from the substrate.

In some embodiments, the color conversion layer includes a dam layer and a plurality of color conversion portions; the dam layer has a plurality of second openings, and the color conversion portions are located in the second openings. The color conversion portions include first color conversion portions, second color conversion portions, and third color conversion portions, which are respectively located in different second openings. The first color conversion portions convert light into red light, the second color conversion portions convert light into green light, and the third color conversion portions maintain light or converts the light into blue light.

In yet another aspect, a display apparatus is provided, and the display apparatus includes the display substrates described in any one of the above embodiments, and a first polarizer, a transflective film, a first lens, a second polarizer, a reflective polarizer and a second lens that are sequentially stacked on a light-exit side of the display substrate.

### BRIEF DESCRIPTION OF THE DRAWINGS

In order to describe technical solutions in the present disclosure more clearly, the accompanying drawings to be used in some embodiments of the present disclosure will be introduced briefly. Obviously, the accompanying drawings to be described below are merely drawings of some embodiments of the present disclosure, and a person of ordinary skill in the art can obtain other drawings according to those drawings. In addition, the accompanying drawings in the following description may be regarded as schematic diagrams, and are not limitations on actual sizes of products involved in the embodiments of the present disclosure.

FIG. 1 is a schematic diagram of a display apparatus, in accordance with some embodiments of the present disclosure;

FIG. 2 is a structural diagram of a display panel, in accordance with some embodiments of the present disclosure;

FIG. 3 is a structural diagram of another display apparatus, in accordance with some embodiments of the present disclosure;

FIG. 4 is a structural diagram of a backlight module, in accordance with some embodiments of the present disclosure;

FIG. 5 is a structural diagram of another backlight module, in accordance with some embodiments of the present disclosure;

FIG. 6A is a structural diagram showing a substrate and light-emitting devices, in accordance with some embodiments of the present disclosure;

FIG. 6B is another structural diagram showing a substrate and light-emitting devices, in accordance with some embodiments of the present disclosure;

FIG. 6C is yet another structural diagram showing a substrate and light-emitting devices, in accordance with some embodiments of the present disclosure;

FIG. 6D is a structural diagram showing a driving circuit and light-emitting devices, in accordance with some embodiments of the present disclosure;

FIG. 7 is a comparison diagram showing characteristics of four display apparatuses in the related art;

FIG. 8A is a structural diagram of a light-emitting device, in accordance with some embodiments of the present disclosure;

FIG. 8B is a structural diagram of another light-emitting device, in accordance with some embodiments of the present disclosure;

FIG. 8C is a structural diagram of yet another light-emitting device, in accordance with some embodiments of the present disclosure;

FIG. 8D is a structural diagram of yet another light-emitting device, in accordance with some embodiments of the present disclosure;

FIG. 9 is a structural diagram of yet another light-emitting device, in accordance with some embodiments of the present disclosure;

FIG. 10 is a structural diagram of yet another light-emitting device, in accordance with some embodiments of the present disclosure;

FIG. 11 is a structural diagram of yet another light-emitting device, in accordance with some embodiments of the present disclosure;

FIG. 12 is a structural diagram of yet another light-emitting device, in accordance with some embodiments of the present disclosure;

FIG. 13 is a structural diagram showing an isolation portion and a light-emitting layer, in accordance with some embodiments of the present disclosure;

FIG. 14 is a structural diagram of yet another light-emitting device, in accordance with some embodiments of the present disclosure;

FIG. 15 is a structural diagram of yet another light-emitting device, in accordance with some embodiments of the present disclosure;

FIG. 16 is a structural diagram of yet another light-emitting device, in accordance with some embodiments of the present disclosure;

FIG. 17 is a structural diagram of yet another light-emitting device, in accordance with some embodiments of the present disclosure;

FIG. 18 is a structural diagram of a metal wire grid with a double wire grid structure, in accordance with some embodiments of the present disclosure;

FIGS. 19 and 20 are diagrams showing relationships between wavelengths and transmittances, absorptivities and reflectivities of a metal wire grid with a double wire grid structure, in accordance with some embodiments of the present disclosure;

FIG. 21 is a structural diagram of a metal wire grid with a single wire grid structure, in accordance with some embodiments of the present disclosure;

FIGS. 22 and 23 are diagrams respectively showing a relationship between transmittances of a metal wire grid with a single wire grid structure and a metal wire grid with a double wire grid structure, as well as a relationship between polarization degrees of the metal wire grid with the single wire grid structure and the metal wire grid with the double wire grid structure, in accordance with some embodiments of the present disclosure;

FIG. 24 is a structural diagram of yet another light-emitting device, in accordance with some embodiments of the present disclosure;

FIG. 25 is a diagram showing relationships between wavelengths and transmittances, absorptivities and polarization degrees of the light-emitting device shown in FIG. 24;

FIG. 26 is a structural diagram of yet another light-emitting device, in accordance with some embodiments of the present disclosure;

FIG. 27 is a diagram showing relationships between wavelengths and transmittances, absorptivities and polarization degrees of the light-emitting device shown in FIG. 26;

FIG. 28 is a structural diagram of yet another light-emitting device, in accordance with some embodiments of the present disclosure;

FIGS. 29 and 30 are diagrams showing relationships between wavelengths and both transmittances and polarization degrees of the light-emitting device shown in FIG. 28;

FIG. 31 is a structural diagram of a metal wire grid, in accordance with some embodiments of the present disclosure;

FIG. 32 is a structural diagram of another metal wire grid, in accordance with some embodiments of the present disclosure;

FIG. 33 is a diagram showing relationships between wavelengths and transmittances of four metal wire grids, in accordance with some embodiments of the present disclosure;

FIG. 34 is a diagram showing relationships between wavelengths and polarization degrees of four metal wire grids, in accordance with some embodiments of the present disclosure;

FIG. 35 is a diagram showing relationships between wavelengths and transmittances of three metal wire grids made of different metal materials, in accordance with some embodiments of the present disclosure;

FIG. 36 is a diagram showing relationships between wavelengths and absorptivities of three metal wire grids made of different metal materials, in accordance with some embodiments of the present disclosure;

FIG. 37 is a diagram showing relationships between wavelengths and reflectivities of three metal wire grids made of different metal materials, in accordance with some embodiments of the present disclosure;

FIG. 38 is a diagram showing relationships between wavelengths and transmittances of various metal wire grids each having a different thickness of a first metal layer, in accordance with some embodiments of the present disclosure;

FIG. 39 is a diagram showing relationships between wavelengths and absorptivities of various metal wire grids each having a different thickness of a first metal layer, in accordance with some embodiments of the present disclosure;

FIG. 40 is a diagram showing relationships between wavelengths and reflectivities of various metal wire grids each having a different thickness of a first metal layer, in accordance with some embodiments of the present disclosure;

FIG. 41 is a diagram showing relationships between thicknesses of a first metal layer and transmittances, absorptivities as well as reflectivities of various metal wire grids each having a different thickness of the first metal layer, in accordance with some embodiments of the present disclosure;

FIG. 42 is a diagram showing relationships between wavelengths and transmittances of various metal wire grids each having a different refractive index of a light-transmitting dielectric pattern, in accordance with some embodiments of the present disclosure;

FIG. 43 is a diagram showing relationships between wavelengths and absorptivities of various metal wire grids each having a different refractive index of a light-transmitting dielectric pattern, in accordance with some embodiments of the present disclosure;

FIG. 44 is a diagram showing relationships between wavelengths and reflectivities of various metal wire grids each having a different refractive index of a light-transmitting dielectric pattern, in accordance with some embodiments of the present disclosure;

FIG. 45 is a diagram showing relationships between refractive indexes and both transmittances and absorptivities of various metal wire grids each having a different refractive index of a light-transmitting dielectric pattern, in accordance with some embodiments of the present disclosure;

FIG. 46 is a diagram showing relationships between wavelengths and transmittances of various metal wire grids each having a different repetition period of second metal patterns, in accordance with some embodiments of the present disclosure;

FIG. 47 is a diagram showing relationships between wavelengths and absorptivities of various metal wire grids each having a different repetition period of second metal patterns, in accordance with some embodiments of the present disclosure;

FIG. 48 is a diagram showing relationships between wavelengths and reflectivities of various metal wire grids each having a different repetition period of second metal patterns, in accordance with some embodiments of the present disclosure;

FIG. 49 is a diagram showing relationships between repetition periods and both transmittances and absorptivities of various metal wire grids each having a different repetition period of second metal patterns, in accordance with some embodiments of the present disclosure;

FIG. 50 is a diagram showing relationships between wavelengths and transmittances of various metal wire grids with different line widths, in accordance with some embodiments of the present disclosure;

FIG. 51 is a diagram showing relationships between wavelengths and absorptivities of various metal wire grids with different line widths, in accordance with some embodiments of the present disclosure;

FIG. 52 is a diagram showing relationships between wavelengths and reflectivities of various metal wire grids with different line widths, in accordance with some embodiments of the present disclosure;

FIG. 53 is a diagram showing relationships between dimensions of a second metal pattern in a second direction and both transmittances and absorptivities of various metal wire grids each having a different dimension of the second metal pattern, in accordance with some embodiments of the present disclosure;

FIG. 54 is a diagram showing relationships between wavelengths and transmittances of various metal wire grids each having a different thickness of a light-transmitting dielectric pattern, in accordance with some embodiments of the present disclosure;

FIG. 55 is a diagram showing relationships between wavelengths and absorptivities of various metal wire grids each having a different thickness of a light-transmitting dielectric pattern, in accordance with some embodiments of the present disclosure;

FIG. 56 is a diagram showing relationships between wavelengths and reflectivities of various metal wire grids each having a different thickness of a light-transmitting dielectric pattern, in accordance with some embodiments of the present disclosure;

FIG. 57 is a diagram showing relationships between thicknesses of a light-transmitting dielectric pattern and transmittances, absorptivities as well as reflectivities of various metal wire grids each having a different thickness of the light-transmitting dielectric pattern, in accordance with some embodiments of the present disclosure;

FIG. 58 is a diagram showing relationships between thicknesses of a light-transmitting dielectric pattern and both transmittances and absorptivities of a light-emitting device with a buffer layer, and relationships between the thicknesses of the light-transmitting dielectric pattern and both transmittances and absorptivities of a light-emitting device without a buffer layer, in accordance with some embodiments of the present disclosure;

FIG. 59 is a diagram showing relationships between wavelengths and transmittances of various metal wire grids each having a different thickness of a buffer layer, in accordance with some embodiments of the present disclosure;

FIG. 60 is a diagram showing relationships between wavelengths and absorptivities of various metal wire grids each having a different thickness of a buffer layer, in accordance with some embodiments of the present disclosure;

FIG. 61 is a diagram showing relationships between wavelengths and reflectivities of various metal wire grids each having a different thickness of a buffer layer, in accordance with some embodiments of the present disclosure;

FIG. 62 is a diagram showing relationships between thicknesses of a buffer layer and transmittances, absorptivities as well as reflectivities of various metal wire grids each having a different thickness of the buffer layer, in accordance with some embodiments of the present disclosure;

FIG. 63 is a diagram showing relationships between wavelengths and transmittances of various metal wire grids each having a different refractive index of a buffer layer, in accordance with some embodiments of the present disclosure;

FIG. 64 is a diagram showing relationships between wavelengths and absorptivities of various metal wire grids each having a different refractive index of a buffer layer, in accordance with some embodiments of the present disclosure;

FIG. 65 is a diagram showing relationships between wavelengths and reflectivities of various metal wire grids each having a different refractive index of a buffer layer, in accordance with some embodiments of the present disclosure;

FIG. 66 is a diagram showing relationships between refractive indexes of a buffer layer and transmittances, absorptivities as well as reflectivities of various metal wire grids each having a different refractive index of the buffer layer, in accordance with some embodiments of the present disclosure;

FIG. 67 is a diagram showing relationships between wavelengths and both transmittances and polarization degrees in a case where a metal wire grid includes a base, in accordance with some embodiments of the present disclosure;

FIG. 68 is a diagram showing relationships between wavelengths and transmittances, absorptivities as well as reflectivities of an optimized metal wire grid, in accordance with some embodiments of the present disclosure;

FIG. 69 is a diagram showing relationships between wavelengths and both transmittances and polarization degrees of an optimized metal wire grid, in accordance with some embodiments of the present disclosure;

FIG. 70 is a structural diagram of a phase conversion layer, in accordance with some embodiments of the present disclosure;

FIG. 71 is a structural diagram of another phase conversion layer, in accordance with some embodiments of the present disclosure;

FIG. 72 is a structural diagram of yet another phase conversion layer, in accordance with some embodiments of the present disclosure;

FIG. 73 is a structural diagram of yet another light-emitting device, in accordance with some embodiments of the present disclosure;

FIG. 74 is a distribution diagram of light emitted from a single light-emitting device, in accordance with some embodiments of the present disclosure;

FIG. 75 is a distribution diagram of light emitted from a plurality of light-emitting devices arranged in an array, in accordance with some embodiments of the present disclosure;

FIG. 76 is a comparison diagram of light emitted from a single light-emitting device and light emitted from a plurality of light-emitting devices arranged in an array, in accordance with some embodiments of the present disclosure;

FIG. 77 is a structural diagram of yet another light-emitting device, in accordance with some embodiments of the present disclosure;

FIG. 78 is a structural diagram of yet another phase conversion layer, in accordance with some embodiments of the present disclosure;

FIGS. 79(a)-(d) are structural diagrams showing four different shapes of nanostructures, in accordance with some embodiments of the present disclosure;

FIG. 80 is a structural diagram showing a metal wire grid and a phase conversion layer, in accordance with some embodiments of the present disclosure;

FIG. 81 is another structural diagram showing a metal wire grid and a phase conversion layer, in accordance with some embodiments of the present disclosure;

FIG. 82 is a diagram showing a relationship between a height of a nanostructure and a polarization conversion rate, in accordance with some embodiments of the present disclosure;

FIG. 83 is a diagram showing a relationship between a minimum repetition period of a phase conversion layer in a direction of a first side and a polarization conversion rate, in accordance with some embodiments of the present disclosure;

FIG. 84 is a diagram showing a relationship between a dimension of a first side of a nanostructure and a polarization conversion rate, in accordance with some embodiments of the present disclosure;

FIG. 85 is a diagram showing a relationship between a polarization conversion rate and a ratio of a dimension of a second side of a nanostructure to a minimum repetition period in a direction of the second side of the nanostructure, in accordance with some embodiments of the present disclosure;

FIG. 86 is yet another structural diagram showing a metal wire grid and a phase conversion layer, in accordance with some embodiments of the present disclosure;

FIG. 87 is a diagram showing another relationship between a height of a nanostructure and a polarization conversion rate, in accordance with some embodiments of the present disclosure;

FIG. 88 is a diagram showing another relationship between a minimum repetition period of a phase conversion layer in a direction of a minor axis and a polarization conversion rate, in accordance with some embodiments of the present disclosure;

FIG. 89 is a diagram showing another relationship between a dimension of a minor axis of a nanostructure and a polarization conversion rate, in accordance with some embodiments of the present disclosure;

FIG. 90 is a diagram showing another relationship between a polarization conversion rate and a ratio of a dimension of a major axis of a nanostructure to a minimum repetition period in a direction of the major axis of the nanostructure, in accordance with some embodiments of the present disclosure;

FIG. 91 is a structural diagram showing an isolation portion and a current blocking layer, in accordance with some embodiments of the present disclosure;

FIG. 92 is a structural diagram of a backlight module in an implementation;

FIG. 93 is a schematic diagram of testing depolarization degree, in accordance with some embodiments of the present disclosure;

FIG. 94 is a comparison diagram of depolarization degrees and transmittances of optical film layers in a backlight module in an implementation;

FIG. 95 is a structural diagram of another backlight module, in accordance with some embodiments of the present disclosure;

FIG. 96 is a diagram showing a relationship between optical distances of a backlight module and uniformities, in accordance with some embodiments of the present disclosure;

FIG. 97 is a diagram showing a relationship between the numbers of uniform-light layers in a backlight module and uniformities, in accordance with some embodiments of the present disclosure;

FIG. 98 is a diagram showing a relationship between positional offsets of a uniform-light layer in a backlight module and uniformities, in accordance with some embodiments of the present disclosure;

FIG. 99 is a diagram showing results of the numbers of uniform-light layers in a backlight module, uniformities, and depolarization degrees, in accordance with some embodiments of the present disclosure;

FIG. 100 is a structural diagram showing a uniform-light layer and a substrate, in accordance with some embodiments of the present disclosure;

FIG. 101 is a diagram showing a relationship between arch heights and depolarization degrees of a uniform-light layer, in accordance with some embodiments of the present disclosure;

FIG. 102 is a diagram showing a relationship between apertures and uniformities of a uniform-light layer, in accordance with some embodiments of the present disclosure;

FIGS. 103 and 104 are diagrams showing relationships between convergence abilities and convergence angles of various uniform-light layers with different arch heights, in accordance with some embodiments of the present disclosure;

FIG. 105 is a diagram showing a relationship between enhancement factors and apertures of a uniform-light layer, in accordance with some embodiments of the present disclosure;

FIG. 106 is a diagram showing a relationship between enhancement factors and arch heights of a uniform-light layer, in accordance with some embodiments of the present disclosure;

FIG. 107 is a structural diagram of yet another backlight module, in accordance with some embodiments of the present disclosure;

FIG. 108 is a structural diagram of yet another backlight module, in accordance with some embodiments of the present disclosure;

FIG. 109 is a structural diagram of a display substrate, in accordance with some embodiments of the present disclosure;

FIG. 110 is a structural diagram of another display substrate, in accordance with some embodiments of the present disclosure;

FIG. 111 is a flow chart of a manufacturing method for a light-emitting device, in accordance with some embodiments of the present disclosure;

FIGS. 112 and 113 are structural diagrams of a light-emitting device in different manufacturing stages, in accordance with some embodiments of the present disclosure;

FIG. 114 is a flow chart of a manufacturing method for another light-emitting device, in accordance with some embodiments of the present disclosure;

FIGS. 115 to 119 are structural diagrams of another light-emitting device in different manufacturing stages, in accordance with some embodiments of the present disclosure;

FIG. 120 is a flow chart of a manufacturing method for another light-emitting device, in accordance with some embodiments of the present disclosure;

FIGS. 121 and 122 are structural diagrams of another light-emitting device in different manufacturing stages, in accordance with some embodiments of the present disclosure;

FIG. 123 is a flow chart of a manufacturing method for another light-emitting device, in accordance with some embodiments of the present disclosure;

FIGS. 124 to 126 are structural diagrams of another light-emitting device in different manufacturing stages, in accordance with some embodiments of the present disclosure;

FIGS. 127 to 134 are flow charts of manufacturing a light-emitting device, in accordance with some embodiments of the present disclosure; and

FIG. 135 is a schematic diagram of light emitted from a display apparatus being incident onto the human eye, in accordance with some embodiments of the present disclosure.

### DESCRIPTION OF THE INVENTION

The technical solutions in embodiments of the present disclosure will be described clearly and completely with reference to the accompanying drawings. Obviously, the described embodiments are merely some but not all of embodiments of the present disclosure. All other embodiments obtained by a person of ordinary skill in the art based on the embodiments of the present disclosure shall be included in the protection scope of the present disclosure.

Unless the context requires otherwise, throughout the description and claims, the term “comprise” and other forms thereof such as the third-person singular form “comprises” and the present participle form “comprising” are construed as an open and inclusive meaning, i.e., “included, but not limited to”. In the description of the specification, terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials, or characteristics may be included in any one or more embodiments or examples in any suitable manner.

Hereinafter, the terms such as “first” and “second” are used for descriptive purposes only, but are not to be construed as indicating or implying the relative importance or implicitly indicating the number of indicated technical features. Thus, a feature defined with “first” or “second” may explicitly or implicitly include one or more of the features. In the description of the embodiments of the present disclosure, the term “a/the plurality of” means two or more unless otherwise specified.

The phrase “A and/or B” includes the following three combinations: only A, only B, and a combination of A and B.

The phrase “applicable to” or “configured to” used herein means an open and inclusive expression, which does not exclude devices that are applicable to or configured to perform additional tasks or steps.

The term such as “about”, “substantially” or “approximately” as used herein includes a stated value and an average value within an acceptable range of deviation of a particular value determined by a person of ordinary skilled in the art, considering measurement in question and errors associated with measurement of a particular quantity (i.e., limitations of a measurement system).

The term such as “perpendicular” or “equal” as used herein includes a stated condition and a condition similar to the stated condition. A range of the similar condition is in an acceptable range of deviation, and the acceptable range of deviation is determined by a person of ordinary skill in the art in view of measurement in question and errors associated with measurement of a particular quantity (i.e., limitations of a measurement system). For example, the term “perpendicular” includes absolute perpendicularity and approximate perpendicularity, and an acceptable range of deviation of the approximate perpendicularity may be, for example, a deviation within 5°. The term “equal” includes absolute equality and approximate equality, and an acceptable range of deviation of the approximate equality may be, for example, a difference between two equals being less than or equal to 5% of any one of the two equals.

It should be understood that, in a case where a layer or an element is referred to be on another layer or a substrate, it may be that the layer or the element is directly on the another layer or the substrate, or there may be intervening layer(s) between the layer or the element and the another layer or the substrate.

Exemplary embodiments are described herein with reference to sectional views and/or plan views as idealized exemplary drawings. In the drawings, thicknesses of layers and sizes of regions are enlarged for clarity. Variations in shapes relative to the accompanying drawings due to, for example, manufacturing technologies and/or tolerances may be envisaged. Therefore, the exemplary embodiments should not be construed as being limited to the shapes of the regions shown herein, but including shape deviations due to, for example, manufacturing. For example, an etched region shown to have a rectangular shape generally has a feature of being curved. Therefore, the regions shown in the accompanying drawings are schematic in nature, and their shapes are not intended to show actual shapes of regions in an apparatus, and are not intended to limit the scope of the exemplary embodiments.

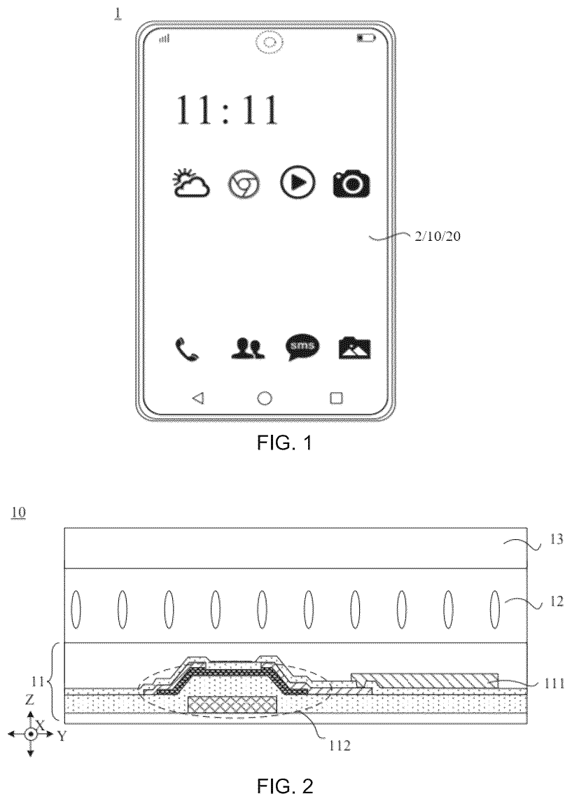

As shown in FIG. 1, some embodiments of the present disclosure provide a display apparatus 1. The display apparatus 1 may be any display apparatus that displays images whether in motion (e.g., videos) or stationary (e.g., static images), and whether textual or graphical. More specifically, it is expected that the display apparatus in the embodiments may be implemented in or associated with a variety of electronic apparatuses. The variety of electronic apparatuses may include (but are not limited to), for example, mobile phones, wireless apparatuses, personal data assistants (PDAs), hand-held or portable computers, GPS receivers/navigators, cameras, MP4 video players, video cameras, game consoles, watches, clocks, calculators, television monitors, flat panel displays, computer monitors, car displays (such as odometer displays), navigators, cockpit controllers and/or displays, camera view displays (such as rear view camera displays in vehicles), electronic photos, electronic billboards or indicators, projectors, building structures, packagings and aesthetic structures (such as a display for an image of a piece of jewelry), etc.

For example, the display apparatus 1 can be a head-mounted display apparatus, and can be used in 2D, 3D, VR (virtual reality), AR (augmented reality), MR (mixed reality) and other near-eye display fields, as well as lighting fields.

For example, the display apparatus 1 includes a frame, a display driver integrated circuit (IC) and other electronic components.

In some embodiments, the display apparatus 1 further includes a display substrate 2 that can be directly used for image display. In this case, the display apparatus 1 is an active light-emitting display apparatus. Since the display substrate 2 itself can emit light, there is no need to configure an additional backlight module.

For example, the display substrate 2 includes light-emitting devices. For example, the light-emitting device includes a light-emitting diode (LED).

In some other embodiments, the display apparatus 1 further includes a display panel 10.

In some examples, the display panel 10 is a liquid crystal display (LCD) panel.

For example, a driving mode of the display panel 10 may be a passive matrix (PM) driving mode or an active matrix (AM) driving mode. In a case where the driving mode of the display panel 10 is the active matrix driving mode, the display panel 10 may be, for example, a thin film transistor liquid crystal display (TFT-LCD) panel.

For example, as shown in FIG. 2, the display panel 10 includes an array substrate 11, a liquid crystal layer 12, and a color filter substrate 13 that are stacked in sequence.

For example, the array substrate 11 includes a plurality of pixel electrodes 111 and a plurality of pixel driving circuits 112. The plurality of pixel electrodes 111 are electrically connected to the plurality of pixel driving circuits 112 in one-to-one correspondence. The pixel driving circuit 112 provides a pixel voltage for the corresponding pixel electrode 111.

For example, the display panel 10 further includes common electrode(s).

An arrangement position of the common electrode(s) is related to a display type of the display panel 10. In the embodiments of the present disclosure, the display type of the display panel 10 may be an ADS (advanced super dimension switch) display type, IPS (In-plane switching) display type, VA (vertical alignment) display type, FFS (fringe field switching) display type, TN (twisted nematic) display type, or the like. Therefore, the arrangement position of the common electrode(s) in the embodiments of the present disclosure varies.

For example, in a case where the display panel 10 is of the IPS display type, the common electrode is arranged in the array substrate 11 and in the same layer as the pixel electrode 111. Thus, the common electrode and the pixel electrode 111 may be formed simultaneously in one patterning process, thereby simplifying a manufacturing process of the display panel 10.

For another example, in a case where the display panel 10 is of the FFS display type or ADS display type, the common electrode is arranged in the array substrate 11 and located in a different layer from the pixel electrode 111. Thus, it may be possible to avoid mutual interference between a pixel voltage signal on the pixel electrode 111 and a common voltage on the common electrode, improving the accuracy of the pixel voltage signal and the common voltage.

For another example, in a case where the display panel 10 is of the TN display type or VA display type, the common electrode is arranged in the color filter substrate 13.

For example, the liquid crystal layer 12 includes liquid crystal molecules. For example, the display panel 10 is of the TN display type, an electric field can be formed between the pixel electrode 111 and the common electrode, and liquid crystal molecules located between the pixel electrode 111 and the common electrode can be deflected under the action of the electric field.

For example, the color filter substrate 13 includes a plurality of color filters. For example, in a case where light incident on the color filters is white light, the color filters can include red filters, green filters, and blue filters. For example, the red filter can only transmit red light in the incident light, the green filter can only transmit green light in the incident light, and the blue filter can only transmit blue light in the incident light. For another example, in a case where light incident on the color filters is blue light, the color filters can include red filters and green filters.

Of course, the color filter substrate 13 further includes a black matrix. The black matrix can be used to prevent light mixing.

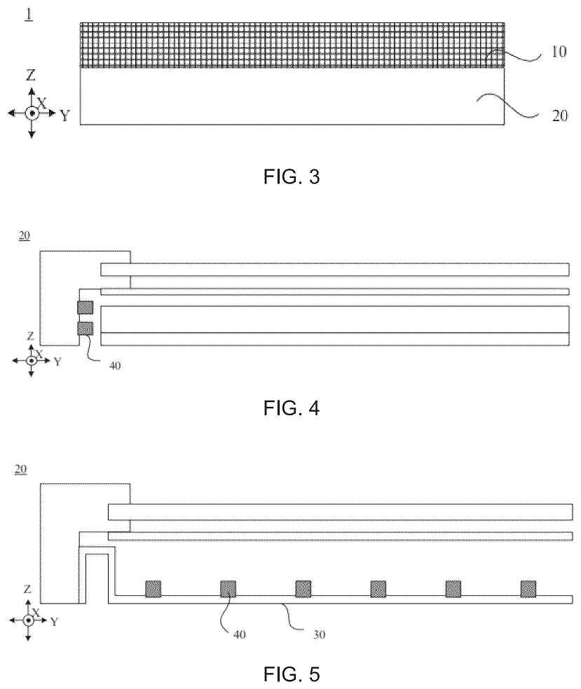

For example, as shown in FIG. 3, the display apparatus 1 further includes a backlight module 20.

For example, the backlight module 20 is used to provide backlight for the display panel 10. The display panel 10 is located on a light-exit side of the backlight module 20. The light-exit side of the backlight module 20 refers to a side from which the backlight module 20 emits light.

It can be understood that the backlight provided by the backlight module 20 can pass through the array substrate 11 and be incident on liquid crystal molecules in the liquid crystal layer 12. Under the action of the electric field formed between the pixel electrode 111 and the common electrode, the liquid crystal molecules deflect to a certain extent, thereby changing a polarization direction of light passing through the liquid crystal molecules. After that, the above-mentioned light passes through the filters of different colors in the color filter substrate 13 and then exit. The exit light includes light of various colors, such as red light, green light, and blue light. The light of various colors cooperates with each other to enable the display apparatus 1 to achieve display.

For example, the backlight module 20 is a backlit backlight module or an edge-lit backlight module. FIG. 4 shows the edge-lit backlight module, and FIG. 5 shows the backlit backlight module.

As shown in FIGS. 4 and 5, the edge-lit backlight module is generally thinner and lighter than the backlit backlight module. However, the backlit backlight module can independently control the brightness of different areas, thereby providing local backlight and ultra-high contrast backlight.

A backlight module is introduced below by taking an example where the backlight module 20 is the backlit backlight module.

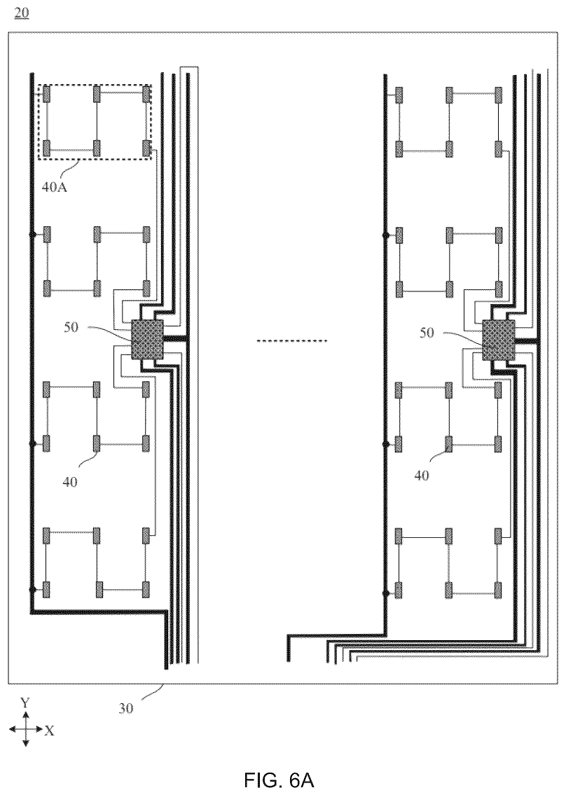

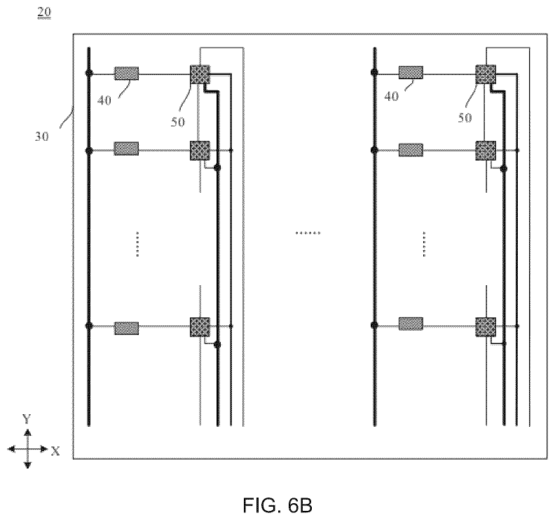

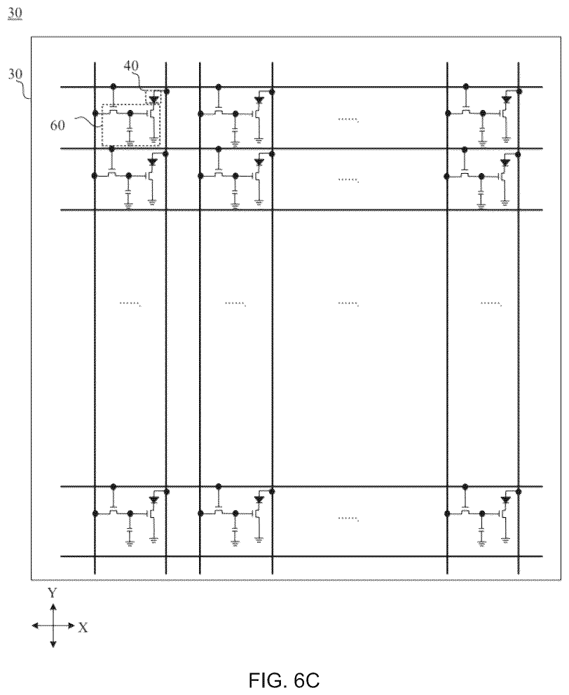

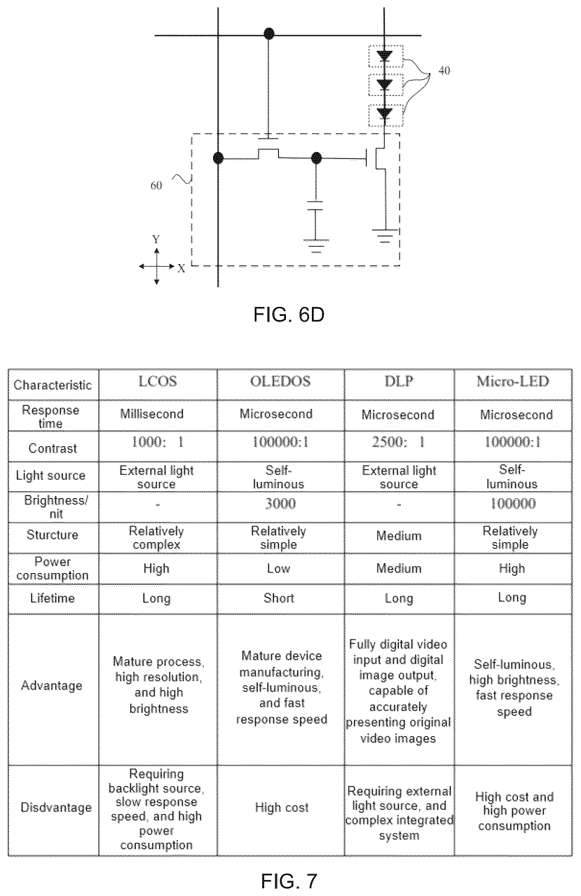

In some embodiments, as shown in FIGS. 6A to 6C, the backlight module 20 includes a substrate 30 and a plurality of light-emitting devices 40.

For example, the light-emitting device 40 is an LED light-emitting device, e.g., a mini light-emitting diode (Mini LED) with a size in a range of 100 μm to 500 μm, or a micro light-emitting diode (Micro LED) with a size less than 100 μm, or an LED with a larger size.

For example, the plurality of light-emitting devices 40 emit light under the control of the substrate 30.

It can be understood that, there are many ways for the substrate 30 to control the working states of the plurality of light-emitting devices 40, which may be set according to actual situations, and the embodiments of the present disclosure do not limit this.

In some examples, as shown in FIGS. 6A and 6B, the substrate 30 includes a plurality of chips 50, and the plurality of chips 50 are arranged in multiple rows and multiple columns. A single chip 50 is electrically connected to at least one light-emitting device 40.

For example, as shown in FIG. 6B, a single chip 50 is electrically connected to one light-emitting device 40, and the chip 50 controls the working state of the light-emitting device 40 electrically connected thereto.

For another example, as shown in FIG. 6A, a single chip 50 is electrically connected to multiple light-emitting devices 40, and the chip 50 controls the working state of the multiple light-emitting devices 40 electrically connected thereto.

It can be understood that, each chip 50 works independently, so that working states of different light-emitting devices 40 electrically connected to different chips may be controlled to be different.

For example, in the case where a single chip 50 is electrically connected to multiple light-emitting devices 40, there are many ways for the chip 50 to electrically connect the multiple light-emitting devices 40, which may be set according to actual needs, and the embodiments of the present disclosure do not limit this.

For example, the multiple light-emitting devices 40 are individually and directly electrically connected to the same chip 50.

For another example, as shown in FIG. 6A, at least two light-emitting devices 40 are connected in series to form a light-emitting device group 40A, and at least one light-emitting device group 40A is electrically connected to one chip 50.

With the above arrangement, the chips 50 in the substrate 30 may be used to control the emission of the plurality of light-emitting devices 40, thereby facilitating the control of the light-emitting devices 40 by the substrate 30, and ensuring that the backlight module 20 can provide backlight for the display panel 10.

In some other examples, as shown in FIG. 6C, the substrate 30 includes a plurality of driving circuit 60. The plurality of driving circuit 60 may be arranged in multiple rows and multiple columns.

In some examples, as shown in FIGS. 6C and 6D, a single driving circuit 60 is electrically connected to at least one light-emitting device 40, and the driving circuit 60 transmits a control signal to the light-emitting device 40 electrically connected thereto, thereby controlling the emission of the light-emitting device 40.

For example, as shown in FIG. 6C, a single driving circuit 60 is electrically connected to one light-emitting device 40.

For another example, as shown in FIG. 6D, a single driving circuit 60 is electrically connected to multiple light-emitting devices 40 that are connected in series.

With the above arrangement, the plurality of driving circuits 60 in the substrate 30 may be used to control the plurality of light-emitting devices 40 to emit light, so that the backlight module 20 may provide backlight for the display panel, and the structure of the substrate 30 is simple, which is convenient for manufacturing of the substrate 30 and the backlight module 20.

At present, common display apparatuses may generally be divided, according to their types, into LCOS (liquid crystal on silicon) display apparatuses, OLEDOS (organic light-emitting diode on silicon) display apparatuses, DLP (digital light processing) display apparatuses, Micro-LED direct-display display apparatuses, etc. The inventors have summarized the characteristics of the above four types of display apparatuses, and obtained FIG. 7.

It can be seen that the Micro-LED direct-display display apparatus has obvious advantages. It has high brightness of display image, fast response speed, simple structure, and long lifetime.

In addition, compared with an OLED display apparatus, the LCD display apparatus has larger power consumption. Generally, the power consumption of the LCD display apparatus is four times that of the OLED display apparatus. The main reason is that in the LCD display apparatus, the light-emitting devices in the backlight module are LED light-emitting devices, and compared with OLED light-emitting devices in the OLED display apparatus, the light emitted by the LED light-emitting devices is more divergent and the light extraction efficiency is lower. Thus, the power consumption of the backlight module and display apparatus is large. Especially in the near-eye display field, in order to improve the display effect, the backlight module generally needs to provide backlight with a single-polarization state and high brightness for the display panel.

However, as the resolution of near-eye display apparatuses or display products continues to increase, the transmittance of the display panel in the display apparatus is greatly reduced (for example, reduced to less than half of the original value). As a result, after the backlight provided by the backlight module passes through the display panel, its brightness also drops by about half. In addition, the backlight provided by the backlight module also needs to pass through the polarizer, and the polarizer absorbs part of the light, causing the display brightness of the display apparatus to further decrease. Moreover, in a case where the display apparatus includes the display substrate, and the display substrate itself emits light, the light extraction efficiency of the display substrate is low, which seriously affects the power consumption of the display apparatus. Therefore, there is an urgent need to provide a high-brightness single-polarization light-emitting device, backlight module and display substrate to reduce the display power consumption of the display apparatus.

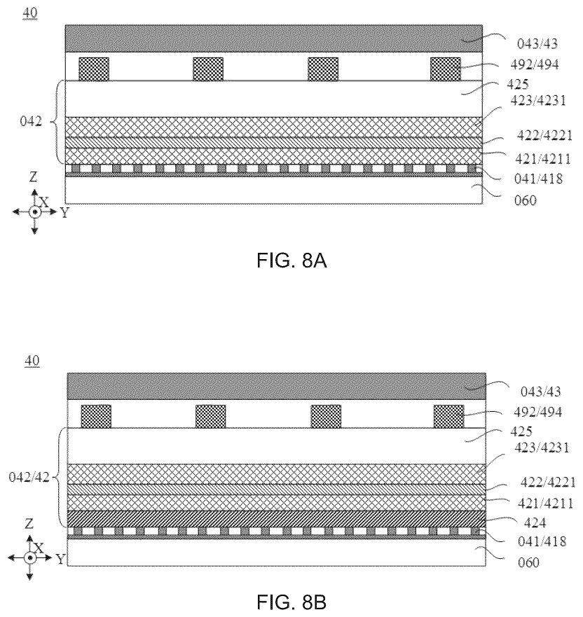

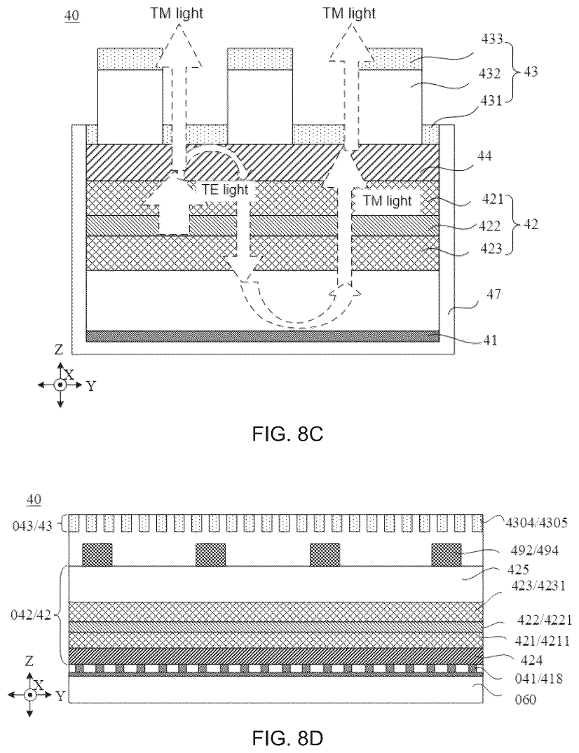

In light of this, some embodiments of the present disclosure provide a light-emitting device, and as shown in FIGS. 8A to 8C, the light-emitting device 40 includes a first light conversion layer 041, a light-emitting portion 042, and a second light conversion layer 043.

For example, the second light conversion layer 043 is located on a side of the light-emitting portion 042 away from the first light conversion layer 041.

For example, the light-emitting portion 042 is located on a side of the first light conversion layer 041, and between the first light conversion layer 041 and the second light conversion layer 043. The light-emitting portion 042 is used for emitting light, e.g., natural light.

The light emitted by the light-emitting portion 042 may be directed towards the first light conversion layer 041, and may also be directed towards the second light conversion layer 043. A light-exit direction of the light-emitting device 40 is substantially along a direction pointing from the light-emitting portion 042 to the second light conversion layer 043.

In some examples, the first light conversion layer 041 is configured to change a traveling direction of part of light incident on the first light conversion layer 041, so that the light with a change in the traveling direction exits in a direction towards the second light conversion layer 043, and a polarization direction of at least part of the light with the change in the traveling direction is changed.

The second light conversion layer 043 is configured to change a traveling direction of part of light incident on the second light conversion layer 043, so that the light with a change in the traveling direction exits in a direction towards the first light conversion layer 041; and the second light conversion layer 043 is configured to enable at least part of light entering the second light conversion layer 043 to form linearly polarized light to exit from the light-emitting device 40.

For example, the light incident on the first light conversion layer 041 may include at least three types of light. A first type of light may be light directly incident on the first light conversion layer 041 from the light-emitting portion 042. The light is changed in the traveling direction by the first light conversion layer 041 and then exits, and the polarization direction of the light with the change in the traveling direction is also changed. A second type of light may be light that is emitted by the light-emitting portion 042 and is incident on the second light conversion layer 043, then is changed in the traveling direction by the second light conversion layer 043, and is incident on the first light conversion layer 041 after passing through the light-emitting portion 042. A third type of light may be light that is emitted by the light-emitting portion 042 and is incident on the second light conversion layer 043, and then travels in the following process: first, the light is changed in the traveling direction by the second light conversion layer 043 to be incident on the first light conversion layer 041 and then is incident on the second light conversion layer 043 again after its traveling direction is changed by the first light conversion layer 041, then the light is incident on the first light conversion layer 041 again after its traveling direction is changed by the second light conversion layer 043, and finally the light is incident on the first light conversion layer 041 after oscillating multiple times between the first light conversion layer 041 and the second light conversion layer 043.

Similarly, the light incident on the second light conversion layer 043 may also include at least three types of light. A first type of light may be light directly incident on the second light conversion layer 043 from the light-emitting portion 042. A second type of light may be light that is emitted by the light-emitting portion 042, is incident on the first light conversion layer 041 first, and then is incident on the second light conversion layer 043 after its traveling direction is changed by the first light conversion layer 041. A third type of light may be light that is emitted by the light-emitting portion 042 and is incident on the first light conversion layer 041, and then travels in the following process: first, the light is changed in the traveling direction by the first light conversion layer 041 to be incident on the second light conversion layer 043, then is incident on the first light conversion layer 041 again after its traveling direction is changed by the second light conversion layer 043 and is incident on the second light conversion layer 043 again after its traveling direction is changed by the first light conversion layer 041, and finally the light is incident on the second light conversion layer 043 after oscillating multiple times between the first light conversion layer 041 and the second light conversion layer 043.

The light emitted by the light-emitting portion 042 may substantially include a first type of light and a second type of light; the first type of light and the second type of light may both be linearly polarized light, and a polarization direction of the first type of light is different from a polarization direction of the second type of light. For example, an included angle between the polarization direction of the first type of light and the polarization direction of the second type of light may be around 90°.

The first light conversion layer 041 may reflect or scatter the light incident thereon to change the traveling direction of the light, and to change the polarization direction of the second type of light incident thereon. For example, the first light conversion layer 041 changes the polarization direction of the second type of light to the same direction as the polarization direction of the first type of light, i.e., converts the second type of light incident thereon into the first type of light.

The second light conversion layer 043 may also reflect or scatter part of the light incident thereon to change traveling direction of the light, e.g., to change the traveling direction of the second type of light incident thereon. The second light conversion layer 043 may also transmit part of the light incident thereon, e.g., transmit the first type of light incident thereon, so that at least part of the light incident on the second light conversion layer 043 exits as polarized light.

Thus, under the cooperation of the first light conversion layer 041 and the second light conversion layer 043, part of the light emitted by the light-emitting portion 042 (e.g., the first type of light) passes through the second light conversion layer 043 and then exits, and part of the light emitted by the light-emitting portion 042 (e.g., the second type of light) travels in the following process: the light is incident on the second light conversion layer 043 and is reflected (or scattered, “reflected” is used as an example for description here) by the second light conversion layer 043 to the first light conversion layer 041, and after the light is reflected (or scattered, “reflected” is used as an example for description here) by the first light conversion layer 041 and its polarization direction is changed by the first light conversion layer 041, the light is incident on the second light conversion layer 043 again and then exits from the second light conversion layer 043. As a result, it avoids the loss of light that is not transmitted by the second light conversion layer 043, so that the utilization rate of the light emitted by the light-emitting portion 042 is increased, the light loss of the light-emitting device 40 is reduced, which helps reduce the power consumption of the backlight module, the display substrate and the display apparatus.

In the light-emitting device 40 provided in the embodiments of the present disclosure, the light-emitting device 40 includes the first light conversion layer 041, the light-emitting portion 042 and the second light conversion layer 043; the light-emitting portion 042 is used to emit light and is located between the first light conversion layer 041 and the second light conversion layer 043; the second light conversion layer 043 changes the traveling direction of part of an incident light and enables at least part of the incident light to form linearly polarized light for exiting, so that the first type of light in the incident light may exit and the second type of light in the incident light may be reflected to the first light conversion layer 041; and the first light conversion layer 041 is capable of changing the traveling direction of an incident light and the polarization direction of the incident light, so that the light incident on the first light conversion layer 041 is changed in the traveling direction by the first light conversion layer 041 and then exits, and the second type of light in the light is changed in the polarization direction (for example, is converted into the first type of light) by the first light conversion layer 041 to be incident on the second light conversion layer 043 again, and then exits from the second light conversion layer 043. As a result, most of the light emitted by the light-emitting portion 042 is converted into light of a single-polarization state (i.e., the first type of light) under the cooperation of the first light conversion layer 041 and the second light conversion layer 043 and then exits, thereby improving the light extraction efficiency of the light-emitting device 40, reducing the light loss of the light-emitting device 40, alleviating or even avoiding the problem of low utilization rate of the light emitted by the light-emitting portion 042 caused by the light reflected by the second light conversion layer 043 being consumed. Thus, in a case where the light-emitting device 40 is applied to the backlight module 20, the display substrate 2 and the display apparatus 1, the backlight module 20 may provide light with the single-polarization state and high brightness for the display panel 10, thereby improving the light extraction efficiency of the backlight module 20, reducing the power consumption of the backlight module 20 and the display apparatus 1, improving the display effect of the display apparatus 1, enabling the display substrate 2 to emit light with the single-polarization state and high brightness, and reducing the power consumption of the display substrate 2.

It can be understood that the structure of the second light conversion layer 043 may be varied, and may be set according to actual needs, which is not limited in the present disclosure. In addition, the structure of the light-emitting portion 042 may be varied, and may be set according to actual needs, which is not limited in the present disclosure.

For example, the second light conversion layer 043 includes at least one wire grid. For example, the second light conversion layer 043 is a metal wire grid or a non-metal wire grid.

For example, the second light conversion layer 043 includes at least one metal wire grid 43. That is, the number of metal wire grids 43 in the light-emitting device 40 may be one or more.

For convenience of description, the following is introduced by taking an example where the light-emitting device 40 includes one metal wire grid 43.

In some examples, the light-emitting portion 042 is an epitaxial structure 42.

As shown in FIG. 8B, the light-emitting portion 042 or the epitaxial structure 42 may include a first semiconductor layer 421, a light-emitting layer 422, and a second semiconductor layer 423 that are stacked in sequence. The first semiconductor layer 421 is closer to the first light conversion layer 041 than the second semiconductor layer 423. The light-emitting layer 422 is located between the first semiconductor layer 421 and the second semiconductor layer 423.

Optionally, the light-emitting layer 422 may be a multiple quantum well (MQW) layer; a material of the first semiconductor layer 421 may be p-GaN (p-type gallium nitride); and a material of the second semiconductor layer 423 may be n-GaN (n-type gallium nitride).

For example, different voltages are applied to the first semiconductor layer 421 and the second semiconductor layer 423, a voltage difference is generated between the first semiconductor layer 421 and the second semiconductor layer 423, and the light-emitting layer 422 emits light (for example, the light is natural light) under the action of the voltage difference.

Optionally, the light-emitting layer 422 may be a multiple quantum well (MQW) layer; a material of the first semiconductor layer 421 may be n-GaN (n-type gallium nitride); and a material of the second semiconductor layer 423 may be p-GaN (p-type gallium nitride).

In some embodiments, as shown in FIG. 8B, the light-emitting portion 042 further includes a current spreading layer 424 located on a side of the first semiconductor layer 421 away from the light-emitting layer 422.

For example, the current spreading layer 424 is made of a conductive material, such as indium tin oxide (ITO).

For example, the current spreading layer 424 is electrically connected to the first semiconductor layer 421.

The light-emitting portion 042 may further include a first sub-base 425 located on a side of the second semiconductor layer 423 away from the light-emitting layer 422.

For example, the first sub-base 425 is made of gallium nitride (GaN).

For example, in the case where the light-emitting portion 042 includes the first sub-base 425, a via hole may be provided in the first sub-base 425, and an electrode (e.g., the second electrode 492 mentioned below) of the light-emitting device 40 is electrically connected to the second semiconductor layer 423 through the via hole.

For example, the metal wire grid 43 is of a single wire grid structure or a double wire grid structure.

For example, the light emitted by the epitaxial structure 42 can include a first type of light and a second type of light. A polarization direction of the first type of light is perpendicular to a direction of a transmission axis of the metal wire grid 43. Here, in an example where the direction of the transmission axis of the metal wire grid 43 is the first direction X, the first type of light may be light along a direction of a transverse magnetic field, and the first type of light may be referred to as TM light for short. A polarization direction of the second type of light is parallel to the direction of the transmission axis of the metal wire grid 43. Here, in an example where the direction of the transmission axis of the metal wire grid 43 is the first direction X, the second type of light may be light along a direction of a transverse electric field, and the second type of light may be referred to as TE light for short. TM light can pass through the metal wire grid 43 and then exit, and TE light can be reflected by the metal wire grid 43.

As a result, the metal wire grid 43 may be used to filter the light emitted by the epitaxial structure 42, so that polarization directions of the light exiting from the metal wire grid 43 in the light-emitting device 40 are substantially the same. Thus, the light-emitting device 40 may be used to provide light of the single-polarization state for the backlight module 20 or display substrate 2, so that the display panel displays images under the light of the single-polarization state provided by the backlight module; or the display substrate 2 emits the light of the single-polarization state using the light-emitting device 40, thereby improving the display effect of the display apparatus 1.

For example, a distance between metal patterns (e.g., first metal patterns or second metal patterns mentioned below) in the metal wire grid 43 is on the order of sub-wavelength, so that the metal wire grid 43 has a certain polarization property within the visible light wavelength range.

For example, the first light conversion layer 041 is at least partially opposite to the epitaxial structure 42. Therefore, the light emitted by the epitaxial structure 42 may be incident on the first light conversion layer 041.

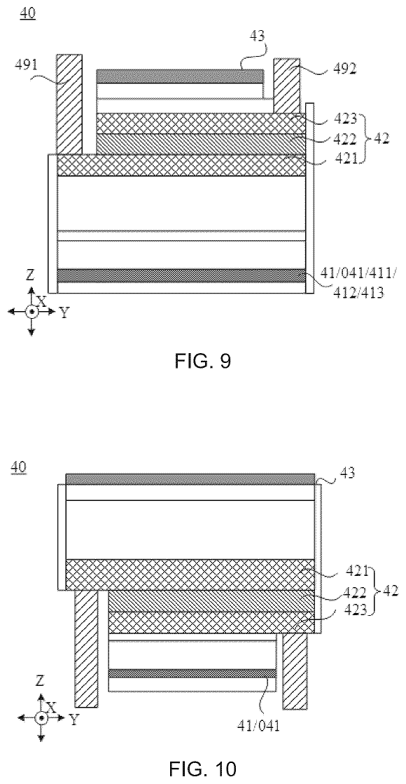

For example, as shown in FIGS. 9 to 11, the light-emitting device 40 may be of a flip-chip structure, a normal structure or a vertical structure.

It can be understood that, in a case where structures of the light-emitting devices 40 are different, a relative positional relationship between the first light conversion layer 041 and the epitaxial structure 42 in each light-emitting device 40 is also different.

In an example where a plane where the metal wire grid 43 is located is a reference plane, in a case where the light-emitting device 40 is of the normal structure, as shown in FIG. 9, an orthographic projection of the epitaxial structure 42 on the reference plane is located within an orthographic projection of the first light conversion layer 041 on the reference plane.

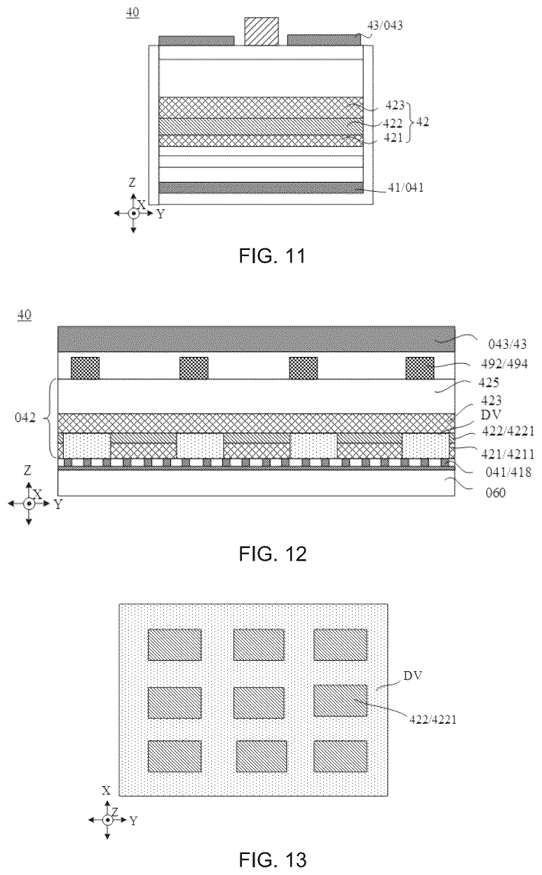

For another example, as shown in FIG. 11, in a case where the light-emitting device 40 is of the vertical structure, the orthographic projection of the epitaxial structure 42 on the reference plane substantially coincides with the orthographic projection of the first light conversion layer 041 on the reference plane.

For another example, as shown in FIG. 10, in a case where the light-emitting device 40 is of the flip-chip structure, the orthographic projection of the first light conversion layer 041 on the reference plane is located within the orthographic projection of the epitaxial structure 42 on the reference plane.

In some examples, as shown in FIGS. 8A to 8C, the first light conversion layer 041 is configured to change the traveling direction of part of light incident on the first light conversion layer 041, so that the light with the change in the traveling direction exits in a direction towards the metal wire grid 43, and the polarization direction of at least part of the light with the change in the traveling direction is changed.

It should be noted that the dotted arrows in FIG. 8C indicate approximate traveling paths of at least part of the light emitted by the epitaxial structure.

For example, after the traveling direction of part of the light incident on the first light conversion layer 041 is changed under the action of the first light conversion layer 041, and the polarization direction of at least part of the light is changed, the light is reflected by the first light conversion layer 041. For example, the incident direction of part of the light incident on the first light conversion layer 041 is substantially a direction of pointing from the epitaxial structure 42 to the first light conversion layer 041, and the exit direction of the part of the light after being reflected by the first light conversion layer 041 is substantially a direction of pointing from the first light conversion layer 041 to the metal wire grid 43.

In addition, as shown in FIG. 8C, the polarization direction of part of the light incident on the first light conversion layer 041 may be parallel to the direction of the transmission axis of the metal wire grid 43, and the polarization direction of at least part of the light exiting from the first light conversion layer 041 is changed. For example, the polarization direction of the at least part of the light has an included angle with the direction of the transmission axis of the metal wire grid 43. For example, an included angle between the polarization direction of the at least part of the light and the direction of the transmission axis of the metal wire grid 43 may be 90°, that is, they are perpendicular to each other. Thus, the at least part of the light can pass through the metal wire grid 43 and then exit. It can be understood that, the light incident on the first light conversion layer 041 includes TE light, and after passing through the first light conversion layer 041, the TE light can be converted into TM light; and thus, the light can pass through the metal wire grid 43 and then exit.

Thus, part of the light incident on the first light conversion layer 041 can pass through the epitaxial structure 42 again and then be incident on the metal wire grid 43, and can exit from the metal wire grid 43, thereby improving the utilization rate of the light emitted by the epitaxial structure 42, reducing the light loss of the light-emitting device 40, increasing the luminous efficiency of the backlight module 20 or the display substrate 2, and reducing the power consumption of the display apparatus 1.

Some embodiments of the present disclosure provide the light-emitting device 40, and the light-emitting device 40 includes the first light conversion layer 041, the epitaxial structure 42 and at least one metal wire grid 43 that are stacked in sequence. The first light conversion layer 041 can change the traveling direction and the polarization direction of the incident light, so that the direction of the light exiting from the first light conversion layer 041 is the direction towards the metal wire grid 43. Thus, in the light emitted by the epitaxial structure 42, TM light incident on the metal wire grid 43 passes through the metal wire grid 43 and then exits, and TE light incident on the metal wire grid 43 is reflected by the metal wire grid to the first light conversion layer 041. The TE light is changed in the traveling direction and the polarization direction by the first light conversion layer 041, then is incident on the metal wire grid 43 again, and exits from the metal wire grid. Therefore, the light-emitting device 40 can emit the light with the single-polarization state and high brightness, which can increase the light extraction efficiency of the light-emitting device 40, reduce the light loss of the light-emitting device 40, and avoid reducing the utilization rate of the light emitted by the epitaxial structure 42 caused by the consumption of light reflected from the metal wire grid 43. As a result, in a case where the light-emitting device 40 is applied to the backlight module 20, the display substrate 2 and the display apparatus 1, the backlight module 20 or the display substrate 2 may emit the light with the single-polarization state and high brightness, thereby increasing the light extraction efficiency of the backlight module 20 and the display substrate 2, reducing the power consumption of the display apparatus 1, and improving the display effect of the display apparatus 1.

It can be understood that there are many ways to realize that the light-emitting device 40 emits the single-polarization light. For example, a polarizer is provided on the epitaxial structure 42 of the light-emitting device 40. In the embodiments of the present disclosure, the metal wire grid 43 is used as the polarization structure. The metal wire grid 43 has excellent exit-light polarization degree, and the metal wire grid 43 can be directly integrated on the epitaxial structure 42, thereby improving the integration degree of the light-emitting device 40, reducing dependence on the supply chain for production of polarizers in the manufacturing process of light-emitting devices 40, and improving the production capacity of light-emitting devices 40.

In some other embodiments, as shown in FIG. 12, the light-emitting device 40 further includes an isolation portion DV. The isolation portion DV separates the light-emitting layer 422 in the light-emitting portion 042 into a plurality of island-shaped light-emitting units 4221, and the island-shaped light-emitting units 4221 are configured to emit light.

For example, the plurality of island-shaped light-emitting units 4221 are not connected to each other and are isolated from each other. The plurality of island-shaped light-emitting units 4221 may be arranged in an array. Colors of light emitted by the island-shaped light-emitting units 4221 in the same light-emitting device 40 may be the same or substantially the same.

With the above arrangement, luminous states of the plurality of island-shaped light-emitting units 4221 may be independent of each other and may not interfere with each other. Each island-shaped light-emitting unit 4221 may be driven to emit light independently, thereby achieving precise control of each island-shaped light-emitting unit 4221, and reducing impact of a poor luminous state of a single island-shaped light-emitting unit 4221 on the overall luminous state of the light-emitting device 40. A light-emitting area of the single island-shaped light-emitting unit 4221 may also be made relatively small, so that a size of the pixel formed by the single island-shaped light-emitting unit 4221 is relatively small in a case where the light-emitting device 40 is applied to the display substrate 2, thereby reducing the pixel size of the display substrate 2, increasing the pixel density of the display substrate 2, increasing the resolution of the display substrate 2 and the display apparatus 1, and improving the performance of the head-mounted display apparatus.

A structure of the isolation portion DV may be varied, and may be set according to actual situations, and the embodiments of the present disclosure do not limit this.

For example, as shown in FIG. 13, the island-shaped light-emitting units 4221 are in contact with the isolation portion DV, and the isolation portion DV between adjacent island-shaped light-emitting units 4221 is continuously distributed.

The isolation portion DV has a certain thickness, and the isolation portion DV may be substantially in a shape of mesh in a top view. Each island-shaped light-emitting unit 4221 is located in a square of the mesh, and a side wall of the island-shaped light-emitting unit 4221 is in contact with a side wall of the square.

With the above arrangement, the separation effect of the isolation portion DV on the light-emitting layer 422 may be ensured, and it is beneficial to simplify the manufacturing process of the light-emitting device 40.

In some examples, as shown in FIGS. 12 and 14 to 17, the isolation portion DV is further configured to separate the first semiconductor layer 421 into a plurality of island-shaped first semiconductor units 4211.

For example, the isolation portion DV is in contact with the island-shaped first semiconductor units 4211, and the isolation portion DV between adjacent island-shaped first semiconductor units 4211 are continuously distributed. The plurality of island-shaped first semiconductor units 4211 are not connected to each other and are isolated from each other. The plurality of island-shaped first semiconductor units 4211 may be arranged in an array.

For example, the island-shaped first semiconductor units 4211 are in one-to-one correspondence with the island-shaped light-emitting units 4221. In a thickness direction of the isolation portion DV, the island-shaped first semiconductor unit 4211 is directly opposite to the island-shaped light-emitting unit 4221, and the island-shaped first semiconductor unit 4211 provides a voltage for the island-shaped light-emitting unit 4221 corresponding thereto.

It can be understood that, in the case where the light-emitting device 40 includes the current spreading layer 424, as shown in FIG. 15, the isolation portion DV is further configured to separate the current spreading layer 424 into a plurality of island-shaped current spreading portions 4241.

With the above arrangement, the plurality of island-shaped first semiconductor units 4211 may respectively receive voltages separately, and voltages of the island-shaped first semiconductor units 4211 do not affect or interfere with each other, thereby facilitating independent control of light emission by each island-shaped light-emitting unit 4221.

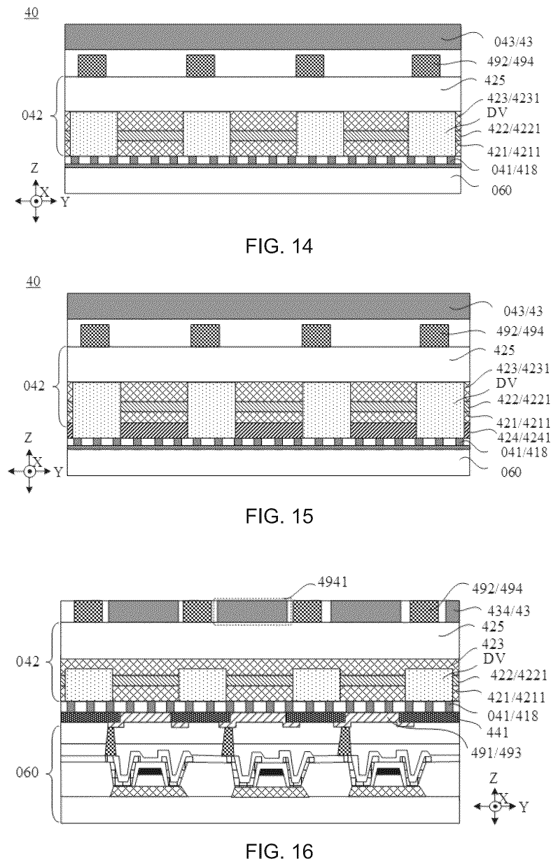

In some other examples, as shown in FIG. 14, the isolation portion DV is further configured to separate the second semiconductor layer 423 into a plurality of island-shaped second semiconductor units 4231.

For example, the isolation portion DV is in contact with the island-shaped second semiconductor units 4231, and the isolation portion DV between adjacent island-shaped second semiconductor units 4231 are continuously distributed. The plurality of island-shaped second semiconductor units 4231 are not connected to each other and are isolated from each other. The plurality of island-shaped second semiconductor units 4231 may be arranged in an array.

For example, the island-shaped second semiconductor units 4231 are in one-to-one correspondence with the island-shaped light-emitting units 4221. In the thickness direction of the isolation portion DV, the island-shaped second semiconductor unit 4231 is directly opposite to the island-shaped light-emitting unit 4221, and the island-shaped second semiconductor unit 4231 provides a voltage for the island-shaped light-emitting unit 4221 corresponding thereto.

With the above arrangement, the plurality of island-shaped second semiconductor units 4231 may respectively receive voltages separately, and voltages of the island-shaped second semiconductor units 4231 do not affect or interfere with each other, thereby facilitating independent control of light emission by each island-shaped light-emitting unit 4221.

In some other examples, as shown in FIG. 15, the isolation portion DV is further configured to separate the first semiconductor layer 421 into a plurality of island-shaped first semiconductor units 4211, and the isolation portion DV is further configured to separate the second semiconductor layer 423 into a plurality of island-shaped second semiconductor units 4231.

With the above arrangement, the plurality of island-shaped first semiconductor units 4211 and the plurality of island-shaped second semiconductor units 4231 may respectively receive voltages separately, the voltages of the island-shaped first semiconductor units 4211 do not affect or interfere with each other, and the voltages of the island-shaped second semiconductor units 4231 do not affect or interfere with each other, which is beneficial to achieving independent light emission of each island-shaped light-emitting unit 4221 under the action of the corresponding voltage difference.

It can be understood that, in some other examples, as shown in FIG. 16, the isolation portion DV separates the first semiconductor layer 421 into a plurality of island-shaped first semiconductor units 4211, and separates the light-emitting layer 422 into a plurality of island-shaped light-emitting units 4221, and a surface of the isolation portion DV away from the first semiconductor layer 421 is located inside the second semiconductor layer 423.

For example, a material of the isolation portion DV includes argon element or arsenic element. Thus, the isolation portion DV may better separate adjacent island-shaped light-emitting units 4221, which avoids the electrical connection between adjacent island-shaped light-emitting units 4221, achieves the separation effect, and helps improve the pixel density of the display substrate 2. Similarly, the isolation portion DV may better separate adjacent island-shaped first semiconductor units 4211 and adjacent island-shaped second semiconductor units 4231, thereby achieving the separation effect.

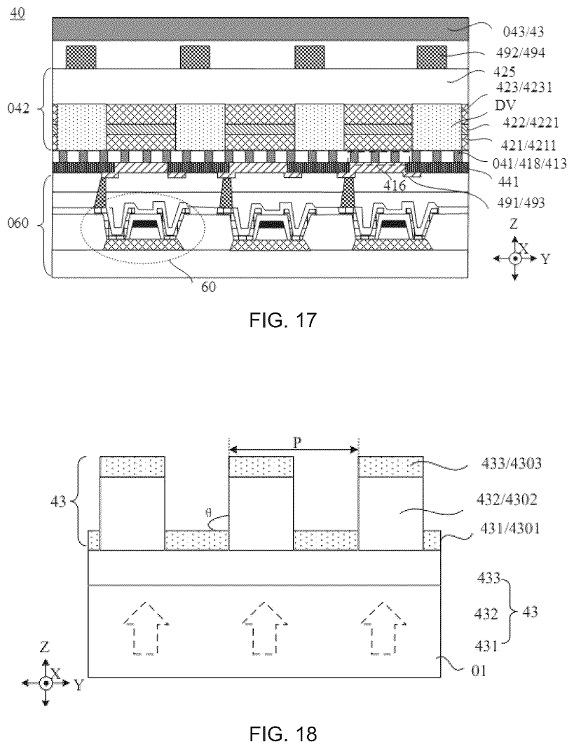

In some examples, as shown in FIG. 17, in the case where the isolation portion DV is configured to separate the first semiconductor layer 421 into the plurality of island-shaped first semiconductor units 4211 and separate the light-emitting layer 422 into the plurality of island-shaped light-emitting units 4221, the light-emitting device 40 further includes: a first electrode layer 493 located on a side of the light-emitting portion 042 away from the second light conversion layer 043, and a driving circuit layer 060 located on a side of the first electrode layer 493 away from the light-emitting portion 042. The driving circuit layer 060 is electrically connected to the island-shaped first semiconductor units 4211 through the first electrode layer 493.

For example, the driving circuit layer 060 provides a voltage for the first electrode layer 493, and the first electrode layer 493 can be electrically connected to the first semiconductor layer 421, so as to transmit the voltage to the first semiconductor layer 421, thereby providing the voltage to the first semiconductor layer 421 and the light-emitting layer 422.

For example, as shown in FIG. 17, the driving circuit layer 060 includes a plurality of driving circuits 60, and the driving circuits 60 are electrically connected to the first electrode layer 493.

In the case where the light-emitting device 40 includes the driving circuit layer 060, the light-emitting device 40 may emit light by itself, and the light-emitting portion of the light-emitting device 40 may emit light independently under the control of the driving circuit.

For example, the light-emitting device 40 is a light-emitting substrate.

For another example, the light-emitting device 40 is a display substrate or a part of the display substrate.

For another example, the light-emitting device 40 is a backlight panel or a part of the backlight panel.

For example, embodiments of the present disclosure further provide a backlight module, and the backlight module includes the backlight panel.

For example, some embodiments of the present disclosure further provide a display apparatus, and the display apparatus includes the above-mentioned backlight panel and a liquid crystal panel that is located on a light-exit side of the backlight panel. For a structure of the liquid crystal panel, reference may be made to the description of the display panel 10 in some embodiments described above, which will not be repeated here.

It can be understood that, a structure of the metal wire grid 43 may be varied, and may be selected according to actual needs, and the embodiments of the present disclosure do not limit this.

Some embodiments of the present disclosure provide a metal wire grid 43 with a double wire grid structure. As shown in FIG. 18, the metal wire grid 43 includes a first metal layer 431, a second dielectric layer 432 and a second metal layer 433.

In some examples, the first metal layer 431 includes a plurality of first metal patterns 4301. Each first metal pattern 4301 extends in a first direction X, and the plurality of first metal patterns 4301 are arranged at intervals in a second direction Y. The first direction X intersects the second direction Y. For example, an included angle between the first direction X and the second direction Y is 85°, 90°, 95°, 100°, or 105°.

For convenience of description, the embodiments of the present disclosure are described by taking an example where the included angle between the first direction X and the second direction Y is 90°.

For example, there is a gap between any two adjacent first metal patterns 4301, and any two adjacent first metal patterns 4301 are parallel to each other.

For example, as shown in FIG. 8C, the first metal layer 431 is located on a side of the first semiconductor layer 421 away from the second semiconductor layer 423.

In some examples, the second dielectric layer 432 includes a plurality of light-transmitting dielectric patterns 4302. Each light-transmitting dielectric pattern 4302 extends in the first direction X, and the plurality of light-transmitting dielectric patterns 4302 are arranged at intervals in the second direction Y.

For example, the light-transmitting dielectric pattern 4302 is located between two adjacent first metal patterns 4301.

For example, the light-transmitting dielectric pattern 4302 separates two adjacent first metal patterns 4301.

In some examples, the second metal layer 433 includes a plurality of second metal patterns 4303. Each second metal pattern 4303 extends in the first direction X, and the plurality of second metal patterns 4303 are arranged at intervals in the second direction Y. A single second metal pattern 4303 is located on a surface of a single light-transmitting dielectric pattern 4302 away from the first semiconductor layer 421.

For example, the plurality of second metal patterns 4303 and the plurality of light-transmitting dielectric patterns 4302 are in one-to-one correspondence.

The inventors of the present disclosure have simulated the influences of the metal wire grid with the single wire grid structure and the metal wire grid with the double wire grid structure on the polarization degree and transmittance of the light emitted by the light-emitting device, and the transmittance, reflectivity and absorptivity of the metal wire grid are obtained by simulation calculations.

The metal wire grid 43 with the double wire grid structure is shown in FIG. 18.

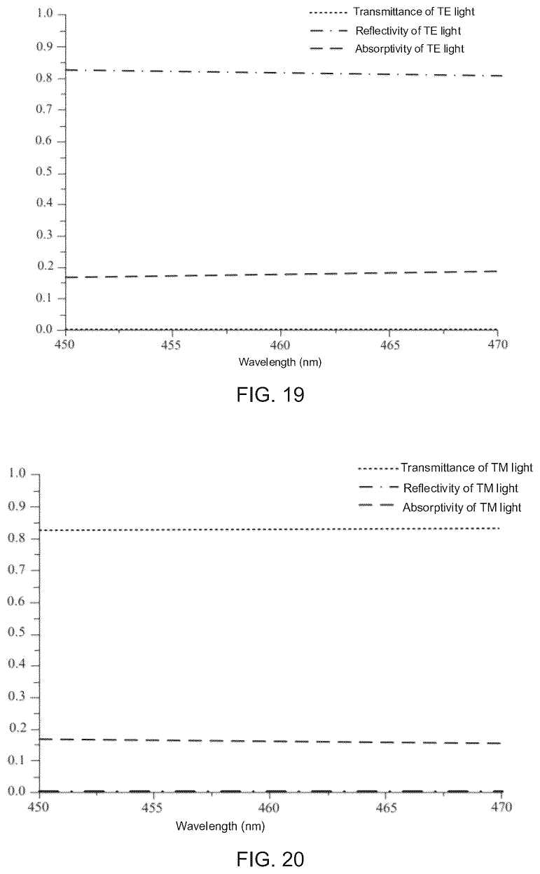

The conditions of the simulation carried out by the inventors on the metal wire grid 43 with the double wire grid structure are that: a plane light source emits light in a first substrate 01, a wavelength of the emitted light is in a range of 450 nm to 470 nm, and a material of the first substrate 01 can be silicon dioxide (SiO₂) or gallium nitride (GaN), where the refractive index of SiO₂ is 1.5 and the refractive index of GaN is 2.4. By simulation calculations, the transmittances, reflectivities and absorptivities of TM light and TE light emitted from the metal wire grid 43 are as shown in FIGS. 19 and 20.

It can be seen from FIG. 19 that, the transmittance of the metal wire grid 43 to the TE light is almost 0, which means that the TE light can hardly pass through the metal wire grid 43, the absorptivity of the metal wire grid 43 to the TE light is about 0.17, and the reflectivity of the metal wire grid 43 to the TE light is about 0.83. That is, in the TE light incident on the metal wire grid 43, about 83% of the TE light is reflected by the metal wire grid 43, and about 17% of the TE light is absorbed by the metal wire grid 43.

It can be seen from FIG. 20 that, the reflectivity of the metal wire grid 43 to the TM light is almost 0, which means that the TM light can hardly be reflected by the metal wire grid 43, the absorptivity of the metal wire grid 43 to the TM light is about 0.17, and the transmittance of the metal wire grid 43 to the TM light is about 83%. That is, in the TM light incident on the metal wire grid 43, about 83% of the TM light passes through the metal wire grid 43, and about 17% of the TM light is absorbed by the metal wire grid 43.

It can be seen that, the metal wire grid 43 can absorb a part of light; the metal wire grid 43 can only transmit TM light, and the transmittance of the metal wire grid 43 to TM light is greater than 80%; and the metal wire grid 43 can reflect most of TE light, and the reflectivity of the metal wire grid 43 to TE light is greater than 80%. As a result, TE light reflected by the metal wire grid 43 may be incident on the first light conversion layer 041, and its traveling direction and polarization direction may be changed by the first light conversion layer 041, so that the light with the change in the polarization direction may be incident on the metal wire grid 43 again and exit from the metal wire grid 43, thereby avoiding the ineffective utilization of the light reflected by the metal wire grid 43. Therefore, in the embodiments of the present disclosure, the metal wire grid 43 with the double wire grid structure is used as the polarization structure to filter the light emitted by the epitaxial structure 42, and thus the light-emitting device 40 may emit the light with the single-polarization state and high brightness, increasing the light extraction efficiency of the light-emitting device 40, and reducing the power consumption of the backlight module 20.

It should be noted that key structural parameters of the metal wire grid with the double wire grid structure include a line width and a repetition period. The line width refers to a width of the first metal pattern (or the second metal pattern) in a direction perpendicular to its extension direction. In an example where dimensions of the first metal pattern and the second metal pattern are the same, it can be seen from FIG. 18 that the line width is the dimension of the first metal pattern in the second direction Y. The repetition period refers to an interval at which the second metal patterns (or the first metal patterns) repeat in the direction perpendicular to the extension direction thereof, which is shown in FIG. 18. Here, the repetition period is the grating period of the metal wire grid.

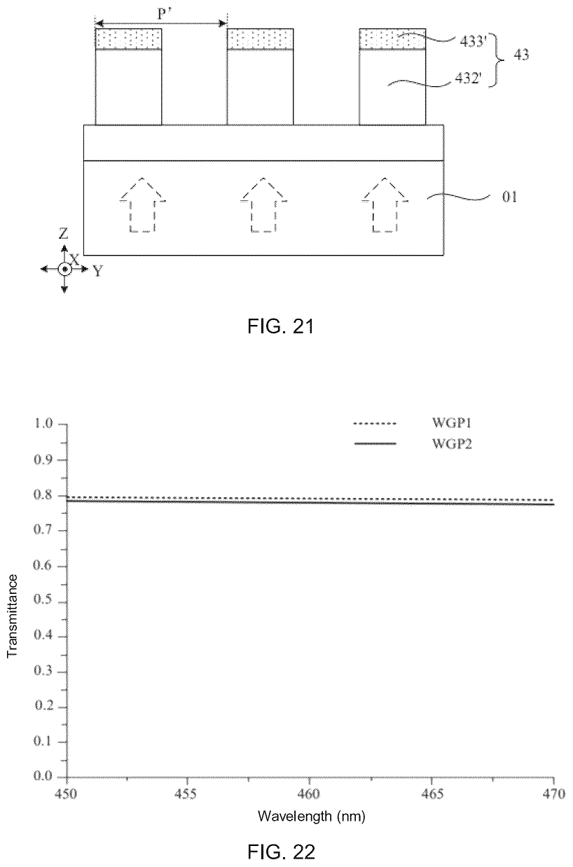

The metal wire grid 43 with the single wire grid structure is shown in FIG. 21. It should be noted that, the metal wire grid includes a plurality of light-transmitting dielectric patterns 432′ arranged at intervals, and second metal patterns 433′ located on the light-transmitting dielectric patterns 432′.

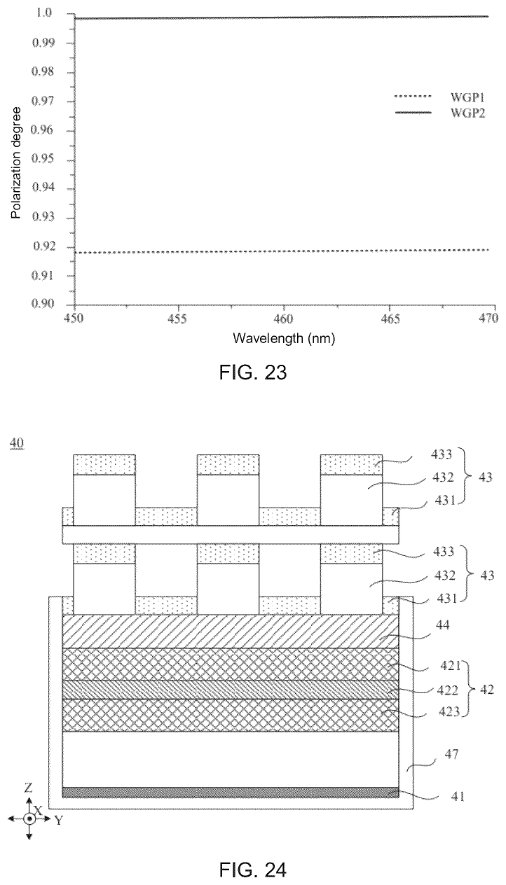

Structural parameters of the metal wire grid with the single wire grid structure are substantially the same as those of the metal wire grid with the double wire grid structure. For example, the wavelengths of light provided for the metal wire grid with the single wire grid structure and the metal wire grid with the double wire grid structure are both in a range of 450 nm to 470 nm. The line width of the metal wire grid with the single wire grid structure (here, the line width refers to a dimension of the second metal pattern 433′ in the second direction) is the same as the line width of the metal wire grid with the double wire grid structure (here, the line width refers to a dimension of the second metal pattern 4303 in the second direction), and they both are 60 nm. The repetition period P′ of the second metal patterns of the metal wire grid with the single wire grid structure in the second direction is equal to the repetition period P of the second metal patterns of the metal wire grid with the double wire grid structure in the second direction, and they both are equal to 120 nm. The thickness of the light-transmitting dielectric pattern of the metal wire grid with the single wire grid structure is the same as the thickness of the light-transmitting dielectric pattern of the metal wire grid with the double wire grid structure, and they both are 80 nm. The refractive index of the light-transmitting dielectric pattern of the metal wire grid with the single wire grid structure is the same as the refractive index of the light-transmitting dielectric pattern of the metal wire grid with the double wire grid structure, and they both are 1.5. The material of the metal pattern (i.e., the second metal pattern) of the metal wire grid with the single wire grid structure is the same as the material of the first metal pattern (or the second metal pattern) of the metal wire grid with the double wire grid structure, and they both are aluminum. The light is incident on the metal wire grid with the single wire grid structure and the metal wire grid with the double wire grid structure from the buffer material with the refractive index of 1.5. By simulation calculations, the transmittances and polarization degrees of the metal wire grid with the single wire grid structure and the metal wire grid with the double wire grid structure are obtained, and are plotted to obtain FIGS. 22 and 23.

In FIG. 22, WGP1 represents the transmittance of light incident on the metal wire grid with the single wire grid structure, and WGP2 represents the transmittance of light incident on the metal wire grid with the double wire grid structure. The above simulation results have verified that TE light can hardly pass through the metal wire grid, so that the transmittance of the light incident on the metal wire grid can be considered as the transmittance of TM light in the light incident on the metal wire grid.

It can be seen from FIG. 22 that the transmittance of the metal wire grid is basically unchanged in a case where the wavelength of the incident light is different. The light transmittances of the metal wire grid with the single wire grid structure and the metal wire grid with the double wire grid structure are basically the same, and they both are about 0.80. The metal wire grid with the single wire grid structure and the metal wire grid with the double wire grid structure have almost no effect on the light transmittance.

In FIG. 23, WGP1 represents the polarization degree of the light exiting from the metal wire grid with the single wire grid structure, and WGP2 represents the polarization degree of the light exiting from the metal wire grid with the double wire grid structure. Here, the polarization degree refers to a ratio of a difference between TM light exiting from the metal wire grid and TE light exiting from the metal wire grid to a sum of the TM light exiting from the metal wire grid and the TE light exiting from the metal wire grid.

It can be seen from FIG. 23 that the polarization degree of the light exiting from the metal wire grid is basically unchanged in a case where the wavelength of the incident light is different. The polarization degree of the metal wire grid with the single wire grid structure is about 0.918, and the polarization degree of the metal wire grid with the double wire grid structure is about 0.999. The metal wire grid with the double wire grid structure has a higher polarization degree.

Based on this, in some embodiments of the present disclosure, the light-emitting device 40 is designed to include the metal wire grid 43 with the double wire grid structure, and thus the polarization degree of the metal wire grid 43 may be greater than 0.99. In the case where the metal wire grid 43 is applied to the light-emitting device 40, the polarization degree of the light emitted by the light-emitting device 40 may be increased, thereby making the light-emitting device provide more accurate single-polarization light, and further improving the display effect of the display apparatus.

In some embodiments, the light-emitting device 40 includes two metal wire grids 43.

In some examples, as shown in FIG. 24, the two metal wire grids 43 are both of the double wire grid structure, the two metal wire grids 43 are stacked on the epitaxial structure 42, and the two metal wire grids 43 are connected together through a connecting layer.

For example, the two metal wire grids 43 constitute a first metal wire grid group.

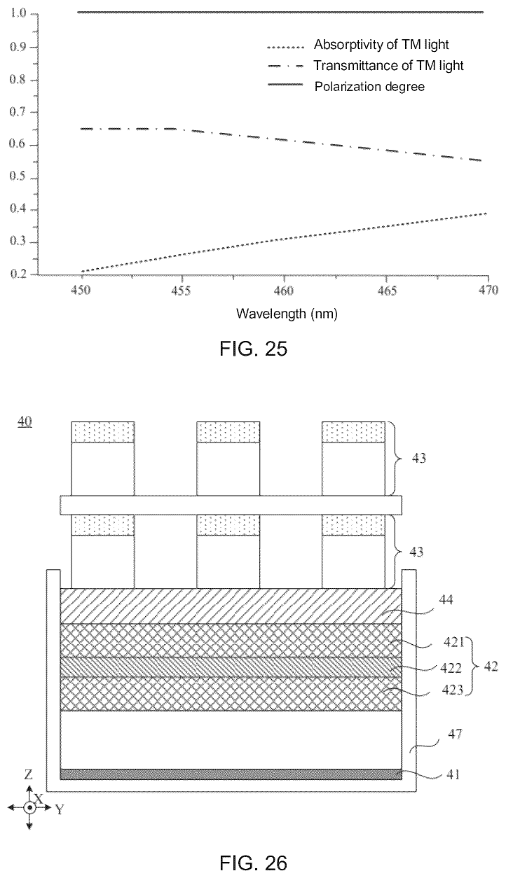

The inventors have simulated the stacked design of the two metal wire grids 43, and the transmittance, absorptivity and polarization degree of the first metal wire grid group are obtained, and are plotted to obtain FIG. 25.

It can be seen from FIG. 25 that in the case of the stacked design of the two metal wire grids 43 with the double wire grid structure, the transmittance of TM light of the first metal wire grid group is about 0.60, and the polarization degree of the first metal wire grid group is close to 1.

Therefore, in the case where the light-emitting device 40 includes two metal wire grids 43 with the double wire grid structure, the polarization degree of the light emitted by the light-emitting device may be relatively high.

In some other examples, as shown in FIG. 26, the two metal wire grids 43 are both of the single wire grid structure, the two metal wire grids 43 are stacked on the epitaxial structure 42, and the two metal wire grids 43 are connected together through a connecting layer.

For example, the two metal wire grids 43 constitute a second metal wire grid group.

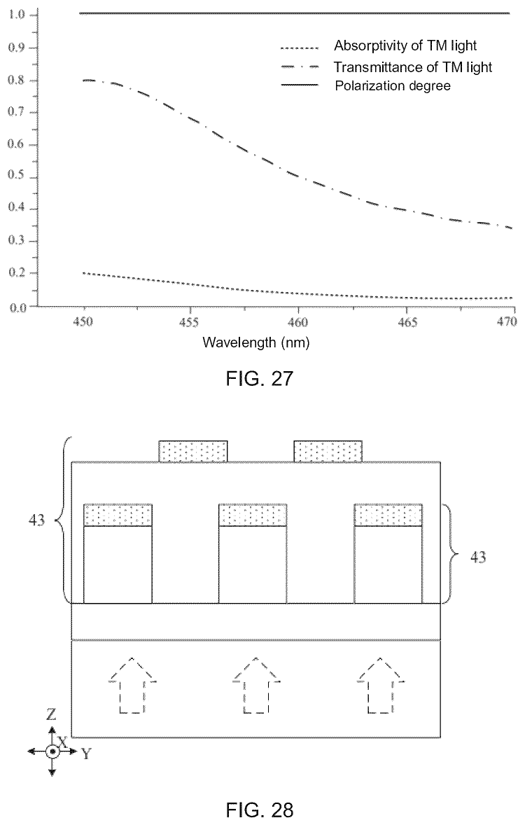

The inventors have simulated the stacked design of the two metal wire grids 43, and the transmittance, absorptivity and polarization degree of the second metal wire grid group are obtained, and are plotted to obtain FIG. 27.

It can be seen from FIG. 27 that in the case of the stacked design of the two metal wire grids 43 with the single wire grid structure, the polarization degree of the second metal wire grid group is close to 1.

Therefore, in the case where the light-emitting device 40 includes two metal wire grids 43 with the single wire grid structure, the polarization degree of the light emitted by the light-emitting device may be relatively high, and the manufacturing process of the light-emitting device may be simple.

For example, in the case where the two metal wire grids 43 are both of the single wire grid structure, the structures of the metal wire grids may also be arranged in other ways. For example, as shown in FIG. 28, the metal patterns of the two metal wire grids are staggered. In this way, the production yield of the metal wire grids may be improved, the metal patterns of the metal wire grids may be prevented from being connected to each other, and the transmittance and polarization degree of the metal wire grids may be prevented from being affected.

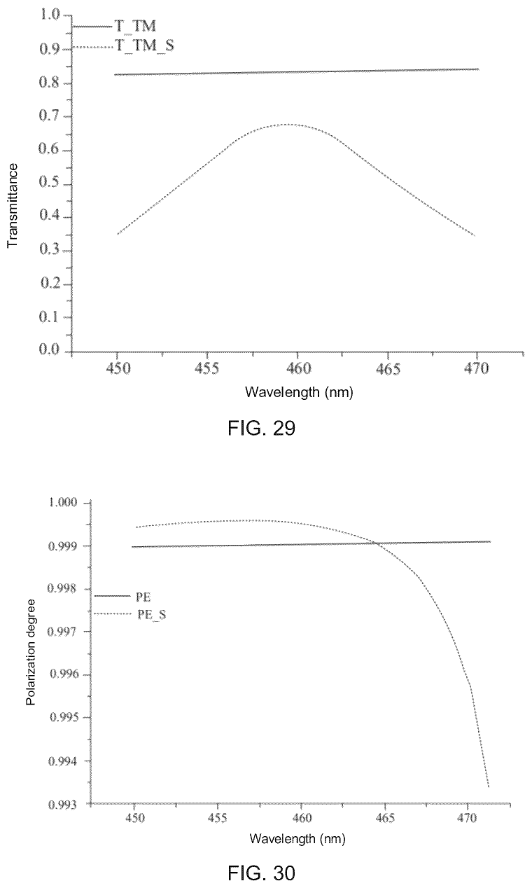

The inventors have simulated the situation of the two metal wire grids in the FIG. 28, and the polarization degree and transmittance are obtained; the polarization degree and transmittance are compared with those of the metal wire grid with the double wire grid structure shown in FIG. 18 in the above embodiments of the present disclosure, and FIGS. 29 and 30 are obtained.

In FIG. 29, T_TM represents the transmittance of TM light of the metal wire grid in FIG. 18, and T_TM_S represents the transmittance of TM light of the metal wire grid in FIG. 28. In FIG. 30, PE represents the polarization degree of the metal wire grid in FIG. 18, and PE_S represents the polarization degree of the metal wire grid in FIG. 28. It can be seen from FIGS. 29 and 30 that compared with T_TM, the transmittance of T_TM_S decreases by more than 10%, and PE_S fluctuates greatly with the change of the wavelengths of the incident light.

In addition, the inventors have simulated the relationship between the alignment accuracy of the two metal wire grids in FIG. 28 and both the transmittance and polarization degree, and found that the alignment accuracy of the two metal wire grids has no influence on the transmittance and polarization.

Therefore, in some embodiments of the present disclosure, the light-emitting device 40 includes the metal wire grid 43 with the double wire grid structure, which may make the light-emitting device 40 have relatively high light extraction efficiency and light polarization degree.

In some examples, as shown in FIG. 18, in the metal wire grid 43, a thickness of the light-transmitting dielectric pattern 4302 is greater than that of the first metal pattern 4301. The second metal pattern 4303 is not connected to the first metal pattern 4301 adjacent thereto, and there is a gap between the second metal pattern 4303 and the first metal pattern 4301. Thus, the light emitted by the light-emitting layer 422 may pass through the gap and the second dielectric layer 432, and transmit the metal wire grid 43, thereby increasing the transmittance of the metal wire grid 43, increasing the brightness of the light-emitting device 40, and increasing the light extraction efficiency of the light-emitting device 40.

It should be noted that the thickness of the light-transmitting dielectric pattern 4302 refers to a dimension of the light-transmitting dielectric pattern 4302 in the Z direction as shown in FIG. 18. Similarly, the thickness of the first metal pattern 4301 refers to a dimension of the first metal pattern 4301 in the Z direction as shown in FIG. 18.

It can be understood that a shape of the light-transmitting dielectric pattern 4302 can be set according to the actual situation, and the present disclosure does not limit this.

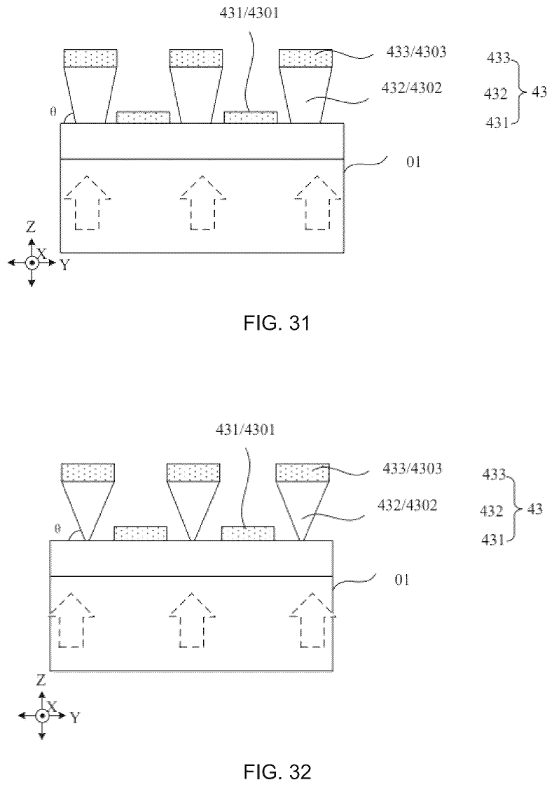

In some embodiments, as shown in FIG. 31, in the direction perpendicular to the plane where the metal wire grid 43 is located and in the second direction Y, a cross-sectional shape of the light-transmitting dielectric pattern 4302 includes an inverted trapezoid. An included angle between a side edge and a bottom edge of the inverted trapezoid is θ, where a range of the included angle θ is less than or equal to 90°.

The second metal pattern 4303 is located on the light-transmitting dielectric pattern 4302; and therefore, by making the cross-sectional shape of the light-transmitting dielectric pattern 4302 include the inverted trapezoid, in a process of manufacturing the second metal pattern 4303, the risk of the material of the second metal layer climbing on a sidewall of the light-transmitting dielectric pattern 4302 may be reduced, and the risk of contact between the second metal pattern 4303 and the adjacent first metal pattern 4301 along the sidewall of the light-transmitting dielectric pattern 4302 may be reduced. Thus, to a certain extent, it may ensure that the first metal pattern 4301 and the second metal pattern 4303 are disconnected, thereby increasing the transmittance of the metal wire grid 43, reducing the absorptivity of the metal wire grid 43, increasing the polarization degree of the light-emitting device 40, increasing the light extraction efficiency of the light-emitting device 40 and the backlight module.

It can be understood that, in the metal wire grid 43 shown in FIG. 31, due to process errors, the cross-sectional shape of the light-transmitting dielectric pattern 4302 may be an inverted trapezoid without sharp corners. For example, the top or bottom corners of the inverted trapezoid may be circular arc corners or approximate circular arc corners (not shown in FIG. 31). In addition, the inverted trapezoid is related to the position of viewing the metal wire grid 43 or the placement position of the metal wire grid 43. For example, in the cross-sectional view of the metal wire grid 43 shown in FIG. 31, the inverted trapezoid means that the cross-sectional shape of the light-transmitting dielectric pattern 4302 in the metal wire grid 43 when viewed from the side of the metal wire grid 43 is inverted-trapezoidal.

The inventors have modelled and simulated the influences of cross-sectional shapes, in the direction perpendicular to the plane where the metal wire grid 43 is located and in the second direction Y, of different light-transmitting dielectric patterns 4302 on the transmittance and polarization degree of the metal wire grid 43 in FDTD (finite difference time domain) software.

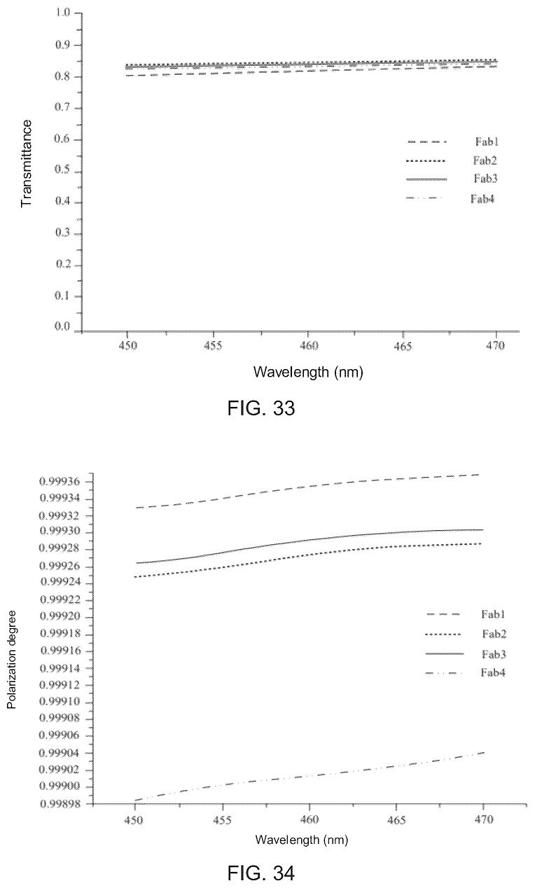

The simulation parameters are set as follows. The cross-sectional shapes of the light-transmitting dielectric patterns 4302 are a first inverted trapezoid Fab1, a second inverted trapezoid Fab2, an inverted triangle Fab3, and a rectangle Fab4. The wavelength of the light incident on the metal wire grid is in a range of 450 nm to 470 nm. The transmittances and polarization degrees of four metal wire grids are obtained through simulation calculations, and plotted to obtain FIGS. 33 and 34. The included angle θ between the side edge and the bottom edge of the first inverted trapezoid Fab1 is 67°, the included angle θ between the side edge and the bottom edge of the second inverted trapezoid Fab2 is 75°, the included angle θ between the side edge and the bottom edge of the inverted triangle Fab3 (as shown in FIG. 32) is 80°, and the included angle θ between the side edge and the bottom edge of the rectangle Fab4 (as shown in FIG. 18) is 90°.

It can be seen from FIG. 33 that the transmittances of the four metal wire grids are not much different, which are basically between 0.8 and 0.85. It can be seen that light-transmitting dielectric patterns with different cross-sectional shapes have little influence on the transmittance of metal wire grids.

It can be seen from FIG. 34 that, in the case where the cross-sectional shapes of the light-transmitting dielectric patterns 4302 are different, the polarization degrees of the four metal wire grids have small change, and the polarization degree change is about in a range of 0.02% to 0.03%. The smaller the included angle between the side edge and the bottom edge of the cross-sectional shape, the greater the polarization degree of light exiting from the metal wire grid 43. Therefore, in the manufacturing process of the metal wire grid, the cross-sectional shape of the light-transmitting dielectric pattern may be set to a special shape (i.e., non-rectangular shape) or an inverted trapezoid. Within the feasible process, the included angle between the side edge and the bottom edge of the special shape is relatively small, which may increase the polarization degree of light exiting from the metal wire grid to a certain extent.

In some embodiments, the first metal pattern 4301 is made of a same material as the second metal pattern 4303.

For example, the material of any one of the first metal pattern 4301 and the second metal pattern 4303 is aluminum (Al), silver (Ag), gold (Au), copper (Cu), or other metal material.

The above metal material is used to form the first metal layer 431 and the second metal layer 433, which may make the metal wire grid 43 have a low absorptivity and a high transmittance, thereby increasing the light extraction efficiency and the light polarization degree of the light-emitting device 40.

For example, the materials of the first metal pattern 4301 and the second metal pattern 4303 are both aluminum. Compared with other metal materials, aluminum has high transmittance for light in the visible wavelength range, low absorptivity and low cost. Therefore, aluminum is used as the material of the first metal pattern 4301 and the material of the second metal pattern 4303, which may further increase the transmittance of the metal wire grid 43, and reduce the absorptivity of the metal wire grid 43, thereby improving the light extraction efficiency and polarization degree of the light-emitting device 40, significantly decreasing the cost of manufacturing the metal wire grid 43, and decreasing the cost of the light-emitting device 40 and the backlight module.

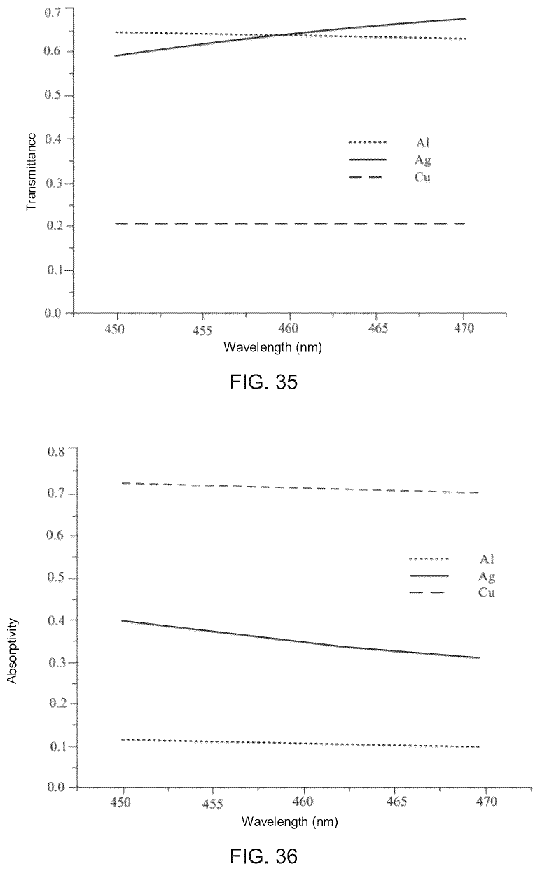

In an example where the material of the first metal layer is the same as that of the second metal layer, the inventors have simulated metal wire grids 43 that are respectively formed of aluminum (Al), silver (Ag), and copper (Cu), and transmittances, absorptivities and reflectivities of the metal wire grids are obtained, and are plotted to obtain FIGS. 35 to 37. Here, the wavelength of light emitted by the light-emitting device is in a range of 450 nm to 470 nm, and the dimension of the first metal pattern (or the second metal pattern) in the second direction is 60 nm.

In FIG. 35, the transmittances of metal wire grids formed of aluminum and silver are not much different, and they both are in a range of 0.55 to 0.70. For the metal wire grid formed of copper, the transmittance of the metal wire grid is relatively small, which is about 0.20.

In FIG. 36, for the metal wire grid formed of aluminum, the absorptivity of the metal wire grid is the smallest, which is in a range of 0.10 to 0.125. For the metal wire grid formed of copper, the absorptivity of the metal wire grid is the largest, which is slightly greater than 0.70. For the metal wire grid formed of silver, the absorptivity of the metal wire grid is intermediate, which is between 0.350 and 0.425.

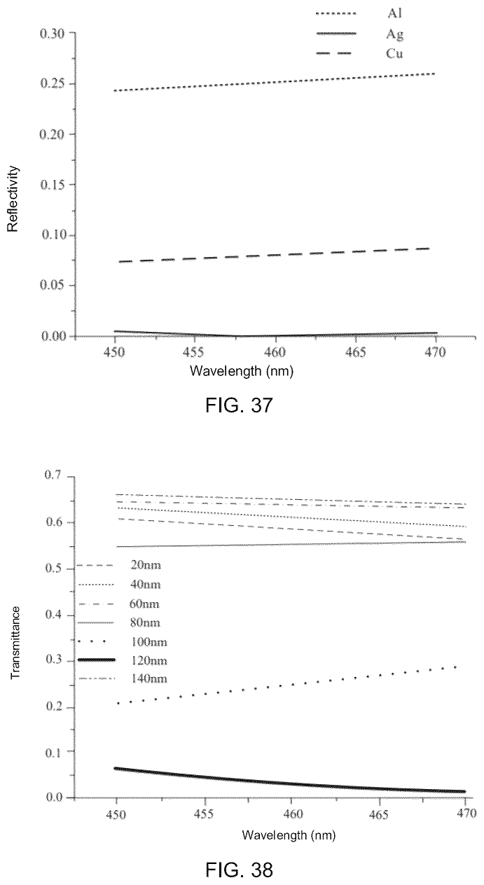

In FIG. 37, for the metal wire grid formed of aluminum, the reflectivity of the metal wire grid is the largest, which is about 0.25. For the metal wire grid formed of copper, the reflectivity of the metal wire grid is intermediate, which is slightly greater than 0.075. For the metal wire grid formed of silver, the reflectivity of the metal wire grid is the smallest, which is close to 0.

It can be seen that, in the case where aluminum and silver are respectively used as the materials of the first metal layers (or the second metal layers) of the metal wire grids, the transmittances of the metal wire grids are relatively large, and there is not much difference between the two. However, in the case where aluminum is used as the material of the first metal layer (or the second metal layer) of the metal wire grid, the absorptivity of the metal wire grid is the smallest. In the case where aluminum is used as the material of the first metal layer (or the second metal layer) of the metal wire grid, the reflectivity of the metal wire grid is the largest. Moreover, compared with silver, the cost of aluminum is lower.

Therefore, aluminum is selected as the material of the first metal layer (or the second metal layer) of the metal wire grid 43. As a result, the transmittance of the metal wire grid 43 may be increased, thereby improving the light extraction efficiency of the light-emitting device 40; the absorptivity of the metal wire grid 43 may also be reduced, thereby reducing the light loss of the light-emitting device 40; and the reflectivity of the metal wire grid 43 may also be increased, so that light that cannot pass through the metal wire grid 43 can be reflected to the first light conversion layer 041 through the metal wire grid 43. Thus, the utilization rate of light emitted by the epitaxial structure 42 may be increased, and the light extraction efficiency of the light-emitting device 40 may be further increased.

In some embodiments, as shown in FIG. 18, in the second direction Y, a dimension of the first metal pattern 4301 is substantially equal to a dimension of the second metal pattern 4303.

For example, from a top view, a shape of each first metal pattern 4301 may be strip-shaped. The dimension of the first metal pattern 4301 in the second direction Y refers to an average dimension of the strip in the width direction. Similarly, from the top view, a shape of each second metal pattern 4303 may also be strip-shaped. The dimension of the second metal pattern 4303 in the second direction Y refers to an average dimension of the strip in the width direction.

With the above arrangement, the shapes of the first metal pattern 4301 and the second metal pattern 4303 may be substantially the same, so that the shapes of the first metal pattern 4301 and the second metal pattern 4303 are relatively regular, which may facilitate the manufacturing of the metal wire grid 43, and reduce the manufacturing difficulty. In addition, the above arrangement may also allow the first metal pattern 4301 and the second metal pattern 4303 to cooperate with each other, thereby achieving filtering of light in a specific polarization direction, and in turn, improving the polarization degree of the light exiting from the metal wire grid 43.

In some embodiments, as shown in FIG. 18, a thickness of the first metal pattern 4301 is substantially equal to a thickness of the second metal pattern 4303.

In the case where the first metal pattern 4301 and the second metal pattern 4303 are made of the same material, by using the above arrangement, the first metal layer 431 and the second metal layer 433 (or the first metal pattern 4301 and the second metal layer 433) may be formed simultaneously in one manufacturing process, thereby reducing the difficulty of manufacturing the metal wire grid 43 and the light-emitting device 40.

In some embodiments, the thickness of the first metal pattern 4301 is in a range of 20 nm to 80 nm, and/or the thickness of the second metal pattern 4303 is in a range of 20 nm to 80 nm.

In some examples, the thickness of the first metal pattern 4301 is in a range of 20 nm to 80 nm.

For example, the thickness of the first metal pattern 4301 is in a range of 20 nm to 80 nm, or in a range of 50 nm to 60 nm, or in a range of 20 nm to 60 nm, or in a range of 60 nm to 80 nm.

For example, the thickness of the first metal pattern 4301 may be 20 nm, 50 nm, 55 nm, 60 nm, or 80 nm.

In some other examples, the thickness of the second metal pattern 4303 is in a range of 20 nm to 80 nm.

For example, the thickness of the second metal pattern 4303 is in a range of 20 nm to 80 nm, or in a range of 50 nm to 60 nm, or in a range of 20 nm to 60 nm, or in a range of 60 nm to 80 nm.

For example, the thickness of the second metal pattern 4303 may be 20 nm, 40 nm, 55 nm, 60 nm, or 80 nm.

In some other examples, the thickness of the first metal pattern 4301 is in a range of 20 nm to 80 nm, and the thickness of the second metal pattern 4303 is in a range of 20 nm to 80 nm.

For example, the thickness range of the first metal pattern 4301 may be the same as or different from the thickness range of the second metal pattern 4303.

The following is described by taking an example where the thickness of the first metal pattern 4301 and the thickness of the second metal pattern 4303 are the same, and the material of the first metal pattern 4301 and the material of the second metal pattern 4303 are the same.

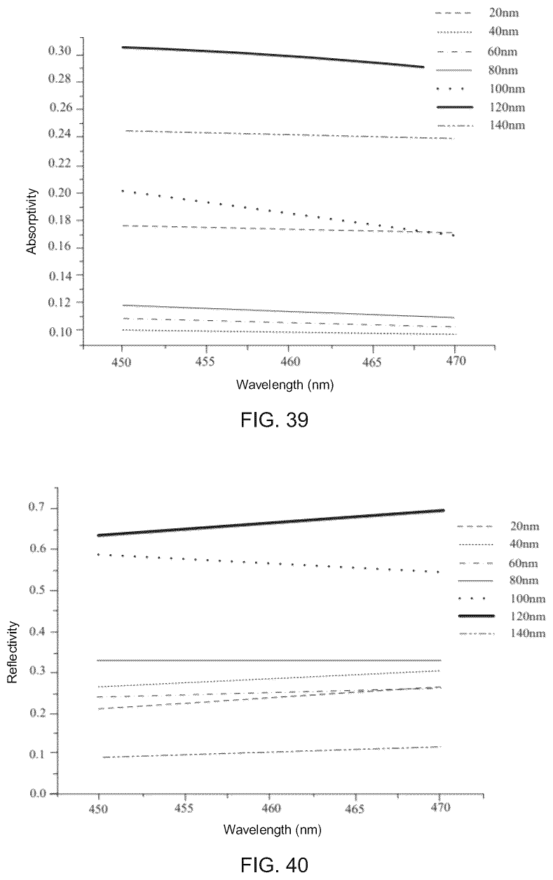

The inventors have simulated metal wire grids 43 with different thicknesses of first metal patterns, and the transmittances, absorptivities and reflectivities of the metal wire grids 43 are obtained through simulation calculations, and plotted to obtain FIGS. 38, 39, 40, and 41. Here, aluminum is selected as the material of the first metal layer (or the second metal layer), the wavelength of the light incident on the metal wire grid 43 is in a range of 450 nm to 470 nm, the line width of the metal wire grid 43 is 60 nm, the repetition period of the second metal patterns is 120 nm, and the thickness of the first metal pattern is in a range of 20 nm to 140 nm.

As shown in FIGS. 38 to 40, in the case where the thickness of the first metal pattern is in the range of 20 nm to 80 nm, the transmittances of the metal wire grids 43 are all greater than 0.55, the absorptivities of the metal wire grids 43 are all less than 0.20, and the reflectivities of the metal wire grids 43 are all between 0.20 and 0.35.

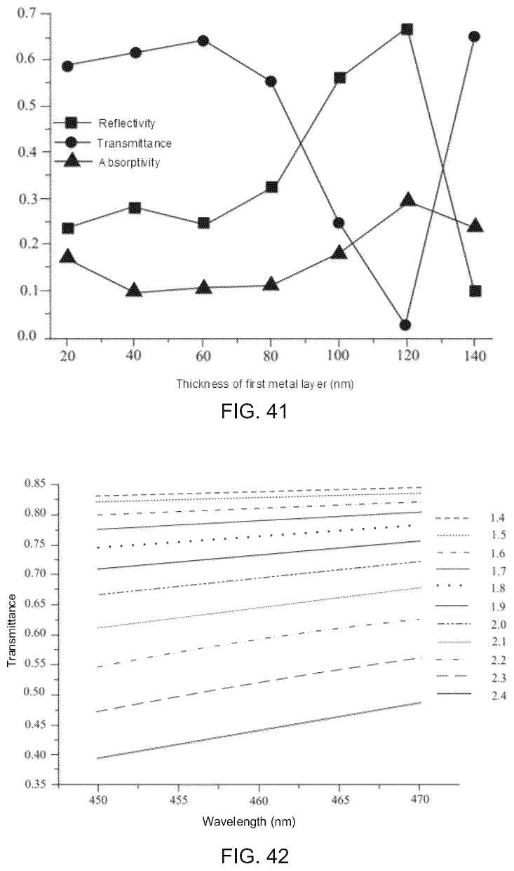

It can be seen from FIGS. 38 to 40 that, in the case where the wavelength of the light incident on the metal wire grid 43 is in the range of 450 nm to 470 nm, for the first metal patterns with different thicknesses, the transmittances, absorptivities and reflectivities of the metal wire grids 43 each have a linear relationship with the wavelength of the light incident on the metal wire grids 43. At the wavelength of 460 nm, the relationships between the thickness of the first metal pattern and the transmittance, reflectivity, and absorptivity of the metal wire grid 43 are obtained and shown in FIG. 41.

As shown in FIG. 41, as the thickness of the first metal pattern continues to increase, the transmittance of the metal wire grid 43 first shows an upward trend, increasing to about 0.65, then shows a downward trend, falling to about 0.02, and finally shows an upward trend. As the thickness of the first metal pattern continues to increase, the reflectivity of the metal wire grid 43 first shows an upward trend, gradually increasing to about 0.67, and then shows a downward trend, falling to about 0.10. As the thickness of the first metal pattern continues to increase, the absorptivity of the metal wire grid 43 first slowly decreases to about 0.1, then increases to about 0.30, and then begins to decrease.

Therefore, in the case where the thickness of the first metal pattern is in the range of 20 nm to 80 nm, especially in the case where the thickness of the first metal pattern is 50 nm, the transmittance of the metal wire grid 43 is relatively high and the absorptivity of the metal wire grid 43 is relatively low, thereby improving the light extraction efficiency of the light-emitting device.

In some embodiments, a refractive index of the light-transmitting dielectric pattern 4302 is in a range of 1.4 to 1.5.

For example, the refractive index of the light-transmitting dielectric pattern 4302 may be 1.40, 1.42, 1.45, 1.49, or 1.50.

The inventors have simulated metal wire grids 43 with different refractive indexes of light-transmitting dielectric patterns 4302, and the transmittances, absorptivities and reflectivities of the metal wire grids 43 are obtained, and plotted to obtain FIGS. 42 to 44.

In FIGS. 42 to 44, 1.4 means that a refractive index of a light-transmitting dielectric pattern is 1.4, 1.5 means that a refractive index of a light-transmitting dielectric pattern is 1.5, . . . , 2.4 means that a refractive index of a light-transmitting dielectric pattern is 2.4.

It can be seen from FIG. 42 that, the smaller the refractive index of the light-transmitting dielectric pattern 4302, the greater the transmittance of the metal wire grid 43; and the greater the refractive index of the light-transmitting dielectric pattern 4302, the smaller the transmittance of the metal wire grid 43.

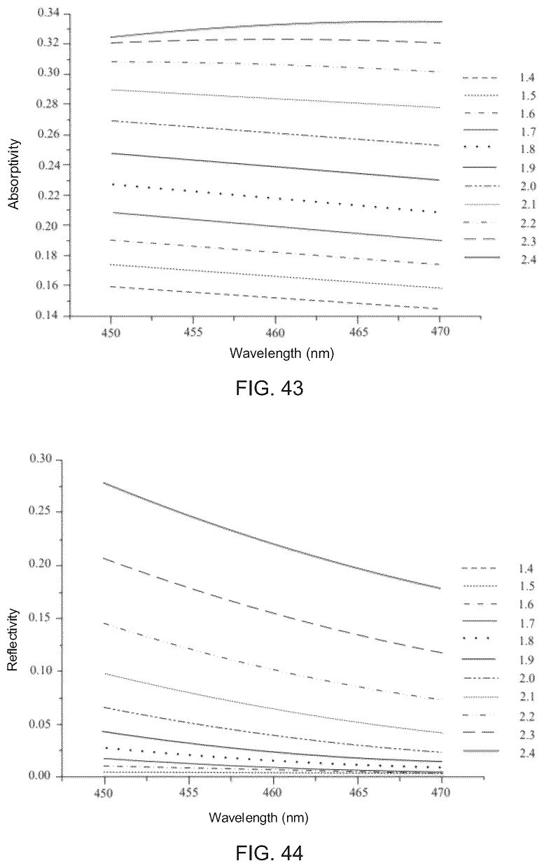

It can be seen from FIG. 43 that, the smaller the refractive index of the light-transmitting dielectric pattern 4302, the smaller the absorptivity of the metal wire grid 43; and the greater the refractive index of the light-transmitting dielectric pattern 4302, the greater the absorptivity of the metal wire grid 43.

It can be seen from FIG. 44 that, the smaller the refractive index of the light-transmitting dielectric pattern 4302, the smaller the reflectivity of the metal wire grid 43; and the greater the refractive index of the light-transmitting dielectric pattern 4302, the greater the reflectivity of the metal wire grid 43.

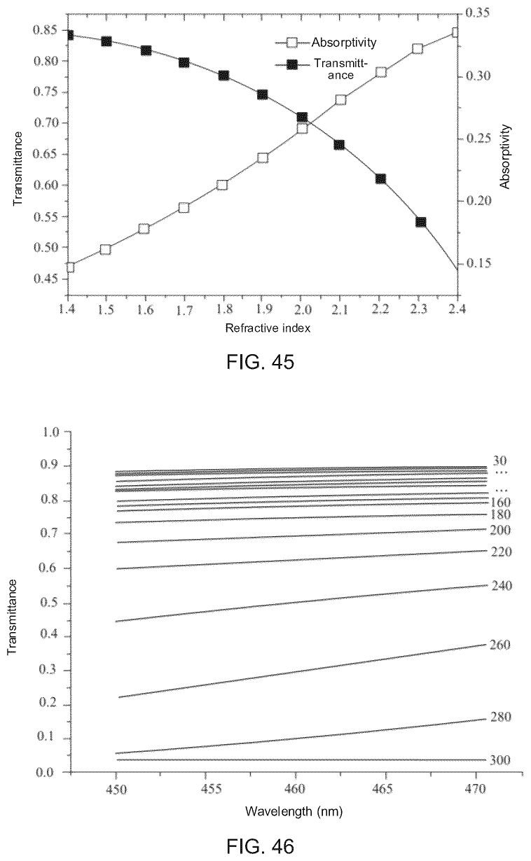

It can be seen from FIGS. 42 to 44 that, in the case where the wavelength of the light incident on the metal wire grid 43 is in the range of 450 nm to 470 nm, the transmittances, absorptivities and reflectivities of the metal wire grids 43 with different refractive indexes of light-transmitting dielectric patterns 4302 are basically linearly related to the wavelength of the light incident on the metal wire grids 43. At the wavelength of 460 nm, the relationships between the refractive index of the light-transmitting dielectric pattern 4302 and the transmittance and absorptivity of the metal wire grid 43 are obtained and shown in FIG. 45.

As shown in FIG. 45, as the refractive index of the light-transmitting dielectric pattern 4302 continues to increase, the transmittance of the metal wire grid 43 shows a downward trend, falling from about 0.85 to about 0.45. As the refractive index of the light-transmitting dielectric pattern 4302 continues to increase, the absorptivity of the metal wire grid 43 shows an upward trend, increasing from about 0.15 to about 0.34.

Therefore, in the case where the refractive index of the light-transmitting dielectric pattern 4302 is in the range of 1.4 to 1.5, the transmittance of the metal wire grid 43 is relatively high and the absorptivity of the metal wire grid 43 is relatively low, thereby improving the light extraction efficiency of the light-emitting device 40 and reducing the light loss of the light-emitting device 40.

For example, an adhesive material or film layer with a smaller refractive index (e.g., magnesium fluoride (MgF)) may be selected as the light-transmitting dielectric pattern 4302. The refractive index of magnesium fluoride is 1.38.

It should be noted that, wavelength ranges of light emitted by epitaxial structures 42 in different light-emitting devices 40 are different, and different structures of metal wire grids 43 can be arranged to match the epitaxial structures 42, thereby achieving optimal light extraction efficiency and polarization degree of the metal wire grids 43.

In some embodiments, in a case where the light-emitting device 40 emits blue light, a repetition period of the second metal patterns 4303 in the second direction Y is less than or equal to 140 nm, and/or a thickness of the light-transmitting dielectric pattern 4302 is in a range of 60 nm to 80 nm, and/or a dimension of the light-transmitting dielectric pattern 4302 in the second direction Y is in a range of 50 nm to 70 nm.

For example, the wavelength of the blue light is in a range of 450 nm to 470 nm.

In some examples, in the case where the light-emitting device 40 emits the blue light, the repetition period of the second metal patterns 4303 in the second direction Y is less than or equal to 140 nm.

For example, in the case where the light-emitting device 40 emits the blue light, the repetition period of the second metal patterns 4303 in the second direction Y is equal to 140 nm.

For example, in the case where the light-emitting device 40 emits the blue light, the repetition period of the second metal patterns 4303 in the second direction Y is less than 140 nm.

For example, as shown in FIG. 18, a distance between a left side wall of a second metal pattern 4303 in the second direction Y and a left side wall of an adjacent second metal pattern 4303 in the second direction Y is the repetition period P of the metal wire grid or the repetition period P of the second metal patterns of the metal wire grid.

It can be understood that, in the light-emitting device 40, the first metal patterns 4301 also have a repetition period, and the repetition period of the first metal patterns 4301 may be the same as the repetition period of the second metal patterns 4303. Of course, the repetition period of the first metal patterns 4301 may also be different from the repetition period of the second metal patterns 4303. For convenience of description, the following is described by taking an example in which the repetition period of the first metal patterns is the same as the repetition period of the second metal patterns.

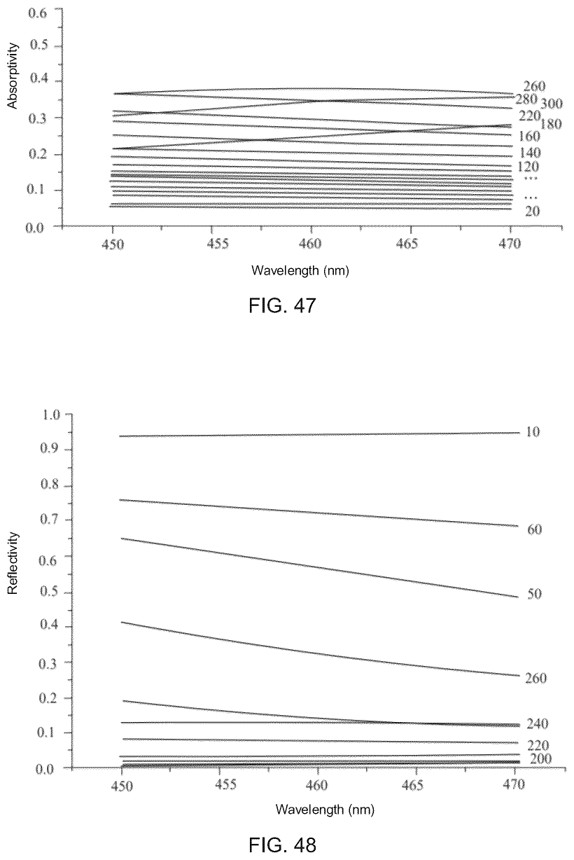

The inventors have simulated metal wire grids 43 each with a different repetition period of second metal patterns, and the parameters are set as follows: the line width of the metal wire grid 43 is half of the repetition period, the refractive index of the light-transmitting dielectric pattern is 1.5, the thickness of the second dielectric layer is 80 nm, the thicknesses of the first metal pattern and the second metal pattern are both 60 nm, and the wavelength of the light incident on the metal wire grid 43 is in a range of 450 nm to 470 nm. The plane light source can pass through the buffer layer and then direct to the metal wire grid 43, and the thickness of the buffer layer is 80 nm. The transmittances, absorptivities and reflectivities of the metal wire grids 43 are obtained through simulation calculations, and plotted to obtain FIGS. 46 to 48. It can be understood that, since the wavelength of the light incident on the metal wire grid 43 is blue light (here, the wavelength of the blue light can be in the range of 450 nm to 470 nm), in the simulation, the repetition period of the second metal patterns is less than the wavelength of the blue light.

In FIGS. 46 to 48, the numbers 20, 30, . . . , 220, 300 on the right side of the line segments indicate that the repetition periods are 20 nm, 30 nm, . . . , 220 nm, 300 nm, respectively.

It can be seen from FIGS. 46 to 48 that, the larger the repetition period of the second metal patterns of the metal wire grid 43, the smaller the transmittance of the metal wire grid 43. In a case where the repetition period of the second metal patterns of the metal wire grid 43 is greater than 180 nm, the transmittance of the metal wire grid 43 is less than 0.7, and the absorptivity of the metal wire grid 43 is greater than 0.20; and in a case where the repetition period of the second metal patterns is 260 nm, the absorptivity of the metal wire grid 43 is about 35%, and the light loss is relatively large. There is a linear relationship between the repetition period of the second metal patterns of the metal wire grid 43 and the reflectivity of the metal wire grid 43.

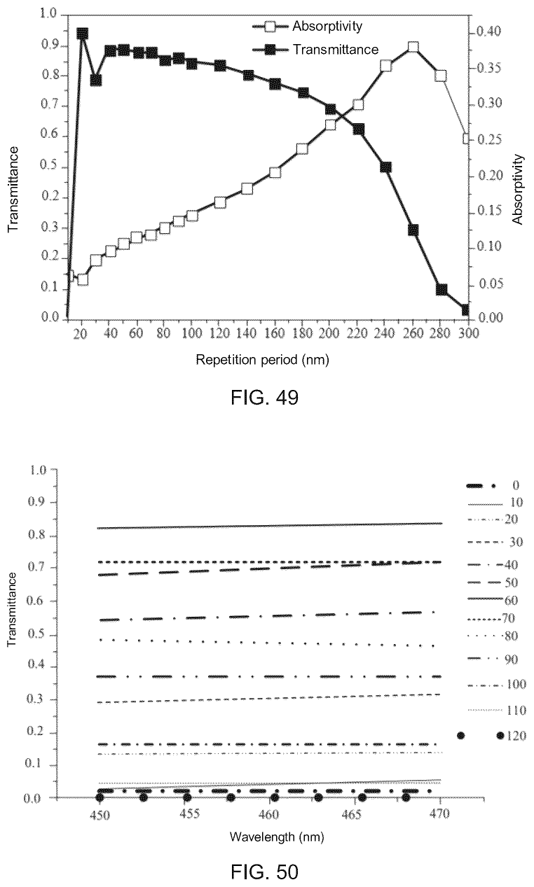

At the wavelength of 460 nm, the relationships between the repetition period of the second metal patterns and the transmittance, reflectivity, and absorptivity of the metal wire grid 43 are obtained and shown in FIG. 49.

It can be seen from FIG. 49 that, as the repetition period of the second metal patterns of the metal wire grid 43 increases (the repetition period is in a range of 40 nm to 300 nm), the transmittance of the metal wire grid 43 shows a downward trend. In a case where the repetition period of the second metal patterns is 300 nm, the transmittance of the metal wire grid 43 is less than 0.05, and the absorptivity of the metal wire grid 43 is about 0.25. In a case where the repetition period of the second metal patterns is in a range of 10 nm and 140 nm, the transmittance of the metal wire grid 43 is basically greater than 0.80, and the absorptivity of the metal wire grid 43 is less than 0.20.

Therefore, by setting the repetition period of the second metal patterns of the metal wire grid 43 to be less than or equal to 140 nm, the metal wire grid 43 may have a high transmittance and a low absorptivity, thereby improving the luminous efficiency of the light-emitting device. In addition, the repetition period of the second metal patterns of the metal wire grid 43 may be set to about 120 nm; and thus, the difficulty of manufacturing the metal wire grid 43 and the light-emitting device may be reduced, and a certain tolerance may be maintained, which facilitates the mass production of metal wire grids 43.

For example, a dimension of the second metal pattern in the second direction is half of the repetition period of the second metal patterns.

For example, in a case where the repetition period of the second metal patterns of the metal wire grid 43 is 120 nm, the dimension of the second metal pattern in the second direction is 60 nm.

For another example, in a case where the repetition period of the second metal patterns of the metal wire grid 43 is 140 nm, the dimension of the second metal pattern in the second direction is 70 nm.

With the above setting, the metal wire grid 43 may have a high transmittance and a low absorptivity, thereby reducing the light loss of the light-emitting device, and improving the light extraction efficiency of the light-emitting device.

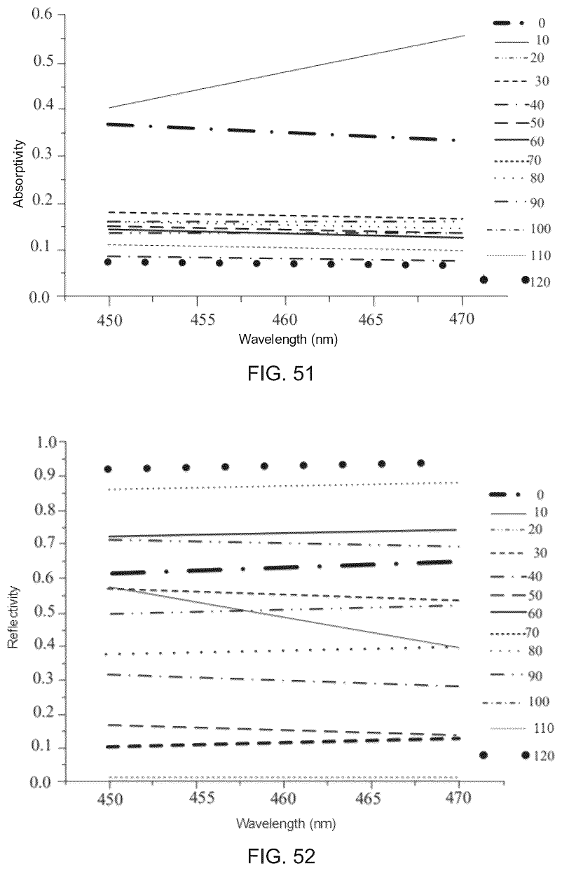

The inventors have simulated different dimensions (hereinafter referred to as line widths) of second metal patterns in the second direction, and the absorptivities, transmittances and reflectivities of different metal wire grids 43 are obtained and plotted to obtain FIGS. 50 to 53.

In FIGS. 50 to 52, the numbers 10, 20, . . . , 110, 120 on the right side of the line segments indicate that the dimensions of the second metal patterns in the second direction are 10 nm, 20 nm, . . . , 110 nm, 120 nm, respectively.

It can be seen from FIGS. 50 to 52 that, in a case where the wavelength of light incident on the metal wire grid 43 is in a range of 450 nm to 470 nm, the transmittances, absorptivities and reflectivities of the metal wire grids 43 each with a different line width of the second metal pattern are linear. However, the transmittances of the metal wire grids 43 with different line widths vary greatly, fluctuating between 0 and 0.8. Therefore, in a case where the repetition period is constant, the line width has a great influence on the transmittance of the metal wire grid 43. Thus, in the process of manufacturing the metal wire grid 43, attention needs to be paid to the control of line width dimension.

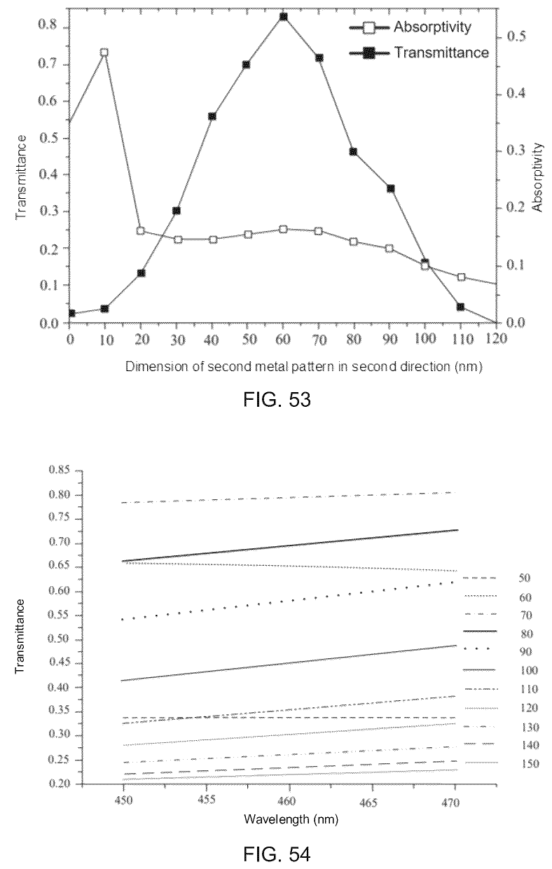

It can be seen from FIG. 53 that, the line width is in a range of 60 nm±10 nm, the repetition period of the second metal patterns is 120 nm, and the line width of the second metal pattern is about 50% of the repetition period; the transmittance of the metal wire grid 43 is greater than 0.7, and the absorptivity of the metal wire grid 43 is about 0.15. Therefore, in the case where the line width of the metal wire grid 43 is set to be in the range of 60 nm±10 nm, and the line width of the second metal pattern is about 50% of the repetition period, the absorptivity of the metal wire grid 43 is relatively low and the transmittance of the metal wire grid 43 is relatively high, thereby improving the light extraction efficiency of the light-emitting device 40 and reducing the power consumption of the backlight module and the display apparatus.

In some other examples, in a case where the light-emitting device 40 emits blue light, the thickness of the light-transmitting dielectric pattern 4302 is in a range of 60 nm to 80 nm.

For example, in the case where the light-emitting device 40 emits the blue light, the thickness of the light-transmitting dielectric pattern 4302 may be in a range of 60 nm to 70 nm, or in a range of 70 nm to 80 nm.

For example, in the case where the light-emitting device 40 emits the blue light, the thickness of the light-transmitting dielectric pattern 4302 may be 60 nm, 65 nm, 70 nm, 77 nm or 80 nm.

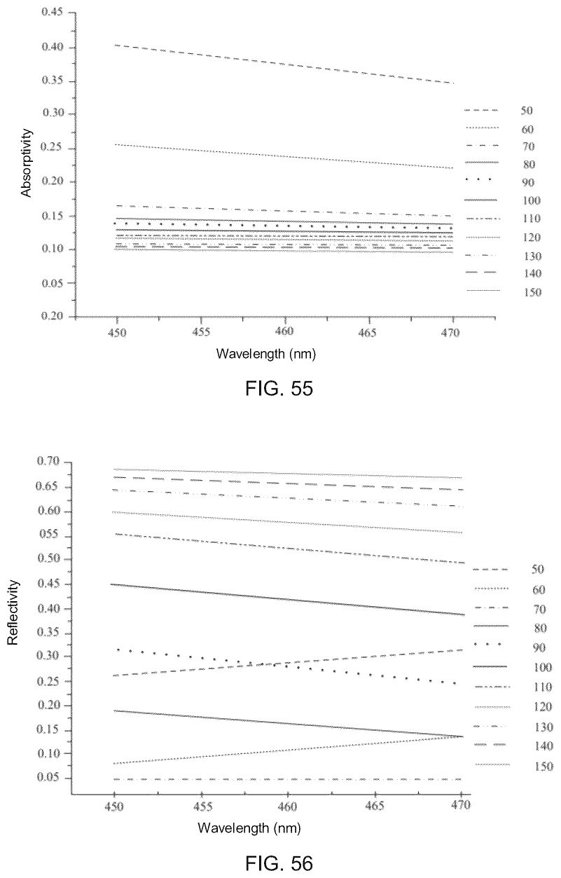

The inventors have simulated metal wire grids 43 with different thicknesses of light-transmitting dielectric patterns, and the parameters are set as follows: the line width of the metal wire grid 43 is 60 nm, the repetition period of the second metal patterns is 120 nm, the refractive index of the light-transmitting dielectric pattern is 1.5, the thicknesses of the first metal pattern and the second metal pattern are both 60 nm, and the wavelength of the light incident on the metal wire grid is in a range of 450 nm to 470 nm. The plane light source passes through the buffer layer and then directs to the metal wire grid, and the thickness of the buffer layer is 80 nm. The transmittances, absorptivities and reflectivities of the metal wire grids 43 are obtained through simulation calculations and plotted to obtain FIGS. 54 to 57.

In FIGS. 54 to 56, the numbers 50, 60, . . . , 140, 150 indicate that the thicknesses of the light-transmitting dielectric patterns are 50 nm, 60 nm, . . . , 140 nm, 150 nm, respectively.

It can be seen from FIGS. 54 to 56 that, in a case where the thickness of the light-transmitting dielectric pattern is in a range of 50 nm to 150 nm, the transmittances, reflectivities and absorptivities of the metal wire grids each have a linear relationship with the thickness of the light-transmitting dielectric pattern. Except for the cases where the thicknesses of the light-transmitting dielectric patterns are 50 nm and 60 nm, the absorptivities of other metal wire grids are all about 0.15.

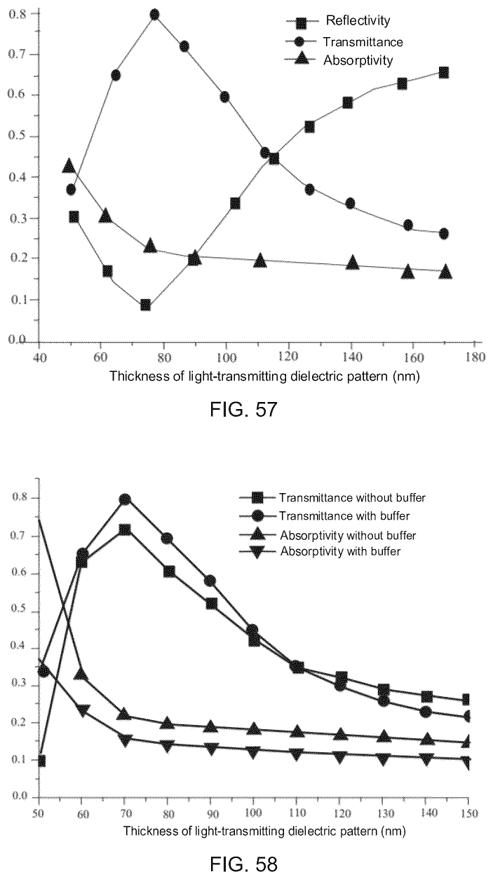

It can be seen from FIG. 57 that the thickness of the second dielectric layer of the metal wire grid has a significant influence on its transmittance. In a case where the thickness of the second dielectric layer is 70 nm, the transmittance of the metal wire grid reaches the maximum value, which is about 0.82, and the reflectivity of the metal wire grid is the minimum, which is about 0.03. In a case where the thickness of the second dielectric layer of the metal wire grid is greater than 70 nm, the absorptivity of the metal wire grid does not change much, which is basically about 0.15.

In a case where the thickness of the second dielectric layer of the metal wire grid is less than 140 nm, the polarization degree of the light exiting from the metal wire grid can reach more than 0.99. Therefore, in a case where the light-emitting device 40 emits blue light, the thickness of the light-transmitting dielectric pattern 4302 is set to be in a range of 60 nm to 80 nm. As a result, the metal wire grid may have a high transmittance and a low absorptivity, and at the same time, the polarization degree may be increased, thereby improving the light extraction efficiency of the blue light emitted by the light-emitting device and reducing the light loss of the blue light from the light-emitting device.

In yet some other examples, in the case where the light-emitting device 40 emits the blue light, the dimension of the light-transmitting dielectric pattern 4302 in the second direction Y is in a range of 50 nm to 70 nm.

For example, in the case where the light-emitting device 40 emits the blue light, the dimension of the light-transmitting dielectric pattern 4302 in the second direction Y may be in a range of 50 nm to 60 nm or in a range of 60 nm to 70 nm.

For example, in the case where the light-emitting device 40 emits the blue light, the dimension of the light-transmitting dielectric pattern 4302 in the second direction Y may be 50 nm, 54 nm, 60 nm, 66 nm, or 70 nm.

With the above setting, the light-transmitting dielectric pattern may be matched with the corresponding second metal pattern, so that the transmittance of the metal wire grid is relatively high, and the light extraction efficiency of the blue light emitted by the light-emitting device is relatively high.

In yet some other examples, in the case where the light-emitting device 40 emits the blue light, the repetition period of the second metal patterns 4303 in the second direction Y is less than or equal to 140 nm, the thickness of the light-transmitting dielectric pattern 4302 is in a range of 60 nm to 80 nm, and the dimension of the light-transmitting dielectric pattern 4302 in the second direction Y is in a range of 50 nm to 70 nm.

For example, in the case where the light-emitting device 40 emits the blue light, the repetition period of the second metal patterns 4303 in the second direction Y is 120 nm, the thickness of the light-transmitting dielectric pattern 4302 is 60 nm, and the dimension of the light-transmitting dielectric pattern 4302 in the second direction Y is 60 nm.

In some embodiments, in a case where the light-emitting device 40 emits green light or red light, the repetition period of the second metal patterns 4303 in the second direction Y is less than or equal to 240 nm, and/or the thickness of the light-transmitting dielectric pattern 4302 is in a range of 70 nm to 90 nm, and/or the dimension of the light-transmitting dielectric pattern 4302 in the second direction Y is in a range of 110 nm to 130 nm.

For example, the wavelength of the red light is in a range of 620 nm to 640 nm, and the wavelength of the green light is in a range of 520 nm to 540 nm.

In some examples, in the case where the light-emitting device 40 emits the green light, the repetition period of the second metal patterns 4303 in the second direction Y is less than or equal to 240 nm, and/or the thickness of the light-transmitting dielectric pattern 4302 is in a range of 70 nm to 90 nm, and/or the dimension of the light-transmitting dielectric pattern 4302 in the second direction Y is in a range of 110 nm to 130 nm.

For example, in the case where the light-emitting device 40 emits the green light, the repetition period of the second metal patterns 4303 in the second direction Y is less than or equal to 240 nm.

For example, in the case where the light-emitting device 40 emits the green light, the repetition period of the second metal patterns 4303 in the second direction Y is 240 nm or 200 nm.

For example, in the case where the light-emitting device 40 emits the green light, the thickness of the light-transmitting dielectric pattern 4302 is in a range of 70 nm to 90 nm.

For example, in the case where the light-emitting device 40 emits the green light, the thickness of the light-transmitting dielectric pattern 4302 is in a range of 70 nm to 80 nm or in a range of 80 nm to 90 nm.

For example, in the case where the light-emitting device 40 emits the green light, the thickness of the light-transmitting dielectric pattern 4302 is 70 nm, 75 nm, 80 nm, 86 nm or 90 nm.

For example, in the case where the light-emitting device 40 emits the green light, the dimension of the light-transmitting dielectric pattern 4302 in the second direction Y is in a range of 110 nm to 130 nm.

For example, in the case where the light-emitting device 40 emits the green light, the dimension of the light-transmitting dielectric pattern 4302 in the second direction Y is in a range of 110 nm to 120 nm or in a range of 120 nm to 130 nm.

For example, in the case where the light-emitting device 40 emits the green light, the dimension of the light-transmitting dielectric pattern 4302 in the second direction Y is 110 nm, 115 nm, 120 nm, 126 nm, or 130 nm.

For example, in the case where the light-emitting device 40 emits the green light, the repetition period of the second metal patterns 4303 in the second direction Y is less than or equal to 240 nm, the thickness of the light-transmitting dielectric pattern 4302 is in a range of 70 nm to 90 nm, and the dimension of the light-transmitting dielectric pattern 4302 in the second direction Y is in a range of 110 nm to 130 nm.

With the above setting, in the case where the light-emitting device emits the green light, the transmittance of the metal wire grid in the light-emitting device to the green light may be relatively high, and the polarization degree of the green light exiting from the metal wire grid may be relatively high, thereby improving the light extraction efficiency and light polarization degree of the light-emitting device for emitting the green light.

In some examples, in the case where the light-emitting device 40 emits the red light, the repetition period of the second metal patterns 4303 in the second direction Y is less than or equal to 240 nm, and/or the thickness of the light-transmitting dielectric pattern 4302 is in a range of 70 nm to 90 nm, and/or the dimension of the light-transmitting dielectric pattern 4302 in the second direction Y is in a range of 110 nm to 130 nm.

For example, in the case where the light-emitting device 40 emits the red light, the repetition period of the second metal patterns 4303 in the second direction Y is less than or equal to 240 nm.

For example, in the case where the light-emitting device 40 emits the red light, the sum of the dimension of the first metal pattern 4301 in the second direction Y and the dimension of the adjacent second metal pattern 4303 in the second direction Y is 240 nm or 200 nm.

For example, in the case where the light-emitting device 40 emits the red light, the thickness of the light-transmitting dielectric pattern 4302 is in a range of 70 nm to 90 nm.

For example, in the case where the light-emitting device 40 emits the red light, the thickness of the light-transmitting dielectric pattern 4302 is in a range of 70 nm to 80 nm or in a range of 80 nm to 90 nm.

For example, in the case where the light-emitting device 40 emits the red light, the thickness of the light-transmitting dielectric pattern 4302 is 70 nm, 75 nm, 80 nm, 86 nm or 90 nm.

For example, in the case where the light-emitting device 40 emits the red light, the dimension of the light-transmitting dielectric pattern 4302 in the second direction Y is in a range of 110 nm to 130 nm.

For example, in the case where the light-emitting device 40 emits the red light, the dimension of the light-transmitting dielectric pattern 4302 in the second direction Y is in a range of 110 nm to 120 nm or in a range of 120 nm to 130 nm.

For example, in the case where the light-emitting device 40 emits the red light, the dimension of the light-transmitting dielectric pattern 4302 in the second direction Y is 110 nm, 115 nm, 120 nm, 126 nm, or 130 nm.

For example, in the case where the light-emitting device 40 emits the red light, the repetition period of the second metal patterns 4303 in the second direction Y is less than or equal to 240 nm, the thickness of the light-transmitting dielectric pattern 4302 is in a range of 70 nm to 90 nm, and the dimension of the light-transmitting dielectric pattern 4302 in the second direction Y is in a range of 110 nm to 130 nm.

With the above setting, in the case where the light-emitting device emits the red light, the transmittance of the metal wire grid in the light-emitting device to the red light may be relatively high, and the polarization degree of the red light exiting from the metal wire grid may be relatively high, thereby improving the light extraction efficiency and light polarization degree of the light-emitting device for emitting the red light.

In some other embodiments, as shown in FIG. 8D, the second light conversion layer includes a metal wire grid 43, and the metal wire grid 43 includes a third metal layer 4304. The third metal layer 4304 includes a plurality of third metal patterns 4305, and the plurality of third metal patterns 4305 extend in the first direction X and are arranged at intervals in the second direction Y.

For example, the third metal pattern 4305 is made of metal aluminum.

For example, a thickness of the third metal pattern 4305 is in a range of 20 nm to 80 nm. For example, the thickness of the third metal pattern 4305 is 20 nm, 40 nm, 60 nm, 70 nm, or 80 nm.

For example, a dimension of the third metal pattern 4305 in the second direction Y is in a range of 50 nm to 70 nm. For example, the dimension of the third metal pattern 4305 in the second direction Y is 50 nm, 55 nm, 60 nm, 66 nm or 70 nm.

For example, the repetition period of the metal wire grid is 120 nm.

In some embodiments, as shown in FIG. 8C, the light-emitting device 40 further includes a buffer layer 44 located between the epitaxial structure 42 and the at least one metal wire grid 43.

For example, in a case where the light-emitting device 40 includes a plurality of metal wire grids 43, the buffer layer 44 is located between a metal wire grid 43 closest to the epitaxial structure 42 and the epitaxial structure 42.

The existence of the buffer layer 44 makes a difference between the refractive index of the first semiconductor layer 421 that is in contact with or adjacent to the buffer layer 44 and the refractive index of the buffer layer 44 small, and makes a difference between the refractive index of the buffer layer 44 that is in contact with or adjacent to the metal wire grid 43 and the refractive index of the metal wire grid 43 small, which improves the light extraction efficiency of the light-emitting device 40. Thus, it may be possible to avoid a large difference between the refractive index of the metal wire grid 43 and the refractive index of the first semiconductor layer 421 in the epitaxial structure, and avoid large light loss due to the large difference between the two refractive indexes in a process of the light from the metal wire grid 43 to the epitaxial structure 42 or from the epitaxial structure to the metal wire grid 43.

For example, a material of the buffer layer is silicon dioxide (SiO₂), silicon nitride (SiNx), photoresist (PR) or PMMA.

The inventors have simulated light-emitting devices 40 without the buffer layer and light-emitting devices 40 with the buffer layer, and the wavelength of the light emitted by the epitaxial structure is 460 nm. The transmittances and polarization degrees of metal wire grids 43 are obtained and plotted to obtain FIG. 58.

It can be seen from FIG. 58 that, compared with the light-emitting device 40 without the buffer layer, for the light-emitting device 40 with the buffer layer, the transmittance of the metal wire grid is relatively large and the absorptivity of the metal wire grid is small. In a case where the thickness of the light-transmitting dielectric pattern is 70 nm, the transmittance of the metal wire grid in the light-emitting device 40 without the buffer layer is about 10% different from the transmittance of the metal wire grid in the light-emitting device 40 with the buffer layer.

Therefore, by providing the buffer layer 44 in the light-emitting device 40, the transmittance of the metal wire grid 43 may be increased, thereby improving the light extraction efficiency of the light-emitting device.

In some embodiments, a thickness of the buffer layer 44 is in a range of 60 nm to 80 nm.

In some examples, the thickness of the buffer layer 44 is in a range of 60 nm to 70 nm, or in a range of 70 nm to 80 nm.

For example, the thickness of the buffer layer 44 is 60 nm, 67 nm, 70 nm, 76 nm, or 80 nm

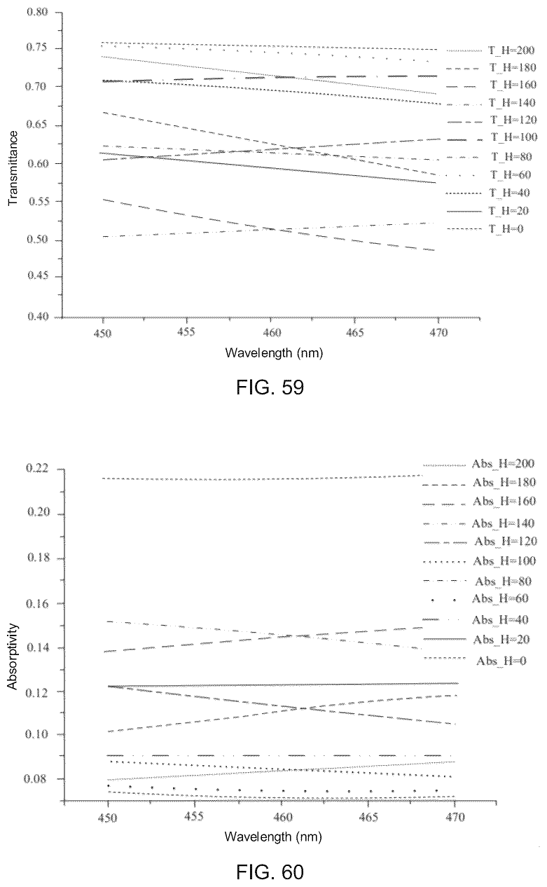

The inventors have simulated light-emitting devices 40 with different thicknesses of buffer layers, and the transmittances, absorptivities and reflectivities of metal wire grids 43 are obtained and plotted to obtain FIGS. 59 to 61.

In FIG. 59, T_H=0 represents the transmittance of the metal wire grid in a case where the thickness of the buffer layer is 0 nm, T_H=20 represents the transmittance of the metal wire grid in a case where the thickness of the buffer layer is 20 nm, . . . , and T_H=200 represents the transmittance of the metal wire grid in a case where the thickness of the buffer layer is 200 nm.

In FIG. 60, Abs_H=0 represents the absorptivity of the metal wire grid in the case where the thickness of the buffer layer is 0 nm, Abs_H=20 represents the absorptivity of the metal wire grid in the case where the thickness of the buffer layer is 20 nm, . . . , and Abs_H=200 represents the absorptivity of the metal wire grid in the case where the thickness of the buffer layer is 200 nm.

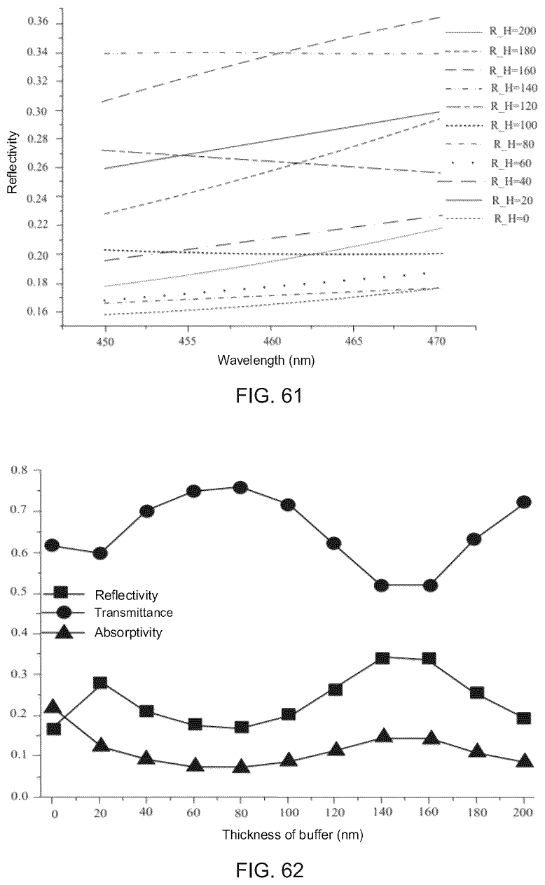

In FIG. 61, R_H=0 represents the reflectivity of the metal wire grid in the case where the thickness of the buffer layer is 0 nm, R_H=20 represents the reflectivity of the metal wire grid in the case where the thickness of the buffer layer is 20 nm, . . . , and R_H=200 represents the reflectivity of the metal wire grid in the case where the thickness of the buffer layer is 200 nm.

It can be seen from FIGS. 59 to 61 that, the wavelength of the light-emitting device 40 does not have a significant influence on the transmittance of the metal wire grid. In the case where the thickness of the buffer layer is in the range of 60 nm to 80 nm, the transmittance of the metal wire grid reaches the maximum value, and the absorptivity of the metal wire grid reaches the minimum value.

In addition, the inventors have simulated cases where the wavelength of the light emitted by light-emitting devices 40 is 460 nm and the thicknesses of the buffer layers are different, and the transmittances, absorptivities, and reflectivities of metal wire grids are obtained and shown in FIG. 62. It can be seen from FIG. 62 that, in the case where the thickness of the buffer layer is in the range of 60 nm to 80 nm, the transmittance of the metal wire grid is 75%, the absorptivity of the metal wire grid is 8%, and the reflectivity of the metal wire grid is 18%. Thus, the luminous efficiency of the light-emitting device may be relatively high.

In some embodiments, a refractive index of the buffer layer 44 is in a range of 1.4 to 1.5.

For example, the refractive index of the buffer layer 44 may be 1.40, 1.43, 1.45, 1.48, or 1.50.

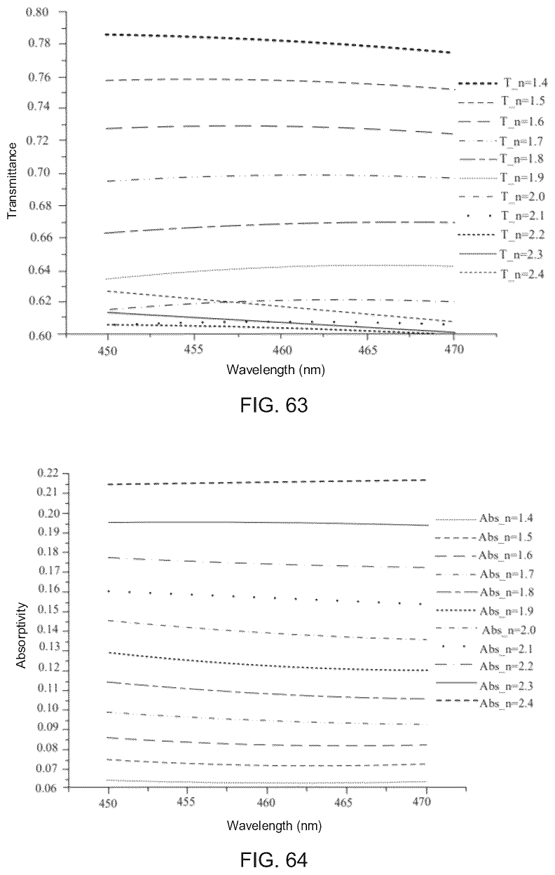

The inventors have simulated light-emitting devices 40 with different refractive indexes of buffer layers, and the transmittances, absorptivities and reflectivities of metal wire grids 43 are obtained and plotted to obtain FIGS. 63 to 66.

In FIG. 63, T_n=1.4 represents the transmittance of the metal wire grid in a case where the refractive index of the buffer layer is 1.4, T_n=1.5 represents the transmittance of the metal wire grid in a case where the refractive index of the buffer layer is 1.5, . . . , and T_n=2.4 represents the transmittance of the metal wire grid in a case where the refractive index of the buffer layer is 2.4.

In FIG. 64, Abs_n=1.4 represents the absorptivity of the metal wire grid in the case where the refractive index of the buffer layer is 1.4, Abs_n=1.5 represents the absorptivity of the metal wire grid in the case where the refractive index of the buffer layer is 1.5, . . . , and Abs_n=2.4 represents the absorptivity of the metal wire grid in the case where the refractive index of the buffer layer is 2.4.

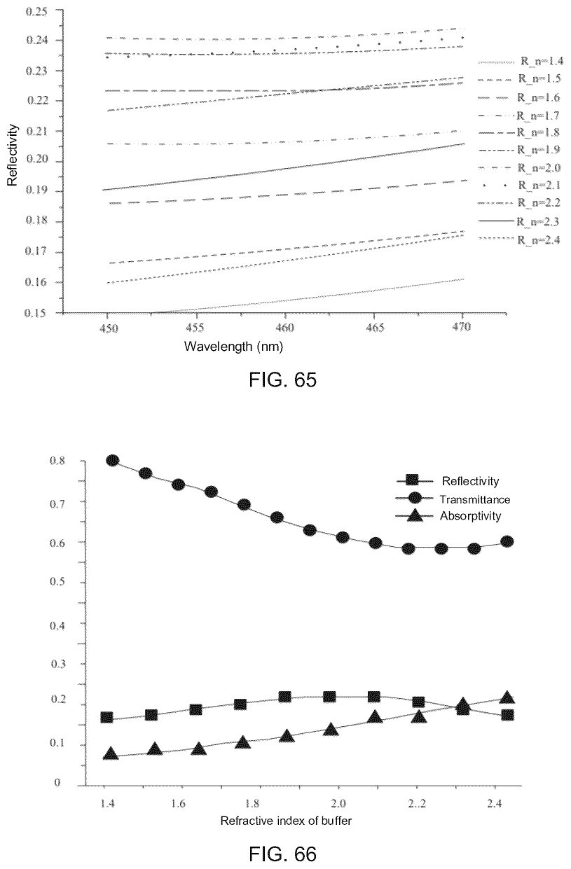

In FIG. 65, R_n=1.4 represents the reflectivity of the metal wire grid in the case where the refractive index of the buffer layer is 1.4, R_n=1.5 represents the reflectivity of the metal wire grid in the case where the refractive index of the buffer layer is 1.5, . . . , and R_n=2.4 represents the reflectivity of the metal wire grid in the case where the refractive index of the buffer layer is 2.4.

By combining FIGS. 63 to 65, it can be seen that, the smaller the refractive index of the buffer layer 44, the greater the transmittance of the metal wire grid, the smaller the absorptivity of the metal wire grid, and the smaller the reflectivity of the metal wire grid.

In addition, the wavelength is set to 460 nm, the refractive index of the buffer layer 44 is set to be in a range of 1.4 to 2.4, and the transmittances, absorptivities and reflectivities of metal wire grids are simulated to obtain FIG. 66. In a case where the refractive index of the buffer layer is small, the transmittance of the metal wire grid is larger and the absorptivity of the metal wire grid is smaller. The changing trend between the transmittance of the metal wire grid and the refractive index of the buffer layer is not completely linear. As the refractive index of the buffer layer continues to decrease, the transmittance of the metal wire grid continues to increase. Therefore, by setting the refractive index of the buffer layer in the range of 1.4 to 1.5, the transmittance of the metal wire grid may be relatively high.

For example, the material of the buffer layer is magnesium fluoride (MgF) or polymethyl methacrylate (PMMA). The refractive index of PMMA is 1.48.

It can be understood that, in the process of manufacturing the light-emitting device, the epitaxial structure and the metal wire grid can be manufactured separately, and then the metal wire grid and the epitaxial structure can be bonded. For example, optical clear adhesive (OCA) with a refractive index of 1.5 is selected to bond the metal wire grid to the epitaxial structure. In the process of manufacturing the metal wire grid, a base needs to be provided (e.g., the base is made of silicon dioxide (SiO₂) or glass), and then the first metal layer, the second dielectric layer and the second metal layer are formed on the base.

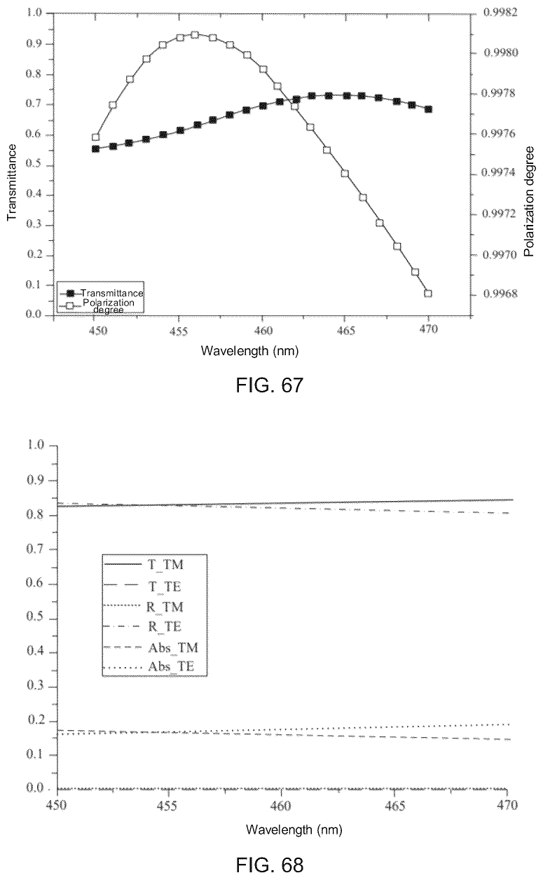

The inventors have simulated a case where the metal wire grid includes the base (e.g., the material of the substrate is glass), and the transmittance and polarization degree of the metal wire grid are obtained and plotted to obtain FIG. 67.

It can be seen from FIG. 67 that, in a case where the metal wire grid includes the base and the wavelength of light incident on the metal wire grid is 460 nm, the transmittance of the metal wire grid decreases slightly, by about 0.1 (compared to FIG. 66 shown herein), while the polarization degree of the metal wire grid remains basically unchanged at about 0.9979. Therefore, in order to reduce the influence of the base on the transmittance of the metal wire grid, in the process of manufacturing the light-emitting device, the metal wire grid can be directly integrated on the epitaxial structure, thereby avoiding loss of the transmittance of the metal wire grid caused by the base, and in turn, improving the light extraction efficiency of the light-emitting device.

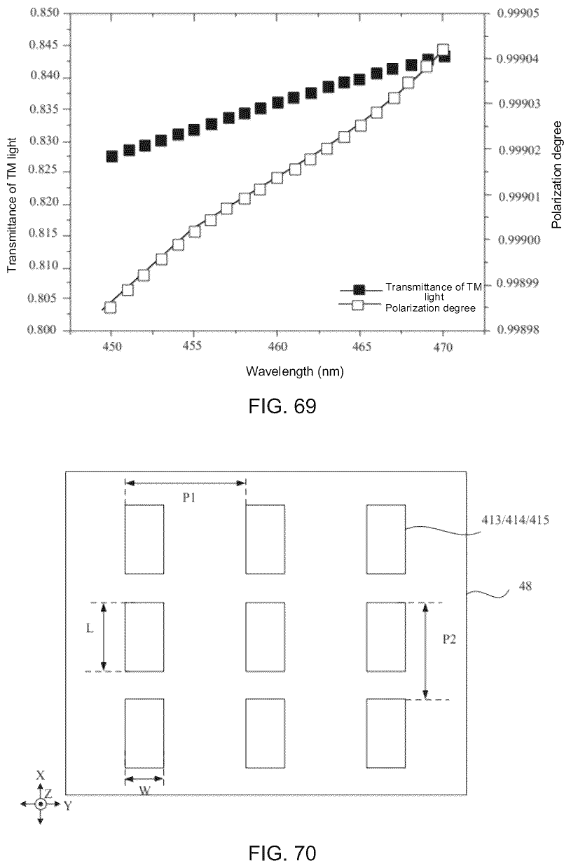

The inventors have simulated the metal wire grid using optimized structural parameters in the above embodiments, and the transmittance, reflectivity, absorptivity and polarization degree of the metal wire grid are obtained through simulation calculations and plotted to obtain FIGS. 68 and 69. Specifically, the wavelength of light incident on the metal wire grid is set to be in a range of 450 nm to 470 nm; the first metal pattern and the second metal pattern in the metal wire grid are set to be made of the same material, which is aluminum; the repetition period of the second metal patterns of the metal wire grid is 120 nm; the dimension of the first metal pattern (or the second metal pattern) in the second direction is 60 nm, and the thickness of the first metal pattern is 60 nm; the refractive index of the light-transmitting dielectric pattern is 1.4, the thickness of the light-transmitting dielectric pattern is 70 nm, and the dimension of the light-transmitting dielectric pattern in the second direction is 60 nm; the refractive index of the buffer layer is 1.4, and the thickness of the buffer layer is 70 nm; and the metal wire grid is directly formed on the epitaxial structure.

In FIG. 68, T_TM represents the transmittance of TM light of the metal wire grid, T_TE represents the transmittance of TE light of the metal wire grid, R_TM represents the reflectivity of TM light of the metal wire grid, R_TE represents the reflectivity of TE light of the metal wire grid, Abs_TM represents the absorptivity of TM light of the metal wire grid, and Abs_TE represents the absorptivity of TE light of the metal wire grid.

It can be seen from FIGS. 68 and 69 that, the polarization degree of the metal wire grid is greater than 0.99898; the transmittance of TM light of the metal wire grid is as high as 0.825, the reflectivity of TM light of the metal wire grid is almost 0, and the absorptivity of TM light of the metal wire grid is 0.16; the transmittance of TE light of the metal wire grid is almost 0, the reflectivity of TE light of the metal wire grid is about 0.82, and the absorptivity of TE light of the metal wire grid is 0.18. Therefore, by using the above setting, the light extraction efficiency of the light-emitting device may be greatly improved and the light loss of the light-emitting device may be reduced.

It should be noted that, the above embodiments are introduced by taking an example in which the light-emitting device 40 emits blue light. In a case where the light-emitting device 40 emits red light or green light, the structural parameters of the metal wire grid 43 can be set as follows. The first metal pattern and the second metal pattern in the metal wire grid 43 are made of the same material, which is aluminum. The repetition period of the second metal patterns of the metal wire grid 43 is 240 nm. The dimension of the first metal pattern (or the second metal pattern) in the second direction is 60 nm, and the thickness of the first metal pattern is 60 nm. The refractive index of the light-transmitting dielectric pattern is 1.4, the thickness of the light-transmitting dielectric pattern is 80 nm, and the dimension of the light-transmitting dielectric pattern in the second direction is 120 nm. The refractive index of the buffer layer is 1.4, and the thickness of the buffer layer is 70 nm. Therefore, the light extraction efficiency of the light-emitting device 40 for emitting red light or green light may be greatly improved, the polarization degree of light exiting from the light-emitting device 40 may be increased, the light loss of the light-emitting device 40 may be reduced, and in turn, the power consumption of the backlight module or display apparatus may be reduced.

It can be understood that a type of the first light conversion layer 041 of the light-emitting device 40 may be varied, and may be selected according to needs, and the present disclosure does not limit this.

In some embodiments, as shown in FIG. 9, the first light conversion layer 041 includes a specular reflection layer 411.

For example, a surface of the specular reflection layer 411 is relatively flat.

For example, a material of the specular reflection layer 411 is metal or metal alloy. For example, the material of the specular reflection layer 411 includes metal silver with a mass percentage greater than or equal to 90%. Therefore, the absorption of light by the specular reflection layer 411 may be reduced, thereby reducing the light loss of the light-emitting device 40. In addition, by reducing a thickness of other film layer (such as a buffer layer) in the light-emitting device 40, the absorption loss of light by other film layer may also be reduced.

In some examples, the specular reflection layer 411 is configured to reflect part of light incident on the specular reflection layer 411.

For example, most of the light emitted by the epitaxial structure is incident on the metal wire grid 43, and then is reflected or absorbed by the metal wire grid 43 or passes through the metal wire grid 43, where most of TM light passes through the metal wire grid 43 for exiting, and most of TE light is reflected by the metal wire grid 43 to the specular reflection layer 411. This part of TE light enters the epitaxial structure, and then passes through the epitaxial structure to be incident on the specular reflection layer 411; after being reflected by the specular reflection layer 411, the TE light is incident on the epitaxial structure again, and then passes through the epitaxial structure to be incident on the metal wire grid 43. During the process of the TE light passing through the epitaxial structure twice, at least part of the TE light is depolarized by the epitaxial structure, and its polarization direction is changed, so that at least part of the TE light is converted into circularly polarized light and then is incident on the metal wire grid. In the circularly polarized light, light perpendicular to a direction of the transmission axis of the metal wire grid 43 can exit from the metal wire grid 43. In the circularly polarized light, light parallel to the direction of the transmission axis of the metal wire grid 43 is reflected by the metal wire grid 43 and then is incident on the epitaxial structure again; after that, the light is depolarized in the epitaxial structure and is incident on the specular reflection layer 411, and then is reflected from the specular reflection layer 411 to the epitaxial structure; then the light is depolarized in the epitaxial structure and is incident on the metal wire grid again. Thus, the above process is circularly repeated.

With the above arrangement, the specular reflection layer 411 is used to reflect light, which is reflected by the metal wire grid 43 and then depolarized by the epitaxial structure, to the metal wire grid again, so that the light is filtered by the metal wire grid for exiting, avoiding the loss of this part of the light. Thus, the loss rate of light emitted by the epitaxial structure 42 may be reduced, and the luminous efficiency of the light-emitting device 40 may be increased.

It can be understood that the epitaxial structure has a certain depolarization effect on light and also has a certain absorption effect on light. Therefore, the thickness of the epitaxial structure may be thinned to reduce the absorption loss of light by the epitaxial structure.

In some examples, a reflectivity of the specular reflection layer 411 is greater than or equal to 80%.

For example, the reflectivity of the specular reflection layer 411 is 80%, 85%, 90%, 96%, or 100%.

The reflectivity of the specular reflection layer 411 is set within the above range, which may increase the utilization rate of light emitted by the epitaxial structure, reduce the loss of the light, and improve the luminous efficiency of the light-emitting device.

In some other embodiments, as shown in FIG. 9, the first light conversion layer 041 includes a scattering reflection layer 412.

For example, a surface of the scattering reflection layer 412 has a certain roughness.

For example, a material of the scattering reflection layer 412 is metal or metal alloy. For example, the material of the scattering reflection layer 412 includes metal silver with a mass percentage greater than or equal to 90%. Therefore, the absorption of light by the scattering reflection layer 412 may be reduced, thereby reducing the light loss of the light-emitting device.

In some examples, the scattering reflection layer 412 is configured to scatter or reflect part of light incident on the scattering reflection layer 412, and to convert at least part of the light scattered or reflected by the scattering reflection layer 412 into natural light.

It can be understood that most of light reflected from the metal wire grid to the scattering reflection layer 412 is TE light. The TE light is reflected or scattered by the scattering reflection layer 412 and converted into natural light by the scattering reflection layer 412. The natural light can incident on the metal wire grid again and then filtered by the metal wire grid, thereby reducing the loss rate of the light emitted by the epitaxial structure and improving the luminous efficiency of the light-emitting device.

For example, the light that is incident on the scattering reflection layer 412 and then exits from the scattering reflection layer 412 satisfies Lambert's cosine law I=I₀×cos^{N}(θ), where I is an intensity of the exit light, I₀ refers to an intensity of the light exiting from the normal direction of the scattering reflection layer, θ is a reflection angle or scattering angle of the light reflected from the scattering reflection layer, I is an intensity of the light with the reflection angle or scattering angle of θ, and N is a roughness of the scattering reflection layer 412. The smaller N is, the smaller the roughness of the scattering reflection layer 412 is. In a case where N is small, the scattering reflection layer 412 reflects almost all incident light, but the scattering effect is weak.

For example, the roughness of the scattering reflection layer 412 is greater than or equal to 2 μm.

For example, the roughness of the scattering reflection layer 412 is 2.0 μm, 2.2 μm, 2.6 μm, 3.0 μm, or 3.2 μm.

It can be understood that the scattering properties of the scattering reflection layer 412 are related to its surface roughness and the incident angle of the light. In a case where the light is incident on the scattering reflection layer 412 at a medium or large angle, the light exiting from the scattering reflection layer 412 no longer strictly adheres to Lambert's cosine law. Actually, in a case where the roughness N of the scattering reflection layer 412 is less than 1 μm (i.e., N<1 μm), the intensity of the light exiting from the scattering reflection layer 412 is concentrated near the angle of specular reflection, and the scattering reflection layer 412 has an appropriate scattering effect on the incident light. In a case where the roughness N of the scattering reflection layer 412 is greater than or equal to 2 μm (i.e., N≥2 μm), the intensity of the light exiting from the scattering reflection layer 412 conforms to Lambert's cosine law, that is, the scattering intensity of the exit light has little difference at various angles. Therefore, the roughness of the scattering reflection layer 412 is set within the above range, which may make the scattering intensity of most of the light exiting from the scattering reflection layer 412 not significantly different at various angles, which may also be considered as natural light. When the natural light is incident on the metal wire grid, the natural light can be filtered by the metal wire grid, and TM light exits from the metal wire grid, thereby improving the light extraction efficiency of the light-emitting device.

In yet some other embodiments, as shown in FIG. 9, the first light conversion layer 041 includes a phase conversion layer 413.

For example, the phase conversion layer 413 can perform phase conversion on light incident on its surface. A phase of the light incident on the surface of the phase conversion layer 413 is different from a phase of the light exiting from the surface of the phase conversion layer 413 after the phase conversion, and a phase difference can be (2n−1)×π, (2n−1)×π/2, etc., where n is a positive integer.

For example, in a case where n is 1, and the phase conversion layer 413 performs π-phase conversion on the light incident on its surface, the phase conversion layer 413 converts TE light incident on its surface into TM light for exiting. As a result, the TM light can exit from the metal wire grid, thereby improving the light extraction efficiency of the light-emitting device.

In some examples, as shown in FIGS. 70 and 72, the phase conversion layer 413 includes a plurality of nano-column structures 414, and the plurality of nano-column structures 414 are arranged in an array.

For example, a material of the nano-column structures 414 is silicon nitride.

For example, in the case where the material of the nano-column structures 414 is silicon nitride, a refractive index of the nano-column structures is about 2.0. Thus, the manufacturing process of the nano-column structures may be compatible with the manufacturing process of the light-emitting device, thereby reducing the difficulty of manufacturing the light-emitting device.

For example, in the case where the material of the nano-column structures 414 is silicon nitride, an extinction coefficient of the nano-column structures is close to 0. Thus, the absorption of light by the nano-column structures may be avoided as much as possible, thereby reducing the light loss of the light-emitting device.

For example, the plurality of nano-column structures 414 perform the phase conversion on the light incident on the surface thereof.

For example, the light-emitting device 40 further includes a first base 48 that is located on a side of the phase conversion layer 413 away from the epitaxial structure 42.

For example, the first base 48 has a substantially flat surface, and the plurality of nano-column structures 414 are located on the first base 48.

In some other examples, as shown in FIG. 72, the phase conversion layer 413 includes a plurality of via holes 415. The plurality of t via holes 415 are periodically arranged.

For example, orthographic projections of the plurality of via holes on the first base are in a shape of a rectangle.

In yet some other examples, the first base 48 of the light-emitting device includes a plurality of depressions that are periodically arranged, and the first base 48 is also used as the phase conversion layer 413.

For example, orthographic projections of the plurality of depressions on a plane where the first base is located are in a shape of a rectangle.

In yet some other examples, the phase conversion layer includes a plurality of nano-column structures and a plurality of via holes.

For example, the plurality of via holes and the plurality of nano-column structures are arranged periodically.

For example, a shape of an orthographic projection, on the first base, of the via hole is substantially the same as a shape of an orthographic projection, on the first base, of the nano-column structure.

In yet some other examples, the phase conversion layer is of a wire grid structure.

It can be understood that, for the cases of the phase conversion layer including the plurality of nano-column structures, the phase conversion layer including the plurality of via holes, and the phase conversion layer including the plurality of depressions, the arrangement period and structural parameters of the plurality of nano-column structures, the arrangement period and structural parameters of the plurality of via holes, and the arrangement period and structural parameters of the plurality of depressions are substantially the same, respectively. The phase conversion may occur when light is incident on the nano-column structures, via holes or depressions. For the convenience of introduction, the following is described by taking an example where the phase conversion layer includes the plurality of nano-column structures.

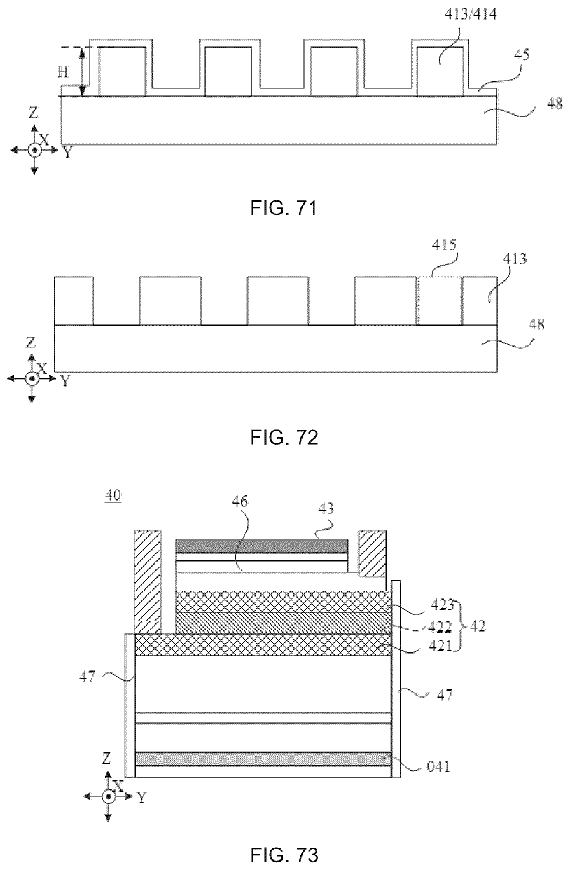

Specifically, when light is incident on the nano-column structures, the phase difference before and after the phase conversion may be in a range of 0 to 2π. Among the phase differences of 0 to 2π, 8 phase differences, which are π/4, π/2, 3π/4, π, 5π/4, 3π/2, 7π/4, and 2π in sequence, are divided. For example, by adjusting the arrangement period and structural parameters of the nano-column structures, the incident light can be accurately converted between the above eight phase differences. In addition, for the plurality of nano-column structures 414 of the phase conversion layer 413, a different arrangement period and different structural parameters will affect the phase conversion efficiency of the phase conversion layer 413. In addition, the phase conversion efficiency is also related to the wavelength of the light incident on the plurality of nano-column structures 414. Therefore, for each of light-emitting devices that emit light of different wavelengths, the arrangement period and structural parameters of the nano-column structures of the phase conversion layer 413 disposed in the light-emitting device are also different. For example, as shown in FIG. 70, the nano-column structures 414 are in a shape of a cuboid. The arrangement period of the nano-column structures 414 includes a first period P1 and a second period P2; the first period P1 is a repetition period of long sides L in the top view of the cuboids, and the second period P2 is a repetition period of short sides W in the top view of the cuboids. As shown in FIGS. 70 and 71, the structural parameters of the nano-column structures 414 include: the dimension L of the long side of the nano-column structure, the dimension W of the short side of the nano-column structure, and the height H of the nano-column structure.

The nano-column structures will be introduced below by taking an example where the phase conversion layer 413 can perform phase conversion of (2n−1)×π/2 on the light incident on its surface.

For example, in the light-emitting device, the first period P1 and the second period P2 of the plurality of nano-column structures 414 are equal. Thus, the manufacturing process of the phase conversion layer and the light-emitting device may be simplified.

For example, in a case where the light-emitting device emits red light (for example, the wavelength of the red light is 620 nm), the first period P1 and the second period P2 are both 300 nm, the height H of the nano-column structure is 700 nm, the ratio of the height H of the nano-column structure to the short side dimension W of the nano-column structure is greater than or equal to 5:1, the ratio of the long side dimension L to the short side dimension W of the nano-column structure is 1, and the short side dimension W of the nano-column structure is 120 nm. Thus, the phase conversion layer can perform phase conversion of π/2 on most of the red light incident on its surface. If the short side dimension of the nano-column structure in the above structural parameters is set to 60 nm, and the other structural parameters are the same, then the phase conversion layer can perform phase conversion of 3π/2 on the red light incident on its surface.

Thus, the phase conversion efficiency of the red light incident on the nano-column structures may be improved, and most of the red light incident on the phase conversion layer can undergo phase conversion. For example, most of the red light incident on the nano-column structures is light reflected from the metal wire grid to the phase conversion layer, and this part of the red light is TE light; the TE light undergoes π/2 (here n is 1) phase conversion through the phase conversion layer, and then directs to the metal wire grid; after being reflected by the metal wire grid, the TE light is incident on the phase conversion layer again, and undergoes π/2 phase conversion again. That is, after two phase conversions, most of the TE light is converted into TM light. As a result, this part of the TM light is incident on the metal wire grid again, and then passes through the metal wire grid for exiting, thereby improving the light extraction efficiency of the light-emitting device that emits the red light.

For another example, in a case where the light-emitting device emits blue light (for example, the wavelength of the blue light is 450 nm), the first period P1 and the second period P2 are both 225 nm, the height H of the nano-column structure is 700 nm, the ratio of the height H of the nano-column structure to the short side dimension W of the nano-column structure is greater than or equal to 5:1, the ratio of the long side dimension L to the short side dimension W of the nano-column structure is 1, and the short side dimension W of the nano-column structure is 45 nm. Thus, the phase conversion layer can perform phase conversion of π/2 on the blue light incident on its surface. If the short side dimension of the nano-column structure in the above structural parameters is set to 80 nm, and the other structural parameters are the same, then the phase conversion layer can perform phase conversion of 3π/2 on the blue light incident on its surface.

Thus, the phase conversion efficiency of the blue light incident on the nano-column structures may be improved, and most of the blue light incident on the phase conversion layer can undergo phase conversion. For example, most of the blue light incident on the nano-column structures is light reflected from the metal wire grid to the phase conversion layer, and this part of the blue light is TE light; the TE light undergoes π/2 (here n is 1) phase conversion through the phase conversion layer, and then directs to the metal wire grid; after being reflected by the metal wire grid, the TE light is incident on the phase conversion layer again, and undergoes π/2 phase conversion again. That is, after two phase conversions, most of the TE light is converted into TM light. As a result, this part of the TM light is incident on the metal wire grid again, and then passes through the metal wire grid for exiting, thereby improving the light extraction efficiency of the light-emitting device that emits the blue light.

For another example, in a case where the light-emitting device emits green light (for example, the wavelength of the green light is 532 nm), the first period P1 and the second period P2 are both 250 nm, the height H of the nano-column structure is 700 nm, the ratio of the height H of the nano-column structure to the short side dimension W of the nano-column structure is greater than or equal to 5:1, the ratio of the long side dimension L to the short side dimension W of the nano-column structure is 1, and the short side dimension W of the nano-column structure is 80 nm. Thus, the phase conversion layer can perform phase conversion of π on the green light incident on its surface. If the short side dimension of the nano-column structure in the above structural parameters is set to 115 nm, and the other structural parameters are the same, then the phase conversion layer can perform phase conversion of 3π on the green light incident on its surface.

Thus, the phase conversion efficiency of the green light incident on the nano-column structures may be improved, and most of the green light incident on the phase conversion layer can undergo phase conversion. For example, most of the green light incident on the nano-column structures is light reflected from the metal wire grid to the phase conversion layer, and this part of the green light is TE light; the TE light undergoes π/2 (here n is 1) phase conversion through the phase conversion layer, and then directs to the metal wire grid; after being reflected by the metal wire grid, the TE light is incident on the phase conversion layer again, and undergoes π/2 phase conversion again. That is, after two phase conversions, most of the TE light is converted into TM light. As a result, this part of the TM light is incident on the metal wire grid again, and then passes through the metal wire grid for exiting, thereby improving the light extraction efficiency of the light-emitting device that emits the green light.

In an implementation, a quarter-wave plate is used to replace the phase conversion layer in the above embodiments. The quarter-wave plate can also perform the phase conversion on the light incident on its surface. However, the transmittance of the quarter-wave plate is in a range of about 50% to 60%, and the polarization conversion rate of the quarter-wave plate is in a range of about 25% to 30%, resulting in a low polarization conversion rate; the structure of the quarter-wave plate is relatively complex, its manufacturing process is difficult to be compatible with the manufacturing process of existing light-emitting devices, and it is difficult to be directly integrated on the epitaxial structure; and in addition, the thickness of the quarter-wave plate is relatively large, which is not conducive to the design of light weight and small thickness of the display apparatus.

However, by using the phase conversion layer including the plurality of nano-column structures in some embodiments of the present disclosure, the transmittance of the phase conversion layer is as high as 85%, the polarization conversion rate is about 42.5%, and the phase conversion layer can be adjusted according to the wavelength of light that needs the phase conversion. As a result, a high polarization conversion rate is obtained, and the thickness of the phase conversion layer is small, which may be in ultra-thin nanoscale dimensions; and thus, it is beneficial to achieve the design of light weight and small thickness of the light-emitting device and the display apparatus. In addition, the manufacturing method of the phase conversion layer may be compatible with the manufacturing method of other film layers of the light-emitting device, so that the phase conversion layer may be manufactured on the epitaxial structure, thereby simplifying the manufacturing process of the light-emitting device. The phase conversion layer may perform the phase conversion on light with a wavelength range of an entire white light spectrum (380 nm to 780 nm), and may accurately control the phase change of the incident light, e.g., the phase change value of nπ/2.

The nano-column structures will be introduced below by taking an example where the phase conversion layer 413 can perform phase conversion of (2n−1)×π on the light incident on its surface.

For example, in the light-emitting device, the first period P1 and the second period P2 of the plurality of nano-column structures 414 are equal. Thus, the manufacturing process of the phase conversion layer and the light-emitting device may be simplified.

For example, in a case where the light-emitting device emits red light (for example, the wavelength of the red light is 620 nm), the first period P1 and the second period P2 are both 300 nm, the height H of the nano-column structure is 700 nm, the ratio of the height H of the nano-column structure to the short side dimension W of the nano-column structure is greater than or equal to 5:1, the ratio of the long side dimension L to the short side dimension W of the nano-column structure is 1, and the short side dimension W of the nano-column structure is 140 nm. Thus, the phase conversion layer can perform the phase conversion of (2n−1)×π on most of the red light incident on its surface.

Thus, the phase conversion efficiency of the red light incident on the nano-column structures may be improved, and most of the red light incident on the phase conversion layer can undergo phase conversion. For example, most of the red light incident on the nano-column structures is light reflected from the metal wire grid to the phase conversion layer, and this part of the red light is TE light; the TE light undergoes (2n−1)×π phase conversion through the phase conversion layer, and most of the TE light is converted into TM light. As a result, this part of the TM light is incident on the metal wire grid again, and then passes through the metal wire grid for exiting, thereby improving the light extraction efficiency of the light-emitting device that emits the red light.

For another example, in a case where the light-emitting device emits blue light (for example, the wavelength of the blue light is 450 nm), the first period P1 and the second period P2 are both 225 nm, the height H of the nano-column structure is 700 nm, the ratio of the height H of the nano-column structure to the short side dimension W of the nano-column structure is greater than or equal to 5:1, the ratio of the long side dimension L to the short side dimension W of the nano-column structure is 1, and the short side dimension W of the nano-column structure is 65 nm. Thus, the phase conversion layer can perform the phase conversion of (2n−1)×π on the blue light incident on its surface.

Thus, the phase conversion efficiency of the blue light incident on the nano-column structures may be improved, and most of the blue light incident on the phase conversion layer can undergo phase conversion. For example, most of the blue light incident on the nano-column structures is light reflected from the metal wire grid to the phase conversion layer, and this part of the blue light is TE light; the TE light undergoes (2n−1)×π phase conversion through the phase conversion layer, and most of the TE light is converted into TM light. As a result, this part of the TM light is incident on the metal wire grid again, and then passes through the metal wire grid for exiting, thereby improving the light extraction efficiency of the light-emitting device that emits the blue light.

For another example, in a case where the light-emitting device emits green light (for example, the wavelength of the green light is 532 nm), the first period P1 and the second period P2 are both 250 nm, the height H of the nano-column structure is 700 nm, the ratio of the height H of the nano-column structure to the short side dimension W of the nano-column structure is greater than or equal to 5:1, the ratio of the long side dimension L to the short side dimension W of the nano-column structure is 1, and the short side dimension W of the nano-column structure is 100 nm. Thus, the phase conversion layer can perform the phase conversion of (2n−1)×π on the green light incident on its surface.

Thus, the phase conversion efficiency of the green light incident on the nano-column structures may be improved, and most of the green light incident on the phase conversion layer can undergo phase conversion. For example, most of the green light incident on the nano-column structures is light reflected from the metal wire grid to the phase conversion layer, and this part of the green light is TE light; the TE light undergoes (2n−1)×π phase conversion through the phase conversion layer, and most of the TE light is converted into TM light. As a result, this part of the TM light is incident on the metal wire grid again, and then passes through the metal wire grid for exiting, thereby improving the light extraction efficiency of the light-emitting device that emits the green light.

It can be understood that, in a case where wavelengths of light emitted by the light-emitting devices are different, the height of the nano-column structures in each light-emitting device can be set to 700 nm, thereby improving the processing convenience and consistency of different light-emitting devices, and achieving the high phase conversion efficiency of the nano-column structures on the white light in the wavelength range of 380 nm to 680 nm.

For example, the plurality of nano-column structures 414 are randomly arranged. In some embodiments, as shown in FIG. 71, the light-emitting device 40 further includes a first reflective layer 45 covering top and side surfaces of each nano-column structure 414.

For example, the first reflective layer 45 may reflect the light incident on its surface to prevent the light from being consumed due to passing through the first reflective layer 45, thereby reducing the light loss of the light-emitting device.

For example, the first reflective layer is made of a metal material. For example, the metal material is silver. By using silver as the material of the first reflective layer, the reflectivity of the first reflective layer may reach about 86%. For another example, the metal material is aluminum. By using aluminum as the material of the first reflective layer, the reflectivity of the first reflective layer may reach about 80%.

For example, the first reflective layer 45 may also be located on the first base 48 and in a region between two adjacent nano-column structures 414.

Since the first reflective layer 45 covers the nano-column structures, and there is a step difference between the nano-column structures and the first base 48, an overall profile of the first reflective layer 45 is periodically undulating. As a result, the light incident on the first reflective layer 45 is phase-converted and reflected under the cooperation of the nano-column structures and the first reflective layer 45, thereby reducing the light loss of the light-emitting device and improving the brightness of the light emitted by the light-emitting device.

In some embodiments, as shown in FIG. 73, the light-emitting device 40 further includes a third light conversion layer 46 located between the epitaxial structure 42 and the at least one metal wire grid 43.

For example, the third light conversion layer 46 is configured to reflect or transmit part of light incident on the third light conversion layer 46, and to change a polarization direction of at least part of light exiting through the third light conversion layer 46.

For example, the light incident on the third light conversion layer 46 may be reflected on the surface of the third light conversion layer 46 to exit towards a direction close to the first light conversion layer 041, or may pass through the third light conversion layer 46 to exit towards a direction close to the metal wire grid 43.

For example, the third light conversion layer 46 can depolarize the light incident on its surface. For example, most of the light reflected by the metal wire grid 43 is TE light; the TE light is incident on the third light conversion layer 46 and can be depolarized by the third light conversion layer 46, so that at least part of the TE light is converted into natural light; the natural light is incident on the metal wire grid 43, and the metal wire grid 43 allows TM light in the natural light to pass through. The natural light can also be reflected by the third light conversion layer 46 and then be incident on the first light conversion layer 041, and be reflected on the first light conversion layer 041 to change its polarization direction, thereby improving the efficiency of converting TE light into TM light, and in turn, increasing the transmittance of the metal wire grid 43 and improving the light extraction efficiency of the light-emitting device 40.

In some examples, the third light conversion layer 46 is further configured to change a color of part of the light incident on the third light conversion layer 46.

For example, a material of the third light conversion layer 46 include a color transfer material or a fluorescent material, thereby changing the color of the light incident on the third light conversion layer 46.

With the above arrangement, the number of oscillations of light in the epitaxial structure 42, buffer layer and other film layers between the metal wire grid 43 and the first light conversion layer 041 may be reduced, thereby reducing the absorption loss of light during the oscillation process, and greatly improving the light extraction efficiency of the light-emitting device 40. In addition, the third light conversion layer 46 has a strong depolarization effect, and when combined with the first light conversion layer 041, the depolarization efficiency may be further improved, thereby improving the light extraction efficiency of the light-emitting device 40.

In some embodiments, as shown in FIG. 8C, the light-emitting device 40 further includes a second reflective layer 47. The second reflective layer 47 surrounds at least side surfaces of the first light conversion layer 041 and the epitaxial structure 42, and the second reflective layer 47 is configured to reflect light incident on the second reflective layer 47, and enable the reflected light to exit towards the light-exit side of the light-emitting device 40.

For example, in the case where the light-emitting device 40 further includes the buffer layer 44, the second reflective layer 47 surrounds side surfaces of the first light conversion layer 041, the epitaxial structure 42 and the buffer layer 44.

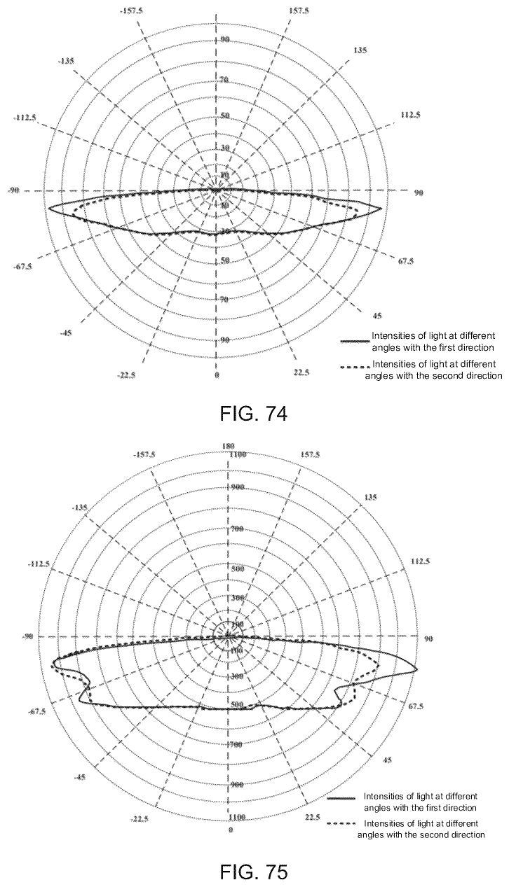

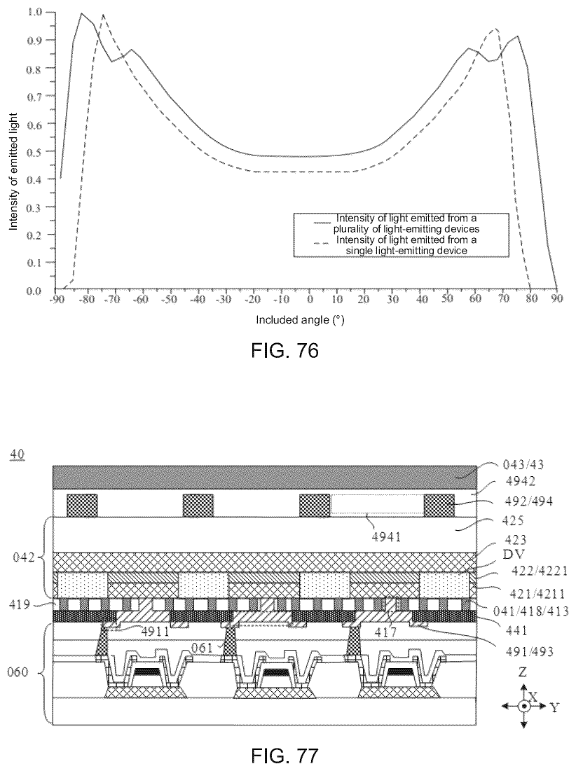

It can be understood that, light emitted by a single light-emitting device is emitted from six surfaces of the light-emitting device, and a chromatographic distribution of the light emitted from the light-emitting device is as shown in FIG. 74. A chromatogram of light emitted from a plurality of light-emitting devices arranged in an array is shown in FIG. 75. It can be seen from FIG. 74 that, light with different light intensities is emitted in a normal direction of a top surface of the light-emitting device and in a direction at an angle with the normal line. And the intensity of the emitted light at a large angle (here, the large angle means that an included angle between a direction of light emission and a plane where the normal line and the first direction are located is greater than 45°, or an included angle between the direction of light emission and a plane where the normal line and the second direction are located is greater than 45°) is greater than the intensity of the emitted light in the normal direction. It can be seen from FIGS. 74 and 75 that the light emitted from of the plurality of light-emitting devices is similar to that of the single light-emitting device. The comparison of the light emitted from the plurality of light-emitting devices and the light emitted from the single light-emitting device is shown in FIG. 76.

Most of the light emitted at a large angle is emitted from a side surface of the light-emitting device, while most of the light emitted at a small angle (here, the small angle means that an included angle between the direction of light emission and the normal line is less than or equal to 45°) is emitted from a main light-exit surface of the light-emitting device (here, the main light-exit surface refers to the top surface of the light-emitting device, which can be considered as the main light-exit surface of the light-emitting device). The light emitted from the main light-exit surface is light that is emitted by the epitaxial structure and then exits after being filtered by the metal wire grid). The light emitted from the side surface of the light-emitting device is mostly emitted from the side surface of the epitaxial structure, and if the light is not processed (that is, it exits without being filtered by the metal wire grid), it may be possible to reduce the polarization degree of the light exiting from the light-emitting device, and thereby reduce the contrast of the display apparatus.

By arranging the second reflective layer 47 in the embodiments of the present disclosure, the light emitted from the side surface of the epitaxial structure 42 is reflected to the inside of the epitaxial structure 42, so that the light passes through the metal wire grid and then exits from the main light-exit surface of the light-emitting device. Thus, the polarization degree of the light exiting from the light-emitting device and the contrast of the display apparatus may be improved. In addition, the above arrangement may also reduce the crosstalk between the light emitted by adjacent light-emitting devices and improve the display effect of the display apparatus.

In some embodiments, as shown in FIG. 9, the light-emitting device 40 further includes a first electrode 491 and a second electrode 492.

For example, the first electrode 491 is electrically connected to the first semiconductor layer 421 and provides a first voltage signal for the first semiconductor layer 421. The second electrode 492 is electrically connected to the second semiconductor layer 423 and provides a second voltage signal for the second semiconductor layer 423.

For example, the second electrode 492 is a common electrode. For example, in a case where the material of the second semiconductor layer 423 is n-GnN, the second electrode 492 is a common cathode. For example, in a case where the material of the second semiconductor layer 423 is p-GnN, the second electrode 492 is a common anode. For example, the driving circuit layer 060 may be electrically connected to the second electrode 492 through a signal line to provide the second electrode 492 with the second voltage signal.

In some other embodiments, as shown in FIG. 77, the first light conversion layer 041 includes a phase conversion layer 413 and the first electrode layer 493 described above. The phase conversion layer 413 is located between the first electrode layer 493 and the light-emitting portion 042.

The first electrode layer 493 includes a plurality of first electrodes 491 spaced apart from each other, and each of the first electrodes 121 is electrically connected to at least one island-shaped first semiconductor unit 4211.

For example, a single first electrode 491 is electrically connected to a single island-shaped first semiconductor unit 4211, so that the single first electrode 491 can provide the voltage for the single island-shaped first semiconductor unit 4211 and a corresponding island-shaped light-emitting unit 4221. Thus, each island-shaped light-emitting unit 4221 may emit light independently, which is beneficial to reducing the pixel size of the display substrate 2 and improving the pixel density and resolution of the display substrate 2.

For another example, a single first electrode 491 is electrically connected to multiple island-shaped first semiconductor units 4211, so that the single first electrode 491 can provide the voltage for the multiple island-shaped first semiconductor units 4211 and corresponding island-shaped light-emitting units 4221. Thus, the number of first electrodes 491 in the first electrode layer 493 may be reduced, which is beneficial to simplifying the process of manufacturing the first electrode layer 493.

For example, the first electrode 491 is configured to reflect light incident on the first electrode 491. Here, the first electrode 491 is also used as a reflective layer to reflect light. The phase conversion layer 413 can be considered to be located between the reflective layer (i.e., the first electrode 491) and the light-emitting portion 042.

Thus, the first electrode 491 or the first light conversion layer 041 may change the traveling direction of the light incident thereon, so that the light exits in a direction towards the second light conversion layer 043. After the light is incident on the phase conversion layer 413, and its polarization direction is changed by the phase conversion layer 413 (for example, after TE light is converted into TM light), the light is incident on the metal wire grid 43 again and then exits through the metal wire grid 43, thereby improving the light extraction efficiency of the light-emitting device 40.

In some examples, as shown in FIG. 17, the phase conversion layer 413 further includes a plurality of conductive portions 416.

For example, the conductive portion 416 is partially directly opposite to at least one island-shaped first semiconductor unit 4211. Thus, the conductive portion 416 can be electrically connected to the island-shaped first semiconductor unit 4211.

For example, the phase conversion layer 413 is made of a conductive material, and the conductive material includes a metal material, e.g., metal aluminum. Thus, a portion of the phase conversion layer 413 can constitute the plurality of conductive portions 416, which not only have a conductive function but can also change the polarization direction of light incident thereon.

The conductive portion 416 can realize electrical connection between the first electrode 491 and the island-shaped first semiconductor unit 4211(s). Specifically, one side of a single conductive portion 416 is electrically connected to a first electrode 491, and the other side of the single conductive portion 416 is electrically connected to at least one island-shaped first semiconductor unit 4211.

In some other examples, as shown in FIG. 77, the phase conversion layer 413 further includes a plurality of first via holes 417, and a first electrode 491 is electrically connected to at least one island-shaped first semiconductor unit 4211 through a first via hole 417.

For example, the phase conversion layer 413 is made of an inorganic material.

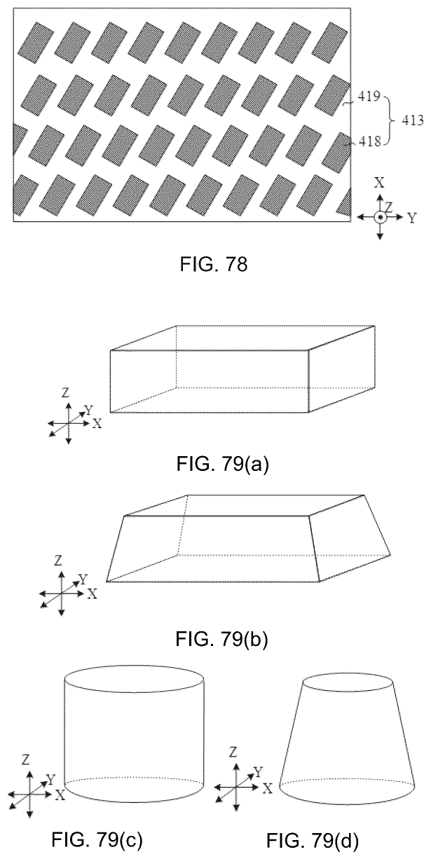

In some examples, as shown in FIG. 78, the phase conversion layer 413 includes a plurality of nanostructures 418 arranged in an array, and a first dielectric layer 419 located between any two adjacent nanostructures 418.

For example, the top view of the first dielectric layer 419 is of a mesh structure, and the plurality of nanostructures 418 are located in squares of the mesh structure. The first dielectric layer 419 is filled between adjacent nanostructures 418, and portions of the first dielectric layer 419 each between any two adjacent nanostructures 418 are connected to each other to form a one-piece structure.

For example, a surface of the first dielectric layer 419 away from the light-emitting portion 042 may be substantially flush with or may be flush with surfaces of the nanostructures 418 away from the light-emitting portion 042.

By arranging the first dielectric layer 419, a surface of the phase conversion layer 413 away from the light-emitting portion 042 may be as flat as possible, which is beneficial to simplifying the manufacturing of other film layers (such as the current blocking layer described below and the first electrode layer) on the phase conversion layer 413.

For example, a surface of the first dielectric layer 419 close to the light-emitting portion 042 is flush with surfaces of the nanostructures 418 close to the light-emitting portion 042. The overall surface formed by the surface of the first dielectric layer 419 close to the light-emitting portion 042 and the surfaces of the nanostructures 418 close to the light-emitting portion 042 is relatively flat or substantially flat.

Therefore, in a process of light emitted by the light-emitting portion 042 being incident on the phase conversion layer 413, after the light is changed in the traveling direction and polarization direction by the phase conversion layer 413, the light may exit from the overall surface of the first dielectric layer 419 and the plurality of nanostructures 418 close to the light-emitting portion 042. Since the surface is relatively flat, the influence of the surface on the exit direction of the light may be reduced, thereby ensuring that the light exits substantially in a direction towards the island-shaped light-emitting unit 4221 after exiting from the surface, avoiding the light loss caused by the light exiting in a direction towards the isolation portion DV after exiting from the surface, reducing the loss of the light during the exit process, and in turn, helping improve the light extraction efficiency of the light-emitting device 40.

For example, a refractive index of the first dielectric layer 419 is in a range of 1.3 to 1.5.

For example, the refractive index of the first dielectric layer 419 is in a range of 1.30 to 1.40, or in a range of 1.40 to 1.50, or in a range of 1.32 to 1.48.

For example, the refractive index of the first dielectric layer 419 is 1.30, 1.35, 1.38, 1.41, 1.46, or 1.50.

With the above setting, the refractive index of the first dielectric layer 419 may be matched with the refractive index of the first electrode layer 493 (or the first semiconductor layer 421) (for example, the refractive indexes of the two may be made as close or equal as possible), thereby reducing the light loss in a process of light being incident on the first electrode layer 493 from the first dielectric layer 419 and then incident on the first dielectric layer 419 from the first electrode layer 493, and further improving the light extraction efficiency of the light-emitting device 40.

For example, an absorption coefficient of the first dielectric layer 419 is close to 0, or equal to 0. Thus, the loss caused by the absorption of light by the first dielectric layer 419 may be reduced as much as possible, thereby further improving the light extraction efficiency of the light-emitting device 40.

For example, the first dielectric layer 419 is made of an inorganic material; and a refractive index of the inorganic material is 1.5, and an absorption coefficient of the inorganic material is 0.

A dimension of the nanostructure 418 is smaller than the wavelength of light (which may be the wavelength of visible light). The nanostructures 418 arranged in the array can have a phase modulation effect on the incident light, thereby changing polarization direction of the incident light. For example, the nanostructures arranged in the array enable the phase of light, which is incident on the surfaces of the nanostructures and then exits, to change. For example, a phase difference between the light before and after being incident on the nanostructures is π, π/2, etc. As a result, the polarization direction of the light is changed.

For example, a material of the nanostructures 418 may be varied and may be selected according to actual conditions, and the present disclosure does not limit this.

For example, the material of the nanostructures 418 is an inorganic material, such as silicon nitride.

In the case where the material of the nanostructures 418 is the inorganic material, the phase conversion layer 413 includes the plurality of the first via holes 417 described above.

For another example, the material of the nanostructures 418 is a conductive material. The conductive material may be a metal material, such as metal aluminum, or metal silver.

In the case where the material of the nanostructures 418 is the conductive material, multiple conductive portions 416 of the phase conversion layer 413 may be composed of multiple adjacent nanostructures 418.

For example, a shape of the nanostructure 418 may be varied and may be selected according to actual conditions, and the present disclosure does not limit this.

In some examples, the structure and shape of the nanostructure 418 may be the same as those of the nano-column structure 414 in some of the above embodiments.

In some other examples, as shown in FIGS. 79(a)-(d), the nanostructure 418 is in a shape of one of a cuboid, a frustum of a pyramid, an elliptical cylinder, and a frustum of an elliptical cone.

It can be understood that the frustum of the pyramid may be a polygonal prism in a non-strict sense, and its side surface is not strictly perpendicular to the bottom surface or top surface. For example, an included angle between the side surface and the bottom surface of the frustum of the pyramid may be a large acute angle, which is 78°, 80°, 82°, 85°, 87° or 89°. The top surface and the bottom surface of the frustum of the pyramid are parallel to each other, and an area of the top surface is not equal to that of the bottom surface (for example, the area of the top surface is smaller than that of the bottom surface). The frustum of the elliptical cone may be an elliptical cylinder in a non-strict sense, and its side surface is not strictly perpendicular to the bottom surface or top surface. The top surface and the bottom surface of the frustum of the elliptical cone are parallel to each other, and an area of the top surface is not equal to that of the bottom surface (for example, the area of the top surface is smaller than that of the bottom surface).

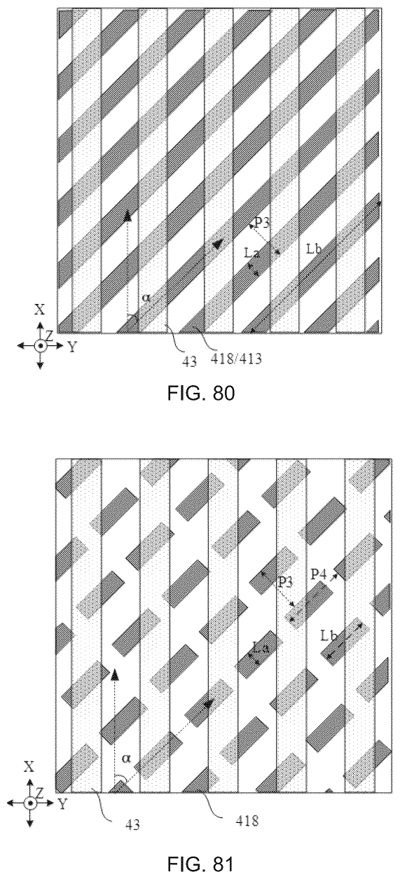

In some other examples, as shown in FIG. 80, the plurality of nanostructures 418 are all cuboids with a large size, and the phase conversion layer 413 formed by the plurality of nanostructures 418 is of a wire grid structure.

In some embodiments, as shown in FIGS. 80 and 81, an orthographic projection of the nanostructure 418 on a plane where the light-emitting portion 042 is located is in a shape of a rectangle, and the rectangle includes a first side and a second side; a dimension La of the first side is smaller than a dimension Lb of the second side; and an included angle α between the direction where the second side of the nanostructure 418 is located and the first direction X is in a range of 30° to 60°. It should be noted that, for the description that the orthographic projection of the nanostructure 418 on the plane where the light-emitting portion 042 is located is in the shape of the rectangle, the rectangle here includes a rectangle in mathematical definition or a rectangle with rounded corners.

For example, the included angle α between the direction where the second side of the nanostructure 418 is located and the first direction X is in a range of 30° to 45°, 45° to 60°, or 40° to 50°.

For example, the included angle α between the direction where the second side of the nanostructure 418 is located and the first direction X is 30°, 33°, 41°, 45°, 48°, 52° or 60°.

In some other embodiments, as shown in FIG. 86, the orthographic projection of the nanostructure 418 on the plane where the light-emitting portion 042 is located is in a shape of an ellipse, which includes a major axis and a minor axis. An included angle α between the direction where the major axis of the nanostructure 418 is located and the first direction X is in a range of 30° to 60°.

For example, the included angle α between the direction where the major axis of the nanostructure 418 is located and the first direction X is in a range of 30° to 45°, 45° to 60°, or 40° to 50°.

For example, the included angle α between the direction where the major axis of the nanostructure 418 is located and the first direction X is 30°, 33°, 41°, 45°, 48°, 52° or 60°.

By setting the included angle α within the range of 30° to 60°, the polarization direction of most of light reflected by the second light conversion layer 043 can be deflected by about 90° on the nanostructures 418 of the phase conversion layer 413 (or the phase of most of the light is delayed by about π phase on the nanostructures 418), so that most of the light is converted into TM light. Thus, most of light incident from the phase conversion layer 413 onto the second light conversion layer 043 may pass through the second light conversion layer 043 and exit, thereby improving the light extraction efficiency of the light-emitting device 40.

In some examples, the wavelength of light emitted by the light-emitting portion 042 is in a range of 435 nm to 485 nm. The refractive index of the first dielectric layer 419 is in a range of 1.46 to 1.50. The light-emitting portion 042 includes the first semiconductor layer 421 and the second semiconductor layer 423, and the refractive index of the first semiconductor layer 421 is in a range of 2.30 to 2.42. The material of the nanostructures 418 is metal aluminum.

For example, the wavelength of the light emitted by the light-emitting portion 042 is in a range of: 435 nm to 455 nm, 455 nm to 485 nm, 435 nm to 465 nm, 440 nm to 475 nm, or 455 nm to 470 nm. For example, the wavelength of the light emitted by the light-emitting portion 042 is 435 nm, 456 nm, 465 nm, 477 nm or 485 nm.

For example, the refractive index of the first dielectric layer 419 is in a range of 1.46 to 1.48, 1.47 to 1.50, or 1.46 to 1.47. For example, the refractive index of the first dielectric layer 419 is 1.46, 1.47, 1.48, 1.49, or 1.50.

For example, the refractive index of the first semiconductor layer 421 is in a range of 2.30 to 2.32, 2.32 to 2.38, 2.30 to 2.40, 2.35 to 2.42, or 2.40 to 2.42. For example, the refractive index of the first semiconductor layer 421 is 2.30, 2.32, 2.37, 2.40, or 2.42.

In the case where the light-emitting device further includes the current spreading layer 424, the refractive index of the current spreading layer 424 may be in a range of 2.02 to 2.22. For example, the refractive index of the current spreading layer 424 is 2.02, 2.08, 2.15, 2.18, or 2.22. Thus, the refractive indexes of the first dielectric layer 419, the current spreading layer 424 and the first semiconductor layer 421 may be relatively close, and the light loss is small when the light passes through the first dielectric layer 419, the current spreading layer 424 and the first semiconductor layer 421 in sequence, thereby reducing the light loss of the light-emitting device 40.

With the above setting, the nanostructures 418 made of the metal aluminum material may be matched with the wavelength of the light from the first dielectric layer 419, the first semiconductor layer 421, the current spreading layer 424 and the light-emitting portion 042, so that the phase conversion layer 413 formed by the nanostructures 418 has a high polarization conversion rate for light, thereby improving the polarization conversion rate of the light-emitting device 40.

The following describes various size parameters of the nanostructure 418 for cases where the nanostructure 418 of the phase conversion layer 413 has a different shape.

In some examples, as shown in FIG. 80, in a case where the nanostructure 418 is in the shape of the cuboid, and a length of the cuboid is large enough (for example, the long side of the cuboid constitutes one side of the phase conversion layer 413), the plurality of nanostructures 418 constitute a wire grid structure. The repetition period P3 of the wire grid structure is in a range of 180 nm to 220 nm, the height of the nanostructure 418 is in a range of 60 nm to 140 nm, and the line width La of the wire grid structure is in a range of 40 nm to 80 nm.

For example, the repetition period P3 of the wire grid structure is in a range of 190 nm to 210 nm, the line width of the wire grid structure is in a range of 50 nm to 70 nm, and the height of the nanostructure is in a range of 80 nm to 120 nm.

For example, the repetition period P3 of the wire grid structure is 180 nm, 188 nm, 190 nm, 210 nm or 220 nm; the line width of the wire grid structure is 40 nm, 50 nm, 60 nm, 70 nm or 80 nm; and the height of the nanostructure is 60 nm, 80 nm, 100 nm, 120 nm or 140 nm.

It can be understood that the minimum repetition period of the plurality of nanostructures 418 along the direction perpendicular to their extension direction constitutes the repetition period of the wire grid structure, and the dimension La of the first side of the nanostructure 418 is the line width mentioned above.

With the above setting, the phase conversion layer 413 may convert more TE light into TM light, thereby improving the light extraction efficiency of the light-emitting device 40.

The inventors have conducted an experiment on the light-emitting device 40 including the plurality of nanostructures 418 in the shape of the cuboid in this example. In addition, in the light-emitting device 40 in this experiment, the refractive index of the first semiconductor layer 421 is set to 2.42, the refractive index of the current spreading layer 424 is set to 2.02, the refractive index of the first dielectric layer 419 is set to 2.02, the wavelength of the light emitted by the light-emitting portion 042 is set to be in a range of 435 nm to 485 nm, and the material of the nanostructures 418 is metal aluminum. The experimental result shows that the phase conversion layer 413 formed by the nanostructures 418 may convert about 79.3% of TE light in the incident light into TM light. It can be seen that the phase conversion layer 413 may effectively improve the light extraction efficiency of the light-emitting device 40.

In addition, the inventors have conducted an experiment on the light-emitting device including the phase conversion layer 413 in this example and the metal wire grid 43 (here, the included angle between the direction where the second side of the nanostructure 418 is located and the first direction X is 45°). The experimental result shows that the light-emitting device 40 emits light of a single-polarization state, and the maximum light extraction efficiency of the light-emitting device 40 can reach about 62%. Compared with the light-emitting device in the related art, in which only the metal wire grid is provided, the light extraction efficiency of the light-emitting device is increased by about 50%.

In some other examples, as shown in FIG. 81, in a case where the nanostructure 418 is in the shape of the cuboid, the top view shape of the nanostructure 418 includes a first side and a second side, and a dimension La of the first side is smaller than a dimension Lb of the second side. The dimension La of the first side is in a range of 40 nm to 80 nm. The minimum repetition period P3 of the plurality of nanostructures 418 along the extension direction of the first side is in a range of 160 nm to 240 nm. The dimension Lb of the second side is in a range of 540 nm to 580 nm, and the ratio of the dimension Lb of the second side to the minimum repetition period P4 of the plurality of nanostructures 418 along the extension direction of the second side is in a range of 0.86 to 1.00. The height of the nanostructure 418 is in a range of 60 nm to 140 nm.

For example, the dimension La of the first side is in a range of 50 nm to 70 nm; the minimum repetition period P3 of the plurality of nanostructures 418 along the extension direction of the first side is in a range of 180 nm to 220 nm; the dimension Lb of the second side is in a range of 550 nm to 570 nm; the minimum repetition period P4 of the plurality of nanostructures 418 along the extension direction of the second side is in a range of 590 nm to 610 nm, and the ratio of the dimension Lb of the second side to the minimum repetition period P4 of the plurality of nanostructures 418 along the extension direction of the second side is in a range of 0.87 to 1.00; and the height of the nanostructure 418 is in a range of 80 nm to 120 nm.

For example, the dimension La of the first side is 40 nm, 50 nm, 62 nm, 70 nm or 80 nm. The minimum repetition period P3 of the plurality of nanostructures 418 along the extension direction of the first side is 160 nm, 180 nm, 200 nm, 220 nm or 240 nm. The dimension Lb of the second side is 540 nm, 550 nm, 565 nm, 570 nm or 580 nm. The minimum repetition period P4 of the plurality of nanostructures 418 along the extension direction of the second side is 590 nm, 595 nm, 600 nm, 607 nm or 610 nm. The height of the nanostructure 418 is 60 nm, 80 nm, 100 nm, 120 nm or 140 nm.

The inventors have conducted an experiment on the light-emitting device 40 including the plurality of nanostructures 418 in the shape of the cuboid in this example. In addition, in the light-emitting device 40 in this experiment, the refractive index of the first semiconductor layer 421 is set to 2.42, the refractive index of the current spreading layer 424 is set to 2.02, the refractive index of the first dielectric layer 419 is set to 2.02, the wavelength of the light emitted by the light-emitting portion 042 is set to be in a range of 435 nm to 485 nm, and the material of the nanostructures 418 is metal aluminum. The experimental result shows that the phase conversion layer 413 formed by the nanostructures 418 may convert about 76% of TE light in the incident light into TM light. It can be seen that the phase conversion layer 413 may effectively improve the light extraction efficiency of the light-emitting device 40.

In addition, the inventors have conducted an experiment on the light-emitting device 40 including the phase conversion layer 413 in this example and the metal wire grid 43 (here, the included angle between the direction where the second side of the nanostructure 418 is located and the first direction X is 45°). The experimental result shows that the light-emitting device 40 emits light of a single-polarization state, and the maximum light extraction efficiency of the light-emitting device 40 can reach about 60%. Compared with the light-emitting device 40 in the related art, in which only the metal wire grid is provided, the light extraction efficiency of the light-emitting device 40 is increased by about 45%.

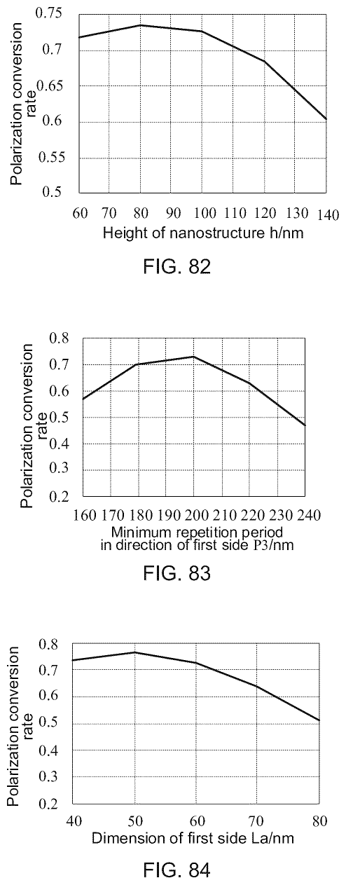

The inventors have also simulated phase conversion layers 413 each formed by nanostructures 418 of a different size in this example, and the polarization conversion rates of the phase conversion layers 413 are obtained through simulation calculation, and are plotted to obtain FIGS. 82 to 85.

As shown in FIG. 82, in a case where the height of the nanostructure 418 is in the range of 60 nm to 140 nm, the polarization conversion rate of the phase conversion layer 413 is greater than 0.62. In a case where the height of the nanostructure 418 is in the range of 80 nm to 120 nm, the polarization conversion rate of the phase conversion layer 413 is greater than 0.68. The polarization conversion rate of the phase conversion layer 413 is relatively high, which is beneficial to improving the light extraction efficiency of the light-emitting device 40.

As shown in FIG. 84, in a case where the dimension La of the first side of the nanostructure 418 is in the range of 40 nm to 80 nm, the polarization conversion rate of the phase conversion layer 413 is greater than 0.50. In a case where the line width of the nanostructure 418 is in the range of 50 nm to 70 nm, the polarization conversion rate of the phase conversion layer 413 is greater than 0.62. The polarization conversion rate of the phase conversion layer 413 is relatively high, which is beneficial to improving the light extraction efficiency of the light-emitting device 40.

As shown in FIG. 83, in a case where the minimum repetition period P3 of the nanostructures 418 along the extension direction of the first side is in the range of 180 nm to 220 nm, the polarization conversion rate of the phase conversion layer 413 is greater than 0.60. In a case where the minimum repetition period P3 of the nanostructures 418 along the extension direction of the first side is in the range of 190 nm to 210 nm, the polarization conversion rate of the phase conversion layer 413 is greater than 0.65. The polarization conversion rate of the phase conversion layer 413 is relatively high, which is beneficial to improving the light extraction efficiency of the light-emitting device 40.

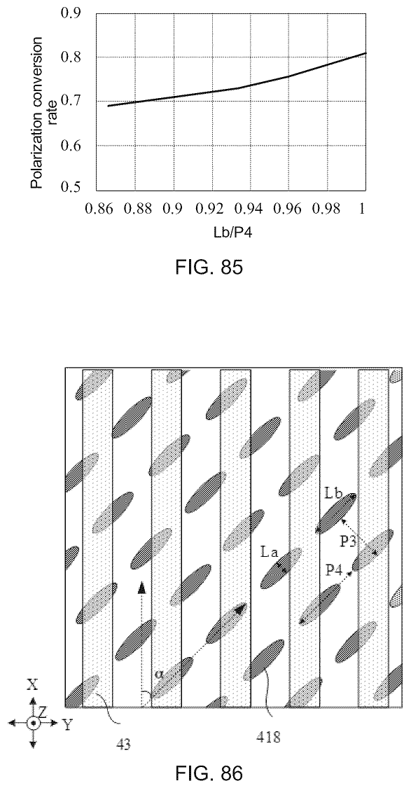

As shown in FIG. 85, in a case where the ratio of the dimension Lb of the second side of the nanostructure 418 to the minimum repetition period P4 of the plurality of nanostructures 418 along the extension direction of the second side is in the range of 0.87 to 1.00, the polarization conversion rate of the phase conversion layer 413 is greater than 0.70. In a case where the ratio of the dimension Lb of the second side to the minimum repetition period P4 of the plurality of nanostructures 418 along the extension direction of the second side is in the range of 0.92 to 1.00, the polarization conversion rate of the phase conversion layer 413 is greater than 0.72. The polarization conversion rate of the phase conversion layer 413 is relatively high, which is beneficial to improving the light extraction efficiency of the light-emitting device 40.

In some other examples, as shown in FIG. 86, in a case where the nanostructure 418 is in the shape of the elliptical cylinder, the top view shape of the nanostructure 418 includes a major axis and a minor axis. The dimension La of the minor axis is in a range of 40 nm to 80 nm. The minimum repetition period P3 of the plurality of nanostructures 418 along the extension direction of the minor axis is in a range of 160 nm to 220 nm. The dimension Lb of the major axis is in a range of 540 nm to 580 nm, and the ratio of the dimension Lb of the major axis to the minimum repetition period P4 of the plurality of nanostructures 418 along the extension direction of the major axis is in a range of 0.87 to 1.00. The height of the nanostructure 418 is in a range of 60 nm to 140 nm.

For example, in the case where the nanostructure 418 is in the shape of the elliptical cylinder, the dimension La of the minor axis is in a range of 50 nm to 70 nm; the minimum repetition period P3 of the plurality of nanostructures 418 along the extension direction of the minor axis is in a range of 170 nm to 210 nm; the dimension Lb of the major axis is in a range of 550 nm to 570 nm, and the ratio of the dimension Lb of the major axis to the minimum repetition period P4 of the plurality of nanostructures 418 along the extension direction of the major axis is in a range of 0.88 to 1.00; and the height of the nanostructure 418 is in a range of 80 nm to 120 nm.

For example, in the case where the nanostructure 418 is in the shape of the elliptical cylinder, the dimension La of the minor axis is 40 nm, 50 nm, 60 nm, 70 nm or 80 nm. The minimum repetition period P3 of the plurality of nanostructures 418 along the extension direction of the minor axis is 160 nm, 170 nm, 190 nm, 210 nm or 220 nm. The dimension Lb of the major axis is 540 nm, 550 nm, 560 nm, 570 nm or 580 nm. The height of the nanostructure 418 is 60 nm, 80 nm, 100 nm, 120 nm or 140 nm.

The inventors have conducted an experiment on the light-emitting device 40 including the plurality of nanostructures 418 in the shape of the elliptical cylinder in this example. In addition, in the light-emitting device 40 in this experiment, the refractive index of the first semiconductor layer 421 is set to 2.42, the refractive index of the current spreading layer 424 is set to 2.02, the refractive index of the first dielectric layer 419 is set to 2.02, the wavelength of the light emitted by the light-emitting portion 042 is set to be in a range of 435 nm to 485 nm, and the material of the nanostructures 418 is metal aluminum. The experimental result shows that the phase conversion layer 413 formed by the nanostructures 418 may convert about 67.2% of TE light in the incident light into TM light. It can be seen that the phase conversion layer 413 may effectively improve the light extraction efficiency of the light-emitting device 40.

In addition, the inventors have conducted an experiment on the light-emitting device 40 including the phase conversion layer 413 in this example and the metal wire grid (here, the included angle between the direction where the second side of the nanostructure 418 is located and the first direction X is 45°). The experimental result shows that the light-emitting device 40 emits light of a single-polarization state, and the maximum light extraction efficiency of the light-emitting device 40 can reach about 54%. Compared with the light-emitting device 40 in the related art, in which only the metal wire grid is provided, the light extraction efficiency of the light-emitting device 40 is increased by about 32%.

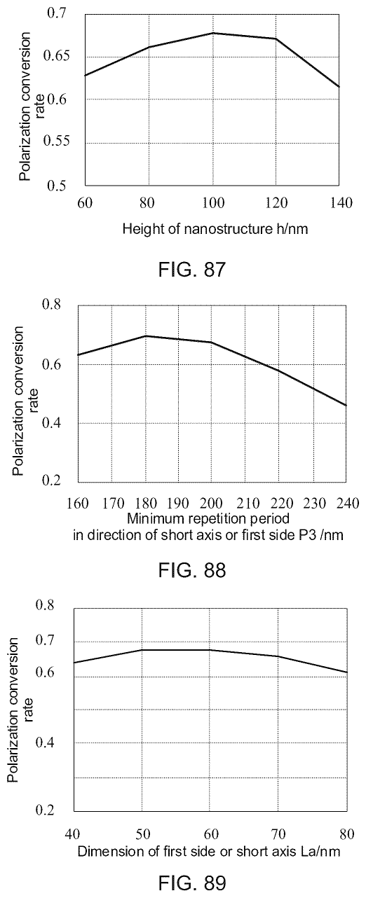

The inventors have also simulated phase conversion layers 413 each formed by nanostructures 418 of a different size in this example, and the polarization conversion rates of the phase conversion layers 413 are obtained through simulation calculation, and are plotted to obtain FIGS. 87 to 90.

As shown in FIG. 87, in a case where the height of the nanostructure 418 is in the range of 60 nm to 140 nm, the polarization conversion rate of the phase conversion layer 413 is greater than 0.62. In a case where the height of the nanostructure 418 is in the range of 80 nm to 120 nm, the polarization conversion rate of the phase conversion layer 413 is greater than 0.67. The polarization conversion rate of the phase conversion layer 413 is relatively high, which is beneficial to improving the light extraction efficiency of the light-emitting device 40.

As shown in FIG. 89, in a case where the dimension of the minor axis of the nanostructure 418 is in the range of 40 nm to 80 nm, the polarization conversion rate of the phase conversion layer 413 is greater than 0.60. In a case where the line width of the nanostructure 418 is in the range of 50 nm to 70 nm, the polarization conversion rate of the phase conversion layer 413 is greater than 0.65. The polarization conversion rate of the phase conversion layer 413 is relatively high, which is beneficial to improving the light extraction efficiency of the light-emitting device 40.

As shown in FIG. 88, in a case where the minimum repetition period of the nanostructures 418 along the extension direction of the minor axis is in the range of 160 nm to 220 nm, the polarization conversion rate of the phase conversion layer 413 is greater than 0.58. In a case where the minimum repetition period of the nanostructures 418 along the extension direction of the minor axis is in the range of 170 nm to 210 nm, the polarization conversion rate of the phase conversion layer 413 is greater than 0.62. The polarization conversion rate of the phase conversion layer 413 is relatively high, which is beneficial to improving the light extraction efficiency of the light-emitting device 40.

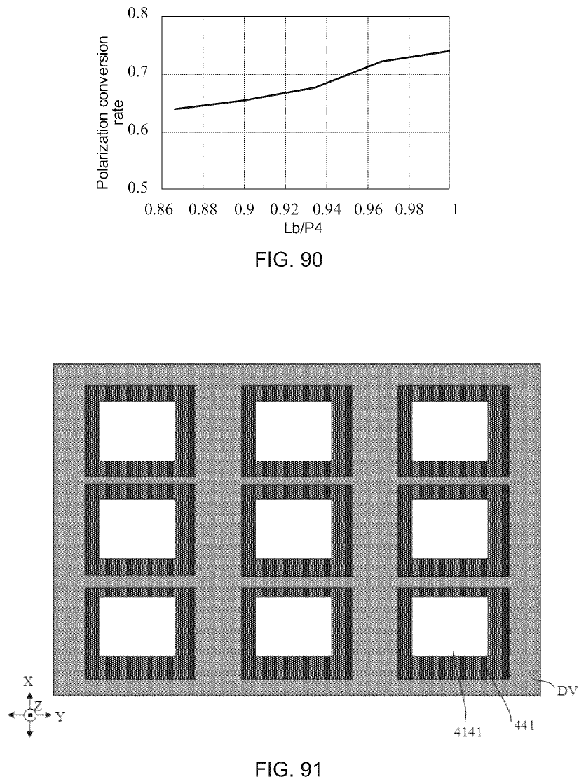

As shown in FIG. 90, in a case where the ratio of the dimension of the major axis of the nanostructure 418 to the minimum repetition period of the plurality of nanostructures 418 along the extension direction of the major axis is in the range of 0.87 to 1.00, the polarization conversion rate of the phase conversion layer 413 is greater than 0.64. In a case where the ratio of the dimension of the major axis to the minimum repetition period of the plurality of nanostructures 418 along the extension direction of the major axis is in the range of 0.92 to 1.00, the polarization conversion rate of the phase conversion layer 413 is greater than 0.67. The polarization conversion rate of the phase conversion layer 413 is relatively high, which is beneficial to improving the light extraction efficiency of the light-emitting device 40.

It can be understood that, in a case where the material of the nanostructure 418 is an inorganic material, the structure of the nanostructure 418 may also be the same as the structure of the nanocolumn structure 414 in the above embodiments. For details, reference may be made to the description of some of the above embodiments.

In some embodiments, as shown in FIGS. 77 and 91, in the case where the light-emitting device 40 includes the isolation portion DV, the light-emitting device 40 further includes a current blocking layer 441 located between the first electrode layer 493 and the phase conversion layer 413. An orthographic projection of the current blocking layer 441 on an extension plane of the isolation portion DV overlaps with the isolation portion DV.

For example, a material of the current blocking layer 441 is silicon dioxide.

For example, the current blocking layer 441 separates the plurality of first electrodes 491. For example, the current blocking layer 441 insulates and separates the plurality of first electrodes 491 to avoid electrical crosstalk between adjacent first electrodes 491.

As shown in FIGS. 77 and 91, the current blocking layer 441 may be of a mesh structure. The current blocking layer 441 includes third openings 4141. A large portion of a first electrode 491 is located in a third opening 4141.

For example, a size of a square of the isolation portion DV is larger than a size of a third opening 4141 of the current blocking layer 441, and borders of an orthographic projection of the third opening 4141 of the current blocking layer 441 on a plane where the light-emitting portion 042 is located are within a region of borders of an orthographic projection of the square of the isolation portion DV on the plane where the light-emitting portion 042 is located. Thus, the size of the third opening 4141 may be relatively small; the size of the portion of the first electrode 491 located in the third opening 4141 is relatively small, and the size is smaller than the size of the island-shaped light-emitting unit 4221 corresponding to the first electrode 491. Therefore, the light emitted by the island-shaped light-emitting unit 4221 is reflected by the first electrode 491 corresponding to the island-shaped light-emitting unit 4221. As a result, it avoids a situation where the first electrode 491 may also reflect the light emitted by the adjacent island-shaped light-emitting unit due to a large size of the portion of the first electrode 491 located in the third opening 4141, thereby avoiding light crosstalk.

For example, an orthographic projection of the first electrode 491 on the plane where the light-emitting portion 042 is located overlaps with the island-shaped light-emitting unit 4221. For example, the orthographic projection of the island-shaped light-emitting unit 4221 on the plane where the light-emitting portion 042 is located is within the orthographic projection of the first electrode 491 on the plane where the light-emitting portion 042 is located.

Thus, the electrical connection between the first electrode 491 and the island-shaped light-emitting unit 4221 may be ensured, and the island-shaped light-emitting unit 4221 may receive the voltage transmitted by the first electrode 491.

In some examples, as shown in FIG. 77, the first electrode 491 includes an overlapping portion 4911, and the overlapping portion 4911 is in contact with a surface of the current blocking layer 441 away from the first light conversion layer 041; and the driving circuit layer 060 is in contact with the overlapping portion 4911. For example, as shown in FIG. 77, the driving circuit layer 060 includes driving signal lines 061, and a driving signal line 061 is in contact with the overlapping portion 4911 to provide the voltage required for the first electrode 491.

Thus, the overlapping portion 4911 may be used to achieve the electrical connection between the first electrode 491 and the driving circuit layer 060.

In some embodiments, as shown in FIG. 77, the light-emitting device 40 further includes a second electrode layer 494.

In some examples, the second electrode layer 494 is located between the light-emitting portion 042 and the second light conversion layer 043; the second electrode layer 494 includes a plurality of first openings 4941, and an orthographic projection of the first opening 4941 on the plane where the light-emitting portion 042 is located overlaps with the light-emitting portion 042.

For example, a flat layer 4942 is disposed between the second electrode layer 494 and the second light conversion layer 043 (or the metal wire grid 43), so that the second light conversion layer 043 may be attached to a relatively flat surface, thereby facilitating the attachment of the second light conversion layer 043.

For example, the orthographic projection of the first opening 4941 on the plane where the light-emitting portion 042 is located may partially overlap with the island-shaped light-emitting unit 4221 in the light-emitting portion 042. A single island-shaped light-emitting unit 4221 may correspond to a single first opening 4941. The orthographic projection of the single island-shaped light-emitting unit 4221 on the plane where the light-emitting portion 042 is located is within the borders of the orthographic projection of the single first opening 4941 on the plane where the light-emitting portion 042 is located.

Thus, the light emitted by the light-emitting portion 042 or the island-shaped light-emitting unit 4221 may exit from the corresponding first opening 4941, thereby preventing the second electrode layer 494 from completely blocking the light emitted by the light-emitting portion 042 or the island-shaped light-emitting unit 4221, and avoiding increasing the light loss of the light-emitting device 40.

In some other examples, the second electrode 492 and the metal wire grid 43 are in the same layer and made of metal. For example, both the second electrode 492 and the metal wire grid 43 are manufactured through a single process. For example, the second electrode 492 is a part of the metal wire grid 43 and plays an optical role of the metal wire grid 43.

In yet some other examples, as shown in FIG. 16, the second electrode layer 494 includes a plurality of first openings 4941. The metal wire grid 43 includes a plurality of sub-wire grids 434 arranged at intervals, and a single sub-wire grid 434 is located in a single first opening 4941; and an orthographic projection of the single sub-wire grid 434 on the plane where the light-emitting portion 042 is located overlaps with the light-emitting portion 042.

For example, the second electrode layer 494 is in a shape of mesh, and the first opening 4941 is a square of the mesh.

For example, the line width of the second electrode 492 in the second electrode layer 494 (here, the width refers to the dimension of the second electrode 492 along the second direction Y in FIG. 16) is greater than the width of each metal pattern in the metal wire grid 43 (e.g., the line width of the metal wire grid mentioned above). In this way, the second electrode layer 494 may serve as a light blocking layer to reduce or prevent light crosstalk between different island-shaped light-emitting units 4221, thereby improving the overall display effect.

For example, the structure of each sub-wire grid 434 is the same as that of the metal wire grid 43, and only the overall size is different. The single sub-wire grid 434 may realize the same function as the metal wire grid 43.

For example, an orthographic projection of a single sub-wire grid 434 on the plane where the light-emitting portion 042 is located partially overlaps with a single island-shaped light-emitting unit 4221 in the light-emitting portion 042. The single sub-wire grid 434 corresponds to the single island-shaped light-emitting unit 4221.

For example, the orthographic projection of the single island-shaped light-emitting unit 4221 on the plane where the light-emitting portion 042 is located is within the orthographic projection of the single sub-wire grid 434 on the plane where the light-emitting portion 042 is located.

With the above arrangement, the overall thickness of the second electrode layer 494 and the metal wire grid 43 may be relatively small, so that the thickness of the light-emitting device 40 may be relatively small, which is beneficial to achieving a design of light weight and small thickness of the backlight module 20, the display substrate 2 and the display apparatus 1.

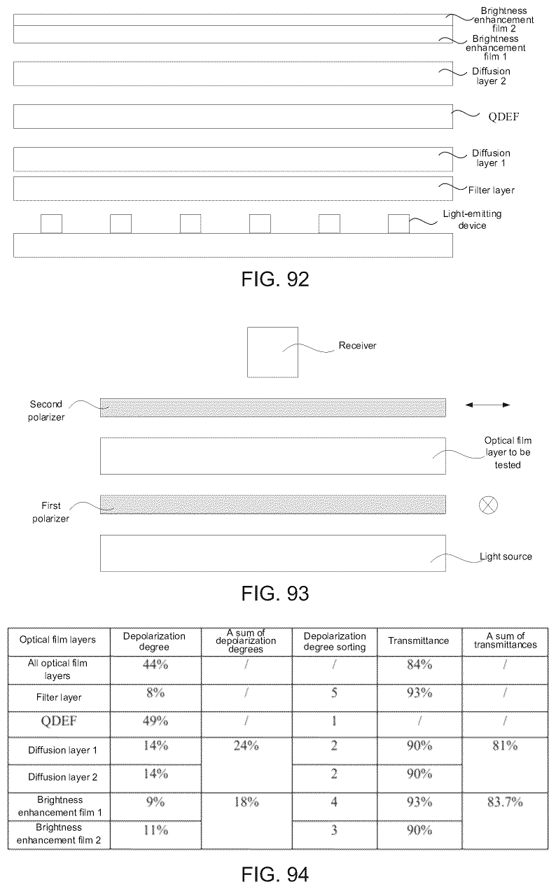

In an implementation, as shown in FIG. 92, the backlight module further includes optical film layers such as a diffusion layer, a quantum dot enhancement film (QDEF), and a filter layer. These optical film layers are doped with a small amount of scattering particles, which have a certain depolarization degree and can depolarize single-polarization light. As a result, in a process of the single-polarization light emitted by the light-emitting device entering the display panel through the diffusion layer, QDEF and other optical film layers, the single-polarization light can be depolarized by the above optical film layers, thereby reducing the polarization degree of the backlight provided by the backlight module.

The depolarization degree of the optical film layer can be obtained through test analysis. For example, as shown in FIG. 93, a light source is provided, and the light source is used to provide natural light. A first polarizer and a second polarizer are respectively provided on both sides of an optical film layer to be tested, and a receiver is provided to detect received light. Transmission axes of the first polarizer and the second polarizer are set perpendicular to each other. The natural light passes through the first polarizer and becomes single-polarization light. Under the depolarization effect of the optical film layer to be tested, the single-polarization light is depolarized, and some of the light passes through the second polarizer and then is received by the receiver. A ratio of intensity of the light received by the receiver to the single-polarization light is calculated, and the depolarization degree of the optical film layer to be tested can be obtained.

Specifically, the depolarization effect and transmittance of each optical film layer are shown in FIG. 94.

It can be seen from FIG. 94 that, QDEF can depolarize almost all single-polarization light and convert the single-polarization light into natural light. Therefore, in a backlight module that provides the single-polarization backlight, it is not necessary to use film layer(s) with a high depolarization degree similar to QDEF. A sum of the depolarization degrees of the diffusion layer 1 and diffusion layer 2 is approximately 24%. That is, after the single-polarization light passes through the two diffusion layers, about half of the light is depolarized into natural light. Thus, in the backlight module that provides the single-polarization backlight, it is best not to provide a diffusion layer. A sum of the depolarization degrees of two brightness enhancement films is 18%. Therefore, in the backlight module that provides the single-polarization backlight, the arrangement of the above optical film layers will reduce the polarization degree of the backlight provided by the backlight module.

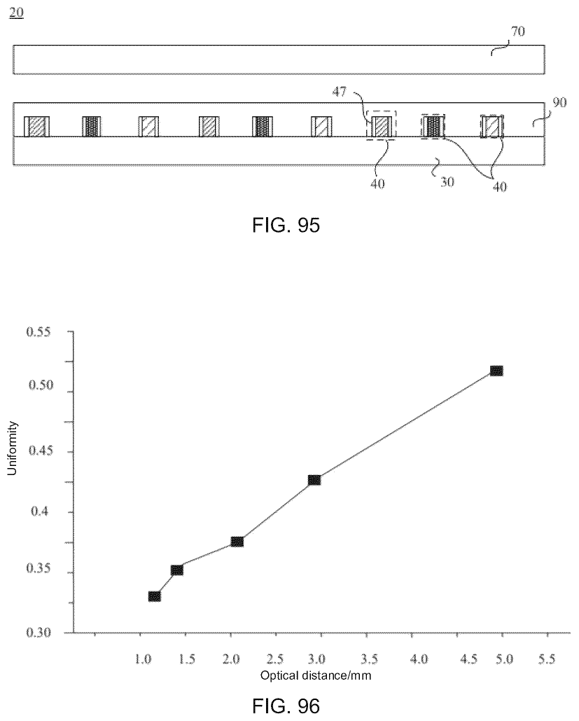

As shown in FIG. 95, the backlight module 20 provided in some of the above embodiments of the present disclosure further includes at least one uniform-light layer 70 located on the plurality of light-emitting devices 40.

For example, the plurality of light-emitting devices 40 includes red light-emitting devices, blue light-emitting devices, and green light-emitting devices.

For example, at least one red light-emitting device, at least one blue light-emitting device and at least one green light-emitting device constitute a light-emitting device group.

For example, light-emitting devices in the light-emitting device group are arranged in a triangular, square or hexagonal arrangement, so that the red light, green light and blue light emitted by the light-emitting device group can be mixed with each other to present white light.

For example, since an epitaxial structure that emits red light has a low electro-optical conversion efficiency and a high cost, the red light-emitting device can be formed by providing a color conversion layer on an epitaxial structure that emits green or blue light. The color conversion layer converts the blue or green light emitted by the epitaxial structure into the red light, thereby reducing the cost of red light-emitting device.

For example, the uniform-light layer 70 can improve the uniformity of light exiting from the backlight module 20.

It can be understood that, in a case where an arrangement density of the plurality of light-emitting devices is constant, a uniformity of the light exiting from the backlight module 20 is positively correlated with an optical distance (the optical distance here is a distance between the uniform-light layer 70 and the substrate 30). The greater the optical distance, the higher the uniformity of light exiting from the backlight module. Without considering the thickness of the backlight module, the optical distance may be used to control the uniformity of light exiting from the backlight module. Air is in the area within the optical distance, which will not affect the polarization degree of the incident light.

The inventors have simulated light uniformities at different optical distances of backlight modules, which are plotted to obtain FIG. 96.

It can be seen from FIG. 96 that, as the optical distance continues to increase, the uniformity of light exiting from the backlight module continues to increase.

For example, the uniform-light layer 70 has a low depolarization degree and has a weak depolarization effect on light, so that the uniform-light layer 70 only depolarizes a small amount of single-polarization light (e.g., TM light) emitted by the light-emitting device, thereby avoiding a significant decrease in the polarization degree of the backlight provided by the backlight module.

For example, the backlight module 20 includes a plurality of uniform-light layers 70. As a result, the plurality of uniform-light layers 70 may be used to uniformize light, so that the optical distance may be reduced and the thickness of the backlight module may be reduced, which is conducive to the design of light weight and small thickness of the backlight module and display apparatus.

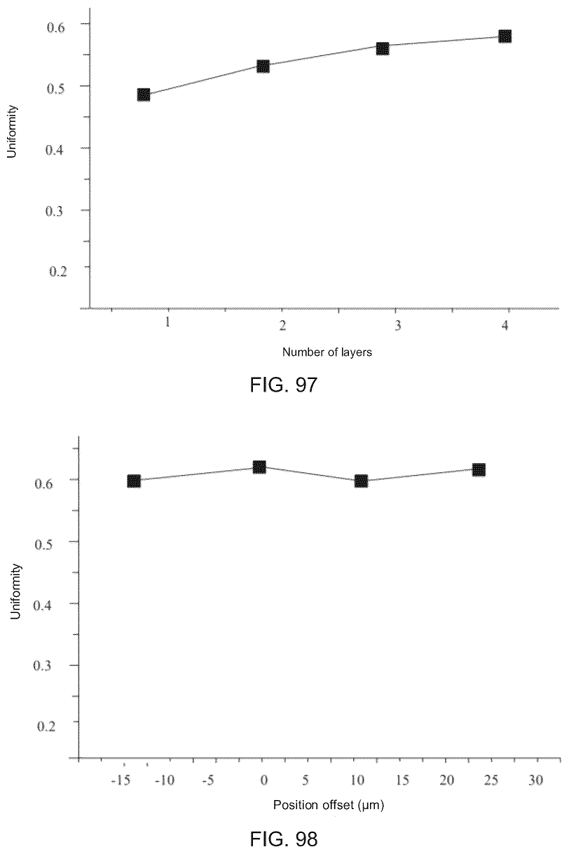

In addition, the inventors have simulated situations where backlight modules each include a different number of uniform-light layers, and uniformities of light exiting from the backlight modules are obtained and plotted to obtain FIGS. 97 to 99.

It can be seen from FIG. 97 that, as the number of uniform-light layers increases, the uniformity of light exiting from the backlight module increases to a certain extent.

FIG. 98 shows a case of two uniform-light layers, and the abscissa is a positional offset between the two uniform-light layers. It can be seen that the positional offset between the uniform-light layers has little impact on the uniformity of the light exiting from the backlight module.

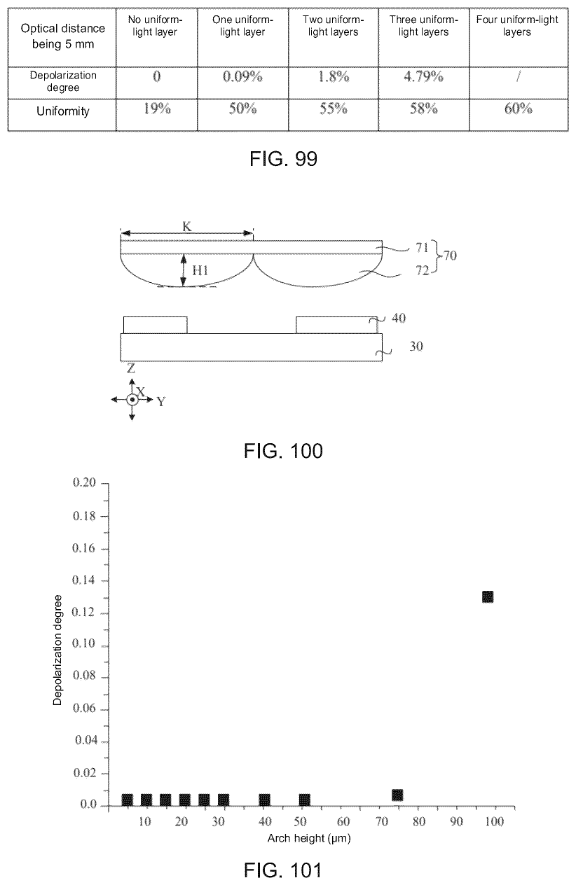

It can be seen from FIG. 99 that, as the number of stacked uniform-light layers increases, the propagation path of light changes multiple times in a process of the light transmission between uniform-light layers, resulting in a certain increase in the depolarization degree of the light by the uniform-light layers. As the number of stacked uniform-light layers increases, the uniformity of the light exiting from the backlight module gradually increases.

In some embodiments, as shown in FIG. 100, the uniform-light layer 70 includes a body 71 and a plurality of transparent micro-structures 72.

For example, the plurality of transparent micro-structures 72 are located on the body 71. Each transparent micro-structure 72 extends in the first direction X, and the plurality of transparent micro-structures 72 are arranged in the second direction Y.

For example, the plurality of transparent micro-structures 72 have the same shape, and distances between the plurality of transparent micro-structures 72 are equal.

For example, light incident on the plurality of transparent micro-structures 72 can pass through the plurality of transparent micro-structures 72 and then exit. The transparent micro-structures 72 are configured to homogenize light emitted by the light-emitting devices 40, and/or to collimate the light emitted by the light-emitting devices 40.

For example, the transparent micro-structures 72 are configured to homogenize the light emitted by the light-emitting devices 40. The uniform-light layer may control transmission paths of the light emitted by the light-emitting devices, thereby achieving uniform processing of the light emitted by the light-emitting devices 40.

For example, the transparent micro-structures 72 are configured to collimate the light emitted by the light-emitting devices 40.

For example, in the light emitted by the light-emitting devices 40 and incident on the transparent micro-structures 72, the transparent micro-structures 72 can converge large-angle light into small-angle light, so that the intensity of the small-angle light increases to a certain extent, thereby achieving the collimation processing of light.

In some embodiments, as shown in FIG. 100, a surface of the transparent micro-structure 72 proximate to the plurality of light-emitting devices 40 is in a shape of an arch.

For example, the light emitted by the light-emitting device 40 is incident on the arched surface, and the exiting direction of the light is changed at the arched surface; and therefore, the exiting direction of the light is close to the normal direction of the backlight module. Thus, the intensity of the light with the direction close to the normal direction is enhanced, the uniformity of the light exiting from the backlight module is improved, and part of the light exits in a nearly collimated manner.

In some embodiments, as shown in FIG. 100, a ratio of height H1 of the arch to aperture K of the arch is less than or equal to 1.5.

For example, the ratio of height H1 of the arch to aperture K of the arch is 1.5, 1.4, 1.3, 1.2 or 1.1.

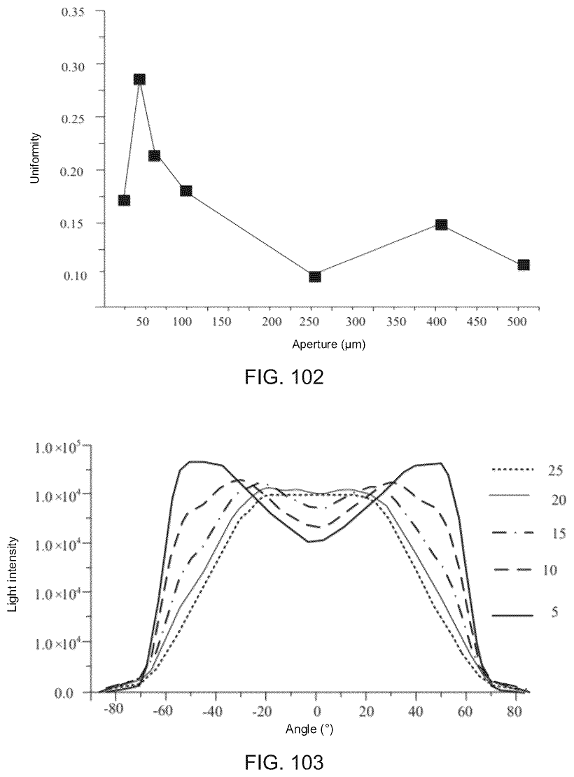

The inventors have simulated different heights and different apertures of arches of transparent micro-structures 72, and depolarization degrees and uniformities of the transparent micro-structures 72 for light are obtained, and plotted to obtain FIGS. 101 and 102.

It can be seen from FIGS. 101 and 102 that, in a case where the height of the arch is less than or equal to 75 μm, the depolarization degree of the uniform-light layer is relatively low; and in a case where the aperture of the arch is about 50 μm, the uniformity of the backlight module is the largest after the uniform-light layer uniformizes the light emitted by the plurality of light-emitting devices. Therefore, in a case where the aperture is about 50 μm, and the ratio of the arch height to the aperture is less than or equal to 1.5, the depolarization degree is less than 1%, and the uniform-light layer has a good light uniformity.

Therefore, by setting the ratio of the height to the aperture of the arch to be less than or equal to 1.5, the depolarization degree of the uniform-light layer may be relatively low, and the uniformity of the light exiting from the backlight module may be relatively high. Thus, the uniformity of the backlight provided by the backlight module may be improved, and the single-polarization light emitted by the light-emitting device is almost not depolarized by the uniform-light layer.

The inventors have simulated uniform-light layers with different apertures and arch heights, and depolarization degrees and light uniformities of the uniform-light layers are obtained. Specifically, in a case where the aperture of the arch of a micro-lens is 8 μm and the arch height of the arch of the micro-lens is in a range of 4 μm to 5 μm, the depolarization degree of the uniform-light layer is 0.3%, and the nine-point uniformity of the brightness of the exiting light is 61%. In a case where the aperture of the arch of the micro-lens is 32 μm and the arch height of the arch of the micro-lens is in a range of 8 μm to 9 μm, the depolarization degree of the uniform-light layer is 0.4%, and the nine-point uniformity of the brightness of the exiting light is 81%.

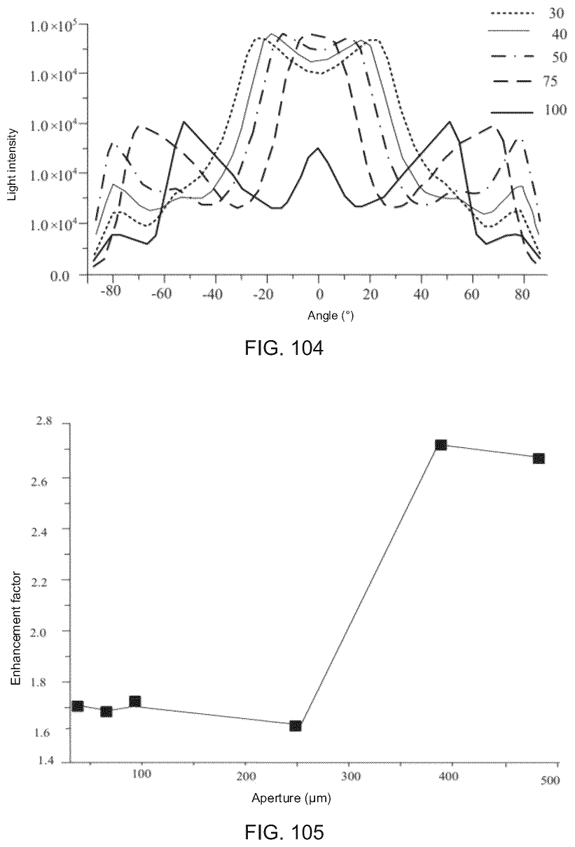

The inventors have also simulated transparent micro-structures with different arch heights in uniform-light layers (the apertures of the transparent micro-structures are all 50 μm), and the collimating effects of the uniform-light layers on light are obtained, and plotted to obtain FIGS. 103 to 104.

In FIGS. 103 and 104, 5, 10, . . . , 100 indicate that the arch heights of the transparent micro-structures are 5 μm, 10 μm, . . . , 100 μm, respectively. It can be seen from FIGS. 103 and 104 that, the transparent micro-structures with different arch heights have different collimating effects or convergence abilities on light. In the case where the ratio of the arch height to the aperture is 1.5 (that is, the aperture of the transparent micro-structure is 50 μm, and the arch height of the transparent micro-structure is 75 μm), the half-peak width of the convergence angles of the transparent micro-structure for light is in a range of ±20°, and the convergence ability is strong.

Therefore, by setting the ratio of the arch height to the aperture of the transparent micro-structure to be less than or equal to 1.5, the collimating effect of the uniform-light layer may be enhanced.

It can be understood that, the transparent micro-structure converges light from a large angle to a small angle, so that the intensity of light in the small angle range has a gain effect. This gain effect can be represented by using the enhancement factor (EF). The enhancement factor refers to a ratio of the brightness within the front viewing angle with the uniform-light layer (the front viewing angle here means that an angle between the exiting light and the normal line of the backlight module is approximately 0°) to the brightness within the front viewing angle without the uniform-light layer.

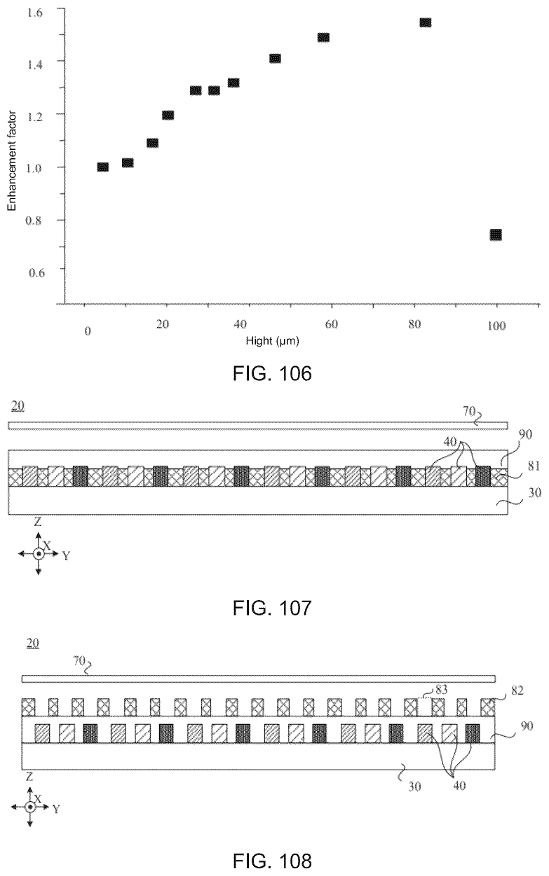

In an example where multiple light-emitting devices in a backlight module are arranged in a square, the inventors have simulated transparent micro-structures with different apertures and arch heights, and corresponding enhancement factors are obtained, and plotted to obtain FIGS. 105 and 106.

It can be seen from FIG. 105 that, in a case where the apertures of the transparent micro-structures are less than 300 μm, the enhancement factors of the transparent micro-structures are all about 1.6. In a case where apertures of transparent micro-structures (e.g., micro-lenses) correspond to arrangement positions of the multiple light-emitting devices, the light-emitting device is equivalent to being placed at the focus of the micro-lens, the enhancement factor of the transparent micro-structure is the largest, and the convergence ability of the uniform-light layer is enhanced.

It can be seen from FIG. 106 that, in a case where the arch height of the transparent micro-structure is less than 80 μm, the enhancement factor is relatively large. Therefore, by setting the aperture of the transparent micro-structure to 50 μm, and the ratio of the arch height to the aperture of the transparent micro-structure to be less than or equal to 1.5, the enhancement factor is large, reaching 1.6, which may make the uniform-light layer have a strong collimating effect on light, and have a good light uniformity.

In some embodiments, as shown in FIG. 107, the backlight module 20 further includes a first barrier layer 81 and an encapsulation layer 90.

For example, the first barrier layer 81 and the encapsulation layer 90 are both located between the light-emitting devices 40 and the uniform-light layer 70.

For example, the first barrier layer 81 is located on the substrate 30.

In some examples, the first barrier layer 81 is located between two adjacent light-emitting devices 40 and is in contact with side surfaces of the light-emitting devices 40. The first barrier layer 81 is configured to absorb light incident on the first barrier layer 81 from the side surfaces of the light-emitting devices 40.

For example, the first barrier layer 81 is made of a black shading material.

It can be understood that, the light-emitting devices 40 with different filling patterns in FIG. 107 represent light-emitting devices 40 that emit light of different colors. As can be seen from the above, the light emitted from the side surface of the light-emitting device 40 is generally non-single-polarization light. With the above arrangement, the first barrier layer 81 may be used to absorb the light emitted from the side surface of the light-emitting device 40, thereby increasing the polarization degree of the backlight provided by the backlight module and preventing the light emitted from the side surface of the light-emitting device 40 from exiting from the backlight module, and in turn, avoiding the influence of this part of light on the polarization degree of the backlight provided by the backlight module. In addition, the above arrangement may also reduce the crosstalk between the light emitted by adjacent light-emitting devices 40 and improve the display effect of the display apparatus.

In some examples, the encapsulation layer 90 covers the plurality of light-emitting devices 40 and the first barrier layer 81.

With the above arrangement, the encapsulation layer 90 is used to isolate the light-emitting devices 40 and the first barrier layer 81 from the outside, and protect the light-emitting devices 40 and the first barrier layer 81 to prevent external water and oxygen from entering the light-emitting devices 40 or the first barrier layer 81 and to avoid affecting the lifetime of the light-emitting devices 40 and the absorption effect of the first barrier layer 81. In addition, the encapsulation layer 90 may also optimize the distribution of light emitted by the light-emitting devices 40 and improve the light extraction efficiency of the light-emitting devices 40.

For example, the encapsulation layer 90 is made of a highly transparent material. For example, the material of the encapsulation layer 90 is OCA. OCA has a transmittance of 98% in a case where the wavelength of the incident light is 450 nm. Thus, it may be possible to prevent the encapsulation layer 90 from absorbing the light emitted by the light-emitting devices 40, thereby reducing the light loss of the backlight module.

For example, an average thickness of the encapsulation layer 90 is in a range of tens to hundreds of microns.

For example, the average thickness of the encapsulation layer 90 is in a range of 200 μm to 300 μm, inclusive.

In some other embodiments, as shown in FIG. 108, the backlight module 20 further includes an encapsulation layer 90 and a second barrier layer 82.

For example, the second barrier layer 82 and the encapsulation layer 90 are both located between the light-emitting devices 40 and the uniform-light layer 70.

For example, the encapsulation layer 90 is located on the substrate 30 and covers the plurality of light-emitting devices 40.

With the above arrangement, the encapsulation layer 90 is used to isolate the light-emitting devices 40 from the outside, and protect the light-emitting devices 40 to prevent external water and oxygen from entering the light-emitting devices 40, thereby avoiding affecting the lifetime of the light-emitting devices 40.

For example, the second barrier layer 82 is located on a side of the encapsulation layer 90 away from the plurality of light-emitting devices 40.

For example, the second barrier layer 82 includes a plurality of openings 83, and a single opening 83 is directly opposite to a single light-emitting device 40. The second barrier layer 82 is configured to absorb or reflect light incident on the second barrier layer 82 from the light-emitting device 40.

For example, the light emitted from the main light-exit surface of the light-emitting device 40 exits from the corresponding opening in the second barrier layer 82 after passing through the encapsulation layer 90, while the light emitted from the side surface of the light-emitting device 40 directs to the second barrier layer 82 after passing through the encapsulation layer 90 and then is absorbed or reflected by the second barrier layer 82. Thus, the polarization degree, contrast, and light extraction efficiency of the backlight provided by the backlight module 20 are improved, and the light emitted from the side surface of the light-emitting device 40 is prevented from exiting from the uniform-light layer without passing through the metal wire grid 43, thereby avoiding reducing the polarization degree of the backlight provided by the backlight module 20. In addition, the above arrangement may also avoid crosstalk between the light emitted by adjacent light-emitting devices 40 and improve the display effect of the display apparatus.

It can be understood that, the display module provided in the embodiments of the present disclosure further includes a substrate, and the light-emitting devices are located on the substrate.

The light emission conditions of the backlight module provided in the embodiments of the present disclosure will be described below.

For a backlight module that does not include the first light conversion layer, only TM light in light emitted from the light-emitting device exits, and the light utilization rate of the light-emitting device is only 50%.

In the embodiments of the present disclosure, the backlight module includes the first light conversion layer; in the light emitted by the epitaxial structure, TM light passes through the metal wire grid and then exits, and TE light is reflected from the metal wire grid to the first light conversion layer and then is incident on the metal wire grid again after its traveling direction and polarization direction are changed by the first light conversion layer. During this process, the reflectivity of the TE light on the metal wire grid is about 90%, and the reflectivity of the TE light on the first light conversion layer is about 90%; the TE light passes through the epitaxial structure and buffer layer twice, and the transmittance of the TE light in these film layers is 80%; and the proportion of the TE light in the light emitted by the epitaxial structure is 50%. Therefore, in the embodiments of the present disclosure, the light utilization rate of the backlight module is 75.9% (specifically calculated as 50%+90%×2×80%×2). Compared with the backlight module without the first light conversion layer, the brightness of the backlight provided by the backlight module including the first light conversion layer may be increased by 51.8% (specifically, (75.9%-50%)/50%=51.8%).

In some embodiments, the display apparatus further includes a polarizer located between the backlight module and the display panel. The polarizer can filter the light emitted from the light-exit side of the backlight module, and thus the display panel can receive light with a high polarization degree (e.g., the polarization degree greater than or equal to 0.99994), thereby achieving more than 20% of the light efficiency gain of the backlight module, and reducing the power consumption of the display apparatus by about 20%.

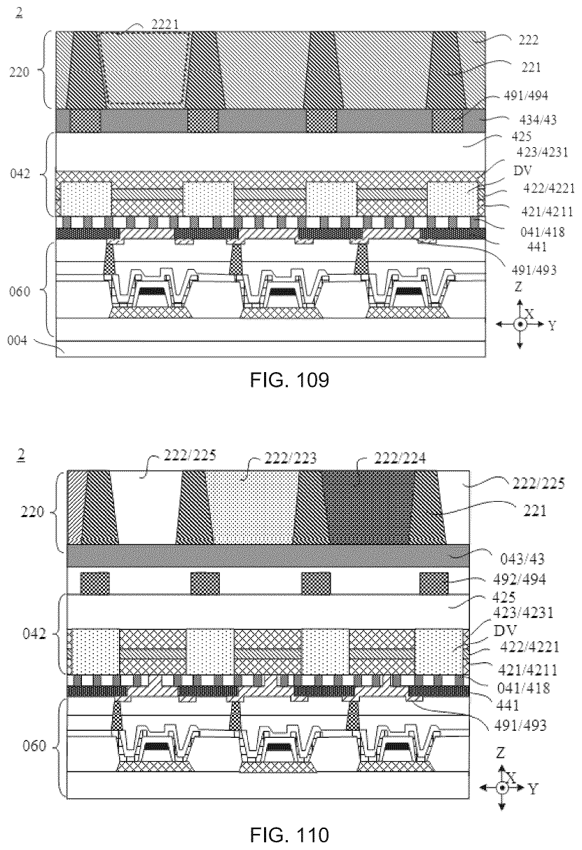

Some embodiments of the present disclosure provide a display substrate 2. As shown in FIG. 109, the display substrate 2 includes a substrate 004, the plurality of light-emitting devices 40 that are located on a side of the substrate 004 and are described in any of the above embodiments, and a color conversion layer 220.

The light emitted by the light-emitting devices 40 is monochromatic light, such as blue light or ultraviolet light.

The color conversion layer 220 is located on a side of the light-emitting devices 40 away from the substrate 004.

The color conversion layer 220 is used to convert the color of the monochromatic light emitted by the light-emitting device 40. As a result, light of multiple colors is formed after the light emitted by the plurality of light-emitting devices 40 passes through the color conversion layer 220. The light of multiple colors cooperates with each other to make the display substrate 2 display images. Furthermore, since the light-emitting device 40 provided in the embodiments of the present disclosure has a high light extraction efficiency, the display substrate 2 may have a high display brightness. In addition, since the light-emitting device 40 provided in the embodiments of the present disclosure has the island-shaped light-emitting unit 4221 with a small area, the display substrate 2 has a high contrast and resolution.

In some examples, as shown in FIGS. 109 and 110, the color conversion layer 220 includes a dam layer 221 and a plurality of color conversion portions 222.

The dam layer 221 has a plurality of second openings 2221. The plurality of color conversion portions 222 correspond to the plurality of second openings 2221, and a single color conversion portion 222 is located in a single second opening 2221.

As shown in FIG. 110, the plurality of color conversion portions 222 include first color conversion portions 223, second color conversion portions 224, and third color conversion portions 225, which are respectively located in different second openings 2221. The first color conversion portion 223 converts light into red light, the second color conversion portion 224 converts light into green light, and the third color conversion portion 225 maintains light or converts the light into blue light.

For example, in a case where the light emitted by the light-emitting device 40 is ultraviolet light, the third color conversion portion 225 converts the light emitted by the light-emitting device 40 into blue light. In a case where the light emitted by the light-emitting device 40 is blue light, the third color conversion portion 225 maintains the light emitted by the light-emitting device 40 as the blue light.

Thus, when the light emitted by the plurality of light-emitting devices 40 is incident on the first color conversion portions 223, second color conversion portions 224, and third color conversion portions 225 respectively, the light emitted by the plurality of light-emitting devices 40 is converted into red light, green light, and blue light, so that the display substrate 2 displays images.

For example, the dam layer 221 is made of a resin material. The dam layer 221 has a light shielding effect to absorb light incident on the dam layer 221, avoiding color crosstalk between light of different colors exiting from the color conversion layer 220.

For example, a single color conversion portion 222 is at least partially opposite to a single island-shaped light-emitting unit 4221. For example, the orthographic projection of the island-shaped light-emitting unit 4221 on the plane where the light-emitting portion 042 is located is within the orthographic projection of the color conversion portion 222 on the plane where the light-emitting portion 042 is located. Thus, the proportion of light, emitted by the light-emitting device 40, converted by the color conversion portion 222 may be increased, the light extraction efficiency of the light-emitting device 40 may be improved, and the display brightness of the display substrate 2 may be improved.

For example, a material of the color conversion portion 222 is an adhesive material. For example, the material of the first color conversion portion 223 is an adhesive material added with a red quantum dot conversion material, the material of the second color conversion portion 224 is an adhesive material added with a green quantum dot conversion material, and the material of the third color conversion portion 225 is an adhesive material without a quantum dot conversion material.

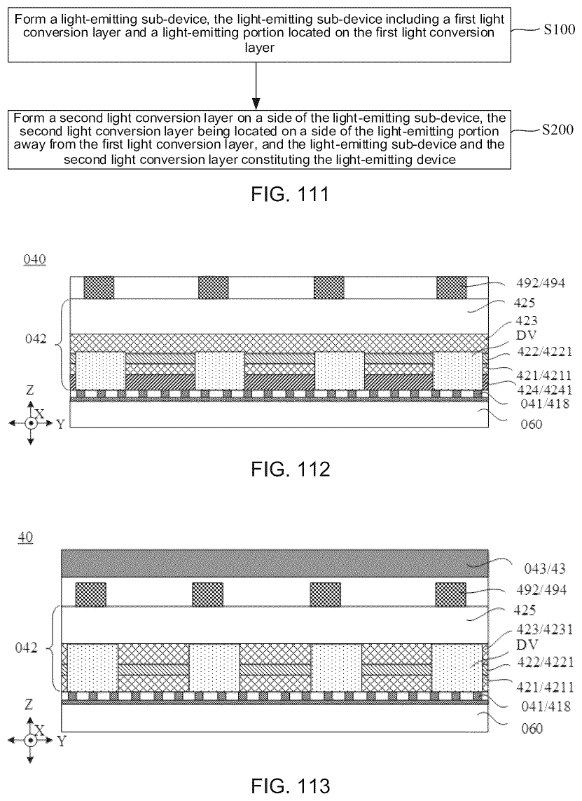

Some embodiments of the present disclosure further provide a manufacturing method for a light-emitting device, and the manufacturing method is used to manufacture the light-emitting device 40 described in any of the above embodiments. As shown in FIG. 111, the manufacturing method includes S100 and S200.

In S100, as shown in FIG. 112, a light-emitting sub-device 040 is formed, and the light-emitting sub-device 040 includes a first light conversion layer 041 and a light-emitting portion 042 located on the first light conversion layer 041.

For example, light emitted by the light-emitting portion 042 is monochromatic light. For example, the light-emitting portion 042 emits blue light, red light, green light, ultraviolet light, or white light.

For the description of the light-emitting portion 042 and the first light conversion layer 041, reference may be made to the description in some embodiments of the present disclosure described above, which will not be repeated here.

In S200, as shown in FIG. 113, a second light conversion layer 043 is formed on a side of the light-emitting sub-device 040; the second light conversion layer 043 is located on a side of the light-emitting portion 042 away from the first light conversion layer 041, and the light-emitting sub-device 040 and the second light conversion layer 043 constitute the light-emitting device 40.

For example, the second light conversion layer 043 is provided, an adhesive is coated on the light-emitting sub-device 040, and then the second light conversion layer 043 is adhered to the light-emitting sub-device 040.

For another example, the second light conversion layer 043 may also be directly formed on the light-emitting sub-device 040.

For example, the second light conversion layer 043 is a metal wire grid. For the description of the metal wire grid, reference may be made to the description in some embodiments of the present disclosure described above, which will not be repeated here.

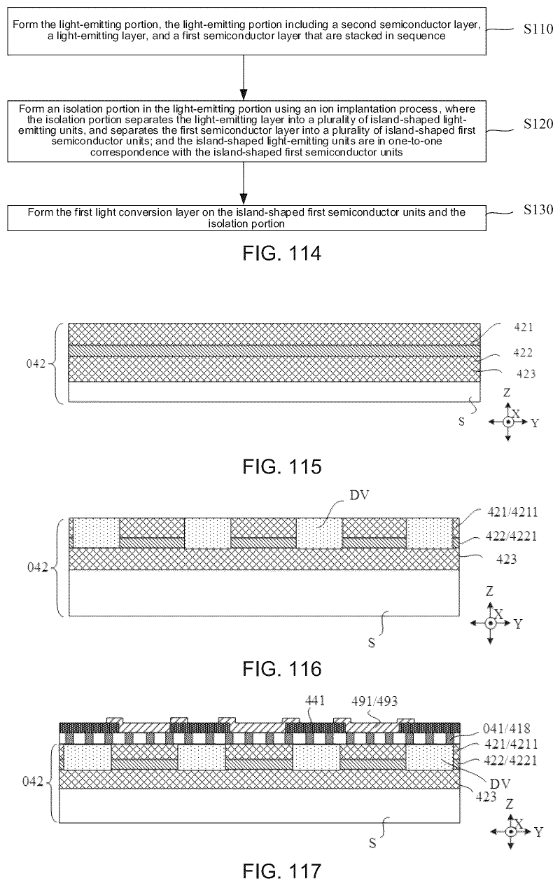

In some examples, as shown in FIG. 114, forming the light-emitting sub-device in S100 includes S110 to S130.

In S110, as shown in FIG. 115, the light-emitting portion 042 is formed, and the light-emitting portion 042 includes a second semiconductor layer 423, a light-emitting layer 422, and a first semiconductor layer 421 that are stacked in sequence.

In an example where the light-emitting portion 042 is an epitaxial structure, forming the light-emitting portion 042 may include: providing a base S, and growing the epitaxial structure on the base S.

For example, a material of the base S may be silicon.

For the description of the light-emitting portion 042, reference may be made to the description in some embodiments of the present disclosure described above, which will not be repeated here.

In S120, as shown in FIG. 116, an isolation portion DV is formed in the light-emitting portion 042 using an ion implantation process; the isolation portion DV separates the light-emitting layer 422 into a plurality of island-shaped light-emitting units 4221, and separates the first semiconductor layer 421 into a plurality of island-shaped first semiconductor units 4211; and the island-shaped light-emitting units 4221 are in one-to-one correspondence with the island-shaped first semiconductor units 4211.

For example, by using the ion implantation process, arsenic ions or argon ions are implanted into a corresponding region of the light-emitting portion 042 on a surface of the first semiconductor layer 421 away from the light-emitting layer 422 to form the isolation portion DV. The implanted ions make the resistance of the isolation portion DV relatively large, so that adjacent island-shaped first semiconductor units 4211 may be isolated from each other, and adjacent island-shaped light-emitting units 4221 may be isolated from each other.

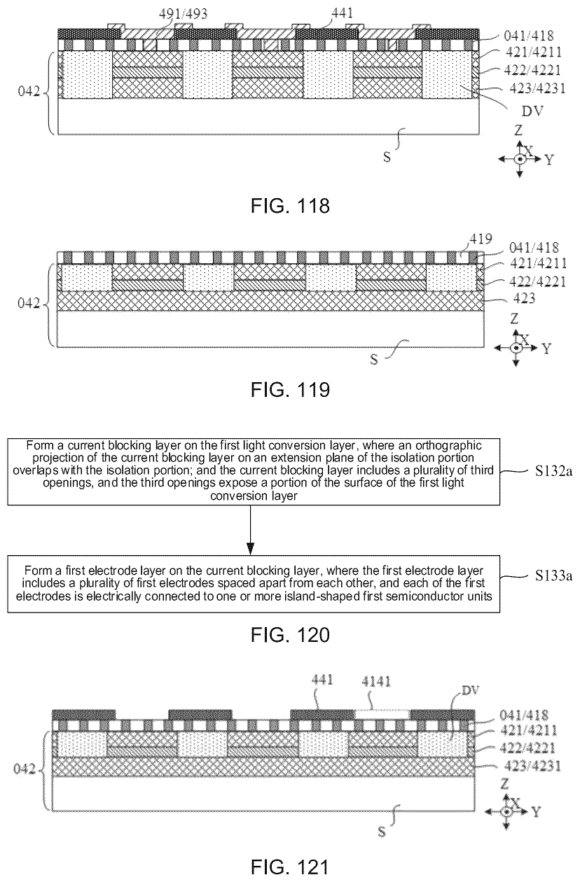

In the above ion implantation process, the ions may also be implanted into the second semiconductor layer 423 to separate the second semiconductor layer 423 into a plurality of island-shaped second semiconductor units 4213 (see FIGS. 14 and 118). The island-shaped second semiconductor units 4213, the island-shaped light-emitting units 4221, and the island-shaped first semiconductor units 4211 are in one-to-one correspondence.

In a case where the light-emitting portion 042 includes a current spreading layer 424, the ions may also be implanted into the current spreading layer 424 to separate the current spreading layer 424 into a plurality of island-shaped current spreading portions 4241 (see FIG. 15).

A surface of the isolation portion DV away from the base S is flush with surfaces of the island-shaped first semiconductor units 4211 away from the base S.

In S130, as shown in FIGS. 117 and 118, the first light conversion layer 041 is formed on the island-shaped first semiconductor units 4211 and the isolation portion DV.

By using the above manufacturing method, the manufacturing process of the light-emitting device is simple, and each light-emitting device 40 can include the plurality of island-shaped light-emitting units 4221 arranged at intervals, which is beneficial to achieving the individual control of the light-emitting function of each island-shaped light-emitting unit 4221. Thus, in a case where the light-emitting device 40 is applied to the display substrate 2 and the display apparatus 1, the pixel density of the display substrate 2 and the display apparatus 1 may be improved.

In some examples, forming the first light conversion layer 041 on the island-shaped first semiconductor units 4211 and the isolation portion DV in S130 includes S131.

In S131, as shown in FIG. 119, a plurality of nanostructures 418 are formed on the island-shaped first semiconductor units 4211 and the isolation portion DV, and a first dielectric layer 419 is formed between adjacent nanostructures 418.

For example, the nanostructures 418 are made of a conductive material such as metal aluminum or metal silver. For example, a sputtering process may be used to form a nano-film on the island-shaped first semiconductor units 4211 and the isolation portion DV. Then, the nano-film is patterned to obtain the nanostructures 418. The patterning process may be a nano-imprinting process or an ion beam etching process.

For example, the nanostructures 418 are made of an inorganic material. For example, the inorganic material is silicon nitride. For example, a deposition process is used to form a nano-film on the island-shaped first semiconductor units 4211 and the isolation portion DV. Then, the nano-film is patterned to obtain the nanostructures 418. The patterning process may be a nano-imprinting process or an ion beam etching process.

For example, the first dielectric layer 419 is formed by using a spin-coating process.

For example, in the case where the material of the nanostructures 418 is the conductive material, as shown in FIG. 120, after the first light conversion layer 041 is formed, forming the light-emitting sub-device 040 in S100 further includes S132a and S133a.

In S132a, as shown in FIG. 121, a current blocking layer 441 is formed on the first light conversion layer 041; an orthographic projection of the current blocking layer 441 on an extension plane of the isolation portion DV overlaps with the isolation portion DV; and the current blocking layer 441 includes a plurality of third openings 4141, and the third openings 4141 expose a portion of the surface of the first light conversion layer 041.

For example, a deposition process is used to form a current blocking film on the first light conversion layer 041, and then an etching process is used to etch a portion of the current blocking film corresponding to each island-shaped light-emitting unit 4221 to form the third openings 4141 and the current blocking layer 441.

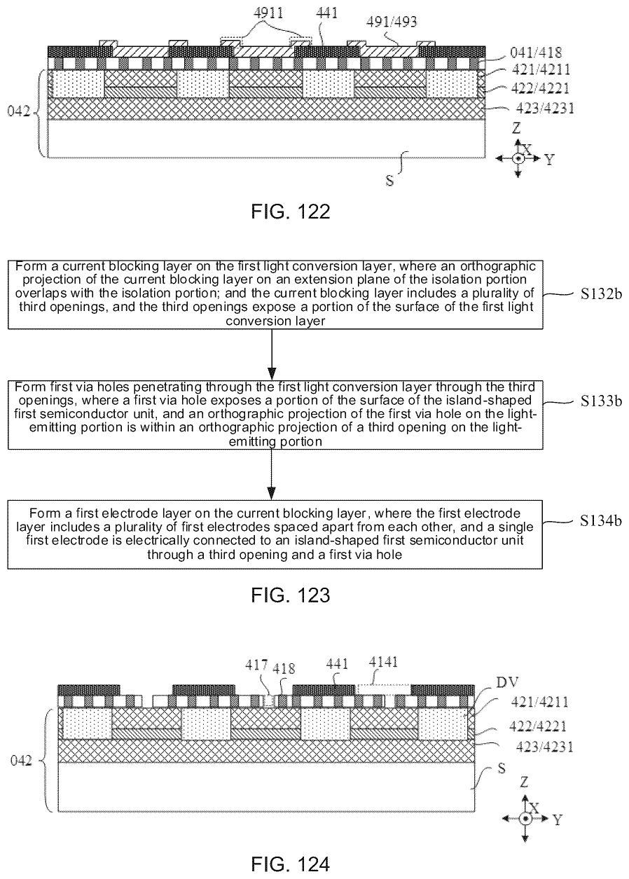

In S133a, as shown in FIG. 122, a first electrode layer 493 is formed on the current blocking layer 441; and the first electrode layer 493 includes a plurality of first electrodes 491 spaced apart from each other, and each of the first electrodes 121 is electrically connected to one or more island-shaped first semiconductor units 4211.

For example, a sputtering process is used to form a first electrode film, the first electrode film covers the current blocking layer 441 and the first light conversion layer 041, and the first electrode film is etched to remove a portion of the first electrode film corresponding to the current blocking layer 441, so as to form the plurality of first electrodes 491. The first electrode layer 493 exposes a portion of the surface of the current blocking layer 441 away from the light-emitting portion 042.

For example, as shown in FIGS. 121 and 122, in a case where a single first electrode 491 is electrically connected to a single island-shaped first semiconductor unit 4211, an overlapping portion 4911 of the single first electrode 491 is in contact with the current blocking layer 441, and a portion of the first electrode 491 other than the overlapping portion 4911 is located within a third opening 4141 of the current blocking layer 441.

In the case where the material of the nanostructures 418 is the inorganic material, as shown in FIG. 123, forming the light-emitting sub-device 040 further includes S132b to S134b.

In S132b, as shown in FIG. 121, a current blocking layer 441 is formed on the first light conversion layer 041; an orthographic projection of the current blocking layer 441 on an extension plane of the isolation portion DV overlaps with the isolation portion DV; and the current blocking layer 441 includes a plurality of third openings 4141, and the third openings 4141 expose a portion of the surface of the first light conversion layer 041.

For the process of forming the current blocking layer 441, reference may be made to the above description in S132a, which will not be repeated here.

In S133b, as shown in FIG. 124, first via holes 417 penetrating through the first light conversion layer 041 are formed through the third openings 4141, a first via hole 417 exposes a portion of the surface of the island-shaped first semiconductor unit 4211, and an orthographic projection of the first via hole 417 on the light-emitting portion 042 is within an orthographic projection of a third opening 4141 on the light-emitting portion 042.

For example, a first via hole 417 is formed on a portion of the surface of the first light conversion layer 041 exposed by a third opening 4141 through the third opening 4141. Each first via hole 417 corresponds to one third opening 4141. For example, the first via hole 417 is directly opposite to the third opening 414, and an area of the orthographic projection of the first via hole 417 on the light-emitting portion 042 is smaller than an area of the orthographic projection of the third opening 4141 on the light-emitting portion 042.

For example, the portion of the first light conversion layer 041 exposed by the third opening 4141 is patterned, for example, by using exposure, development and etching processes, to form the first via hole 417.

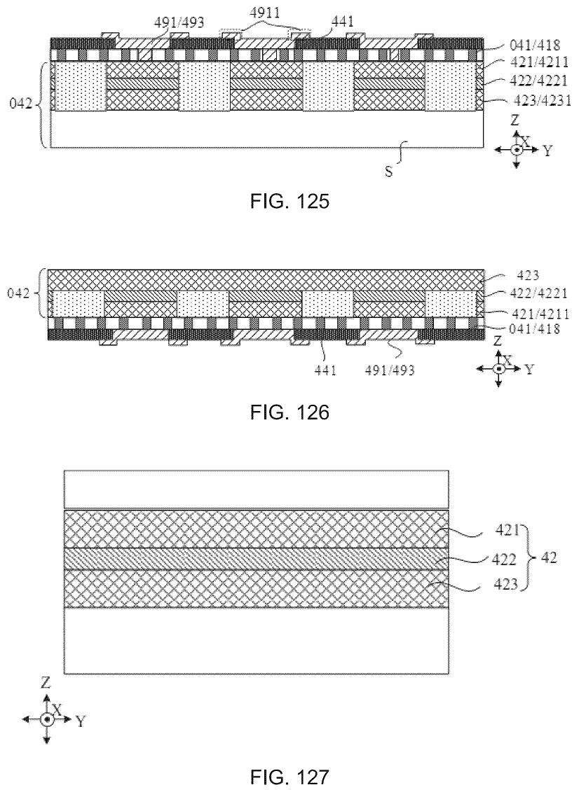

In S134b, as shown in FIG. 125, a first electrode layer 493 is formed on the current blocking layer 441; and the first electrode layer 493 includes a plurality of first electrodes 491 spaced apart from each other, and a single first electrode 121 is electrically connected to an island-shaped first semiconductor unit 4211 through a third opening 4141 and a first via hole 417.

For example, a sputtering process is used to form a first electrode film, the first electrode film covers the current blocking layer 441 and the first light conversion layer 041, and the first electrode film is etched to remove a portion of the first electrode film corresponding to the current blocking layer 441, so as to form the plurality of first electrodes 491. The first electrode layer 493 exposes a portion of the surface of the current blocking layer 441 away from the light-emitting portion 042.

For example, an overlapping portion 4911 of the first electrode 491 is in contact with the current blocking layer 441, and a portion of the first electrode 491 other than the overlapping portion 4911 is located in the third opening 4141 of the current blocking layer 441 and the first via hole 417.

In a process of forming a light-emitting sub-device in the related art, a first light conversion layer is generally formed first, and then first via holes are formed; next, a current blocking film is formed, and third openings are formed, where a third opening corresponds to a first via hole; and then, a first electrode layer is formed. However, during the process of forming the current blocking film, the material of the current blocking film is easily dropped into the first via hole and covers the surface of the island-shaped first semiconductor unit. In the process of forming the third opening, the material of the current blocking film dropped into the first via hole 417 is not easily removed, and the removal operation is relatively complicated, which may easily affect the electrical connection between the subsequently formed first electrode and the island-shaped first semiconductor unit.

In the above manufacturing method in the embodiments of the present disclosure, the first via hole 417 is formed through the third opening 4141, which may avoid the problem of the material of the current blocking layer dropping into the first via hole 417 during the formation of the current blocking layer 441. Therefore, the above manufacturing method is conducive to simplifying the manufacturing process of the light-emitting device 40, and can ensure the electrical connection between the subsequently formed first electrode 491 and the island-shaped first semiconductor unit 4211.

In some embodiments, the manufacturing method for forming the light-emitting device 40 further includes: forming a driving circuit layer 060.

For example, a process of forming the driving circuit layer 060 includes: providing a substrate, and forming a plurality of driving circuits 60 on the substrate. The driving circuit 60 is bonded to the first electrode 491 of the light-emitting device 40 to achieve the electrical connection.

For example, the driving circuit 60 includes at least one transistor. The transistor may be a low temperature polysilicon thin film transistor (LTPS TFT).

For example, the transistor can be formed by using a deposition process, an etching process, etc.

On this basis, the manufacturing method for forming the light-emitting device 40 further includes: peeling off the base; forming a second electrode layer 494 on a side of the light-emitting portion 042 away from the first electrode layer 493; and forming a second light conversion layer 043 on the second electrode layer 494.

For example, as shown in FIG. 126, the light-emitting sub-device is first turned upside down, and then the base in the light-emitting portion 042 is peeled off; and a second electrode layer 494 and a second light conversion layer 043 are formed on the light-emitting portion 042 (referring to FIGS. 112 and 113 here, in which the first sub-base 425 (which can also be referred to as the base) can be omitted).

For example, forming the second electrode layer 494 includes: depositing a second electrode film on the light-emitting portion 042; and etching the second electrode film to form a plurality of first openings 4941. An orthographic projection of the first opening 4941 on the plane where the light-emitting portion 042 is located partially overlaps with the island-shaped light-emitting unit 4221 in the light-emitting portion 042 (referring to FIG. 77 for details).

For example, a glass cover is provided, the second light conversion layer 043 is formed on the glass cover, an adhesive is coated on the second light conversion layer 043 to form a flat surface, and then the second light conversion layer 043 is adhered to the second electrode layer 494.

For example, before forming the second light conversion layer 043, a flat layer 4942 is formed on the second electrode layer 494, and the flat layer 4942 covers a surface of the second electrode layer 494 away from the light-emitting portion. Then, the second light conversion layer 043 is attached to the flat layer 4942.

A refractive index of the flat layer 4942 may be in a range of 1.4 to 1.6. For example, the refractive index of the flat layer 4942 is 1.40, 1.42, 1.48, 1.52, or 1.60. Thus, the loss of light emitted by the light-emitting portion 042 in a process of passing through the flat layer 4942 may be reduced, which is beneficial to reducing the light loss of the light-emitting device 40 and improving the light extraction efficiency of the light-emitting device 40.

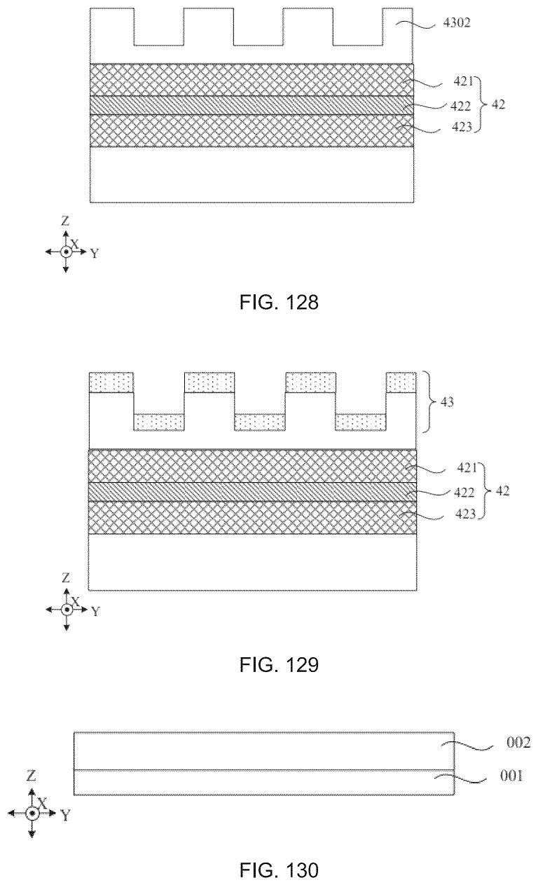

Some embodiments of the present disclosure further provide another method for manufacturing a light-emitting device 40. As shown in FIGS. 127 to 129, an epitaxial structure 42 is provided first, and a light-transmitting dielectric material is spin-coated on a surface of the epitaxial structure 42 (the material may be PMMA or resin); then the light-transmitting dielectric material is patterned through a nanoimprint process to form a second dielectric layer 432 including light-transmitting dielectric patterns 4302; and next, a metal material is deposited on the second dielectric layer 432 to form a first metal layer and a second metal layer. The light-transmitting dielectric patterns, the first metal layer and the second metal layer constitute the metal wire grid 43.

For example, a magnetron sputtering process can be used to deposit the metal material on the light-transmitting dielectric patterns 4302 and in the areas between adjacent light-transmitting dielectric patterns 4302.

For the structure of the metal wire grid 43, reference may be made to the description in some of the above embodiments, which will not be repeated here.

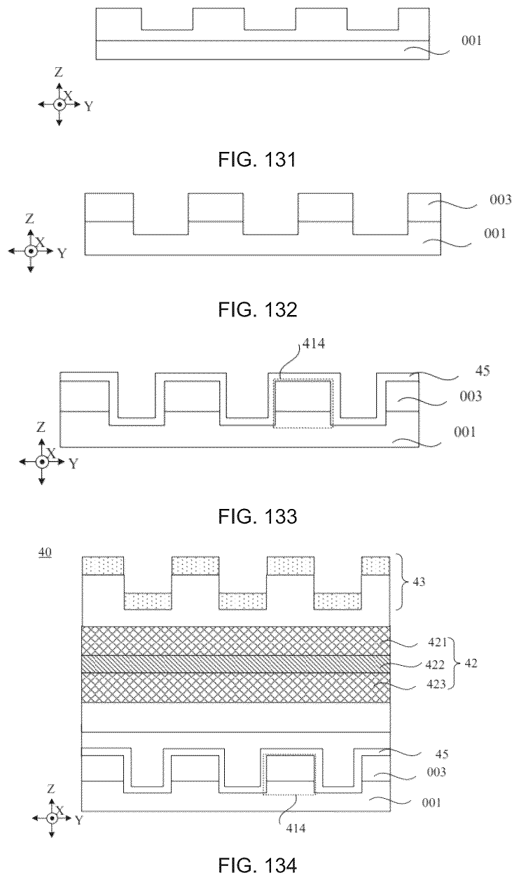

As shown in FIGS. 130 to 134, the manufacturing method for the light-emitting device 40 further includes: providing a second substrate 001; spin-coating a resin material on the second substrate 001 to form a first thin film 002; patterning the first thin film 002 and then etching it to form first patterns 003, a first pattern 003 and a portion of the second substrate 001 constituting a nano-column structure 414; depositing a metal material on the first patterns 003 to form a first reflective layer 45; and bonding the whole composed of the second substrate 001, the nano-column structures 414 and the first reflective layer 45 to a surface of the epitaxial structure 42 away from the metal wire grid 43 to form the light-emitting device 40.

For example, the process for patterning the first thin film may be a nanoimprint process or a plasma etching process.

For example, the first pattern is in a shape of a column, and an included angle between a sidewall of the column and the substrate can be an acute angle. In this way, it may be possible to ensure that the metal material is deposited on the sidewall of the first pattern, thereby ensuring the integrity of the nano-column structure.

For example, a material of the substrate is sapphire.

For the structure of the nano-column structure, reference may be made to the description in some of the above embodiments, which will not be repeated here.

For example, the manufacturing method for the light-emitting device further includes: forming an encapsulation layer on a side of the metal wire grid 43 away from the epitaxial structure.

For example, the encapsulation layer is made of a light-transmitting material.

In addition, for the metal wire grid in the light-emitting device, it may also be formed as follows. After the encapsulation layer of the light-emitting device is manufactured, a metal material is sprayed on the encapsulation layer to form first metal patterns and second metal patterns, thereby forming the metal wire grid.

In some embodiments, after the light-emitting devices 40 are manufactured, a substrate can be provided, the light-emitting devices 40 are transferred and fixed to the substrate 30, and random inspection is performed to detect the fixed yield of the light-emitting device. The reflow soldering process can be used to fix the light-emitting devices to the substrate. Then, a reflective layer is formed on the substrate, the reflective layer has openings, and the light-emitting device is located in an opening. Glue is applied around the light-emitting device, an encapsulation layer is formed, and then the light-emitting device is bonded to an FPC (flexible printed circuit) to complete the manufacturing of a backlight module.

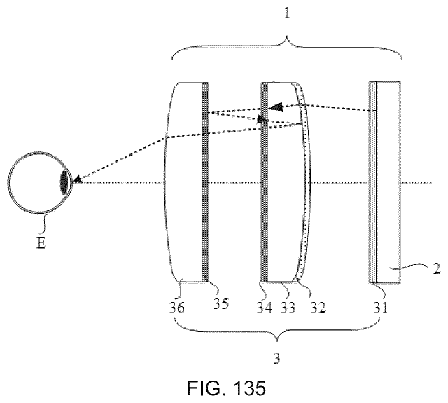

Some embodiments of the present disclosure further provide a display apparatus. As shown in FIG. 135, the display apparatus 1 includes the display substrate 2 described in any of the above embodiments, and optical film lens group 3 disposed on a light-exit side of the display substrate 2.

For example, the optical film lens group 3 includes: a first polarizer 31, a transflective film 32, a first lens 33, a second polarizer 34, a reflective polarizer 35 and a second lens 36 that are sequentially stacked on the light-exit side of the display substrate 2.

The first polarizer 31 and the second polarizer 34 may both be quarter wave plates.

It can be understood that the display substrate 2 includes the light-emitting device 40 described in any of the above embodiments.

For example, the first lens 33 and the second lens 36 can increase the optical path of the light emitted from the display substrate 2 and can amplify the image displayed by the display substrate 2.

The path of the light emitted by the display apparatus 1 and incident on the human eye E is briefly introduced below.

For example, as shown in FIG. 135, the light emitted from the light-emitting portion of the light-emitting device or the display substrate 2 is converted into linearly polarized light (e.g., TM light) under the action of the first light conversion layer and the second light conversion layer. The linearly polarized light is incident on the first polarizer 31 and is converted into circularly polarized light, and then the circularly polarized light exits. The circularly polarized light is incident on the transflective film 32, and part of the circularly polarized light passes through the transflective film 32, and then is incident on the second polarizer 34 after passing through the first lens 33. The part of circularly polarized light is converted into linearly polarized light (e.g., TE light) by the second polarizer 34 and then is incident onto the reflective polarizer 35. The linearly polarized light is reflected by the reflective polarizer 35 and then incident on the second polarizer 34 again. The linearly polarized light is converted into circularly polarized light by the second polarizer 34, and then incident on the transflective film 32 after passing through the first lens 33. The circularly polarized light is partially reflected by the transflective film 32 to the second polarizer 34, is converted into linearly polarized light (e.g., TM light) by the second polarizer 34, and then is incident on the reflective polarizer 35. The linearly polarized light passes through the reflective polarizer 35 and the second lens 36 and then enters the human eye E. As a result, the human eye E may see an image composed of polarized light (in FIG. 135, the dotted line with arrows represents the propagation path of the light emitted from the display substrate).

In the display apparatus 1 provided in the above embodiments of the present disclosure, the optical film lens group 3 is utilized to increase the optical path of the light emitted from the display substrate 2, thereby achieving the ultra-short-focus optical path performance of the display apparatus 1. Moreover, by utilizing the light-emitting devices 40 in the display substrate 2, the pixel density of the image displayed by the display apparatus 1 is relatively high, and the resolution of the displayed image is also high, which is beneficial to improving the overall performance of the display apparatus 1, especially the head-mounted display apparatus 1.

The above are only specific embodiments of the present disclosure, but the scope of protection of the present disclosure is not limited thereto, and any person skilled in the art may conceive of variations or replacements within the technical scope of the present disclosure, which shall fall within the protection scope of the present disclosure. Therefore, the protection scope of the present disclosure should be determined by the protection scope of the claims.

1. A light-emitting device, comprising:
a first light conversion layer;
a light-emitting portion located on a side of the first light conversion layer and used for emitting light; and
a second light conversion layer located on a side of the light-emitting portion away from the first light conversion layer, wherein
the first light conversion layer is configured to change a traveling direction of part of light incident on the first light conversion layer, so that the light with a change in the traveling direction exits in a direction towards the second light conversion layer, and a polarization direction of at least part of the light with the change in the traveling direction is changed; and
the second light conversion layer is configured to change a traveling direction of part of light incident on the second light conversion layer, so that the light with a change in the traveling direction exits in a direction towards the first light conversion layer; and the second light conversion layer is configured to enable at least part of light entering the second light conversion layer to form linearly polarized light to exit from the light-emitting device.

2. The light-emitting device according to claim 1, wherein the light-emitting portion includes a first semiconductor layer, a light-emitting layer, and a second semiconductor layer that are stacked in sequence, and the first semiconductor layer is closer to the first light conversion layer than the second semiconductor layer; and the light-emitting layer is a multi-quantum well layer.

3. The light-emitting device according to claim 1, wherein the second light conversion layer includes a metal wire grid structure.

4. The light-emitting device according to claim 2, further comprising an isolation portion, wherein the isolation portion separates the light-emitting layer into a plurality of island-shaped light-emitting units, and the island-shaped light-emitting units are configured to emit light.

5. The light-emitting device according to claim 4, wherein the island-shaped light-emitting units are in contact with the isolation portion, and the isolation portion between adjacent island-shaped light-emitting units is continuously distributed; and
the isolation portion is further configured to separate the first semiconductor layer into a plurality of island-shaped first semiconductor units; and/or the isolation portion is further configured to separate the second semiconductor layer into a plurality of island-shaped second semiconductor units.

6. The light-emitting device according to claim 4, wherein a material of the isolation portion includes argon element or arsenic element.

7. The light-emitting device according to claim 4, wherein the isolation portion is configured to separate the first semiconductor layer into a plurality of island-shaped first semiconductor units, and the island-shaped first semiconductor units are in one-to-one correspondence with the island-shaped light-emitting units;
the light-emitting device further comprises: a first electrode layer located on a side of the light-emitting portion away from the second light conversion layer, and a driving circuit layer located on a side of the first electrode layer away from the light-emitting portion; and
the driving circuit layer is electrically connected to the island-shaped first semiconductor units through the first electrode layer.

8. The light-emitting device according to claim 7, wherein the first light conversion layer includes a phase conversion layer and the first electrode layer, and the phase conversion layer is located between the first electrode layer and the light-emitting portion;
the first electrode layer includes a plurality of first electrodes spaced apart from each other, and each of the first electrodes is electrically connected to at least one island-shaped first semiconductor unit; and
the first electrodes are configured to reflect light incident on the first electrodes.

9. The light-emitting device according to claim 8, wherein
the phase conversion layered-er includes a plurality of conductive portions, and a conductive portion is partially directly opposite to the at least one island-shaped first semiconductor unit; a side of the conductive portion is electrically connected to a first electrode, and another side of the conductive portion is electrically connected to the at least one island-shaped first semiconductor unit; or
the phase conversion layer includes a plurality of first via holes, and a first electrode is electrically connected to the at least one island-shaped first semiconductor unit through a first via hole.

10. The light-emitting device according to claim 8, further comprising a current blocking layer located between the first electrode layer and the phase conversion layer, wherein an orthographic projection of the current blocking layer on an extension plane of the isolation portion overlaps with the isolation portion; and
an orthographic projection of the first electrode on a plane where the light-emitting portion is located overlaps with an island-shaped light-emitting unit.

11. The light-emitting device according to claim 10, wherein the first electrode includes an overlapping portion, and the overlapping portion is in contact with a surface of the current blocking layer away from the first light conversion layer; and the driving circuit layer is in contact with the overlapping portion.

12. The light-emitting device according to claim 1, wherein the first light conversion layer includes a phase conversion layer and a reflective layer, and the phase conversion layer is located between the reflective layer and the light-emitting portion; and
the phase conversion layer includes a plurality of nanostructures arranged in an array, and a first dielectric layer located between any two adjacent nanostructures.

13-15. (canceled)

16. The light-emitting device according to claim 12, wherein a nanostructure is in a shape of a cuboid, and the plurality of nanostructures constitute a wire grid structure; a repetition period of the wire grid structure is in a range of 180 nm to 220 nm, a line width of the wire grid structure is in a range of 40 nm to 80 nm, and a height of the nanostructure is in a range of 60 nm to 140 nm.

17-19. (canceled)

20. The light-emitting device according to claim 1, wherein the second light conversion layer includes a metal wire grid; and
the metal wire grid includes:
a first metal layer including a plurality of first metal patterns, wherein the plurality of first metal patterns extend in a first direction and are arranged at intervals in a second direction;
and the first direction intersects the second direction;
a second dielectric layer including a plurality of light-transmitting dielectric patterns, wherein each of the plurality of light-transmitting dielectric patterns extends in the first direction, and the plurality of light-transmitting dielectric patterns are arranged at intervals in the second direction; and a light-transmitting dielectric pattern is located between two adjacent first metal patterns; and
a second metal layer including a plurality of second metal patterns, wherein each of the plurality of second metal patterns extends in the first direction, and the plurality of second metal patterns are arranged at intervals in the second direction; and a second metal pattern is located on the light-transmitting dielectric pattern.

21. The light-emitting device according to claim 1, wherein the second light conversion layer includes a metal wire grid; and
the metal wire grid includes a third metal layer; the third metal layer includes a plurality of third metal patterns, and the plurality of third metal patterns extend in a first direction and are arranged at intervals in a second direction; and the first direction intersects the second direction.

22. The light-emitting device according to claim 20, wherein the first light conversion layer includes a plurality of nanostructures;
an orthographic projection of a nanostructure on a plane where the light-emitting portion is located is in a shape of a rectangle, and the rectangle includes a first side and a second side; a dimension of the first side is smaller than a dimension of the second side; and an included angle between a direction where the second side of the nanostructure is located and the first direction is in a range of 30° to 60°; or
the orthographic projection of the nanostructure on the plane where the light-emitting portion is located is in a shape of an ellipse, and the ellipse includes a major axis and a minor axis; and an included angle between a direction where the major axis of the nanostructure is located and the first direction is in a range of 30° to 60°.

23. The light-emitting device according to claim 20, further comprising a second electrode layer located between the light-emitting portion and the second light conversion layer, wherein
the second electrode layer includes a plurality of first openings, and an orthographic projection of a first opening on a plane where the light-emitting portion is located overlaps with the light-emitting portion.

24. The light-emitting device according to claim 20, further comprising a second electrode layer, wherein
the second electrode layer includes a plurality of first openings; the metal wire grid includes a plurality of sub-wire grids arranged at intervals, and a sub-wire grid is located in a first opening; and an orthographic projection of the sub-wire grid on a plane where the light-emitting portion is located overlaps with the light-emitting portion.

25-30. (canceled)

31. A backlight module, comprising:
a substrate, and
one or more light-emitting devices, located on the substrate, according to claim 1.

32. (canceled)

33. A display substrate, comprising a substrate;
one or more light-emitting devices, located on a side of the substrate, according to claim 1, wherein light emitted by the light-emitting devices is blue light or ultraviolet light; and
a color conversion layer located on a side of the light-emitting devices away from the substrate, wherein the color conversion layer includes a dam layer and a plurality of color conversion portions; the dam layer has a plurality of second openings, and the plurality of color conversion portions are located in the plurality of second openings; and
the plurality of color conversion portions include first color conversion portions, second color conversion portions, the third color conversion portions, which are respectively located in different second openings; the first color conversion portion convert light into red light, the second color conversion portions convert light into green light, and the third color conversion portions maintain light or converts the light into blue light.

34. (canceled)

35. (canceled)
